(19) United States
(12) Patent Application Publication
(10) Pub. No.: US 2026/0104482 A1
(43) Pub. Date: Apr. 16, 2026

(54) RADAR APPARATUS, SYSTEM, AND METHOD

(71) Applicant: INTEL CORPORATION, Santa Clara, CA (US)

(72) Inventors: Ophir Shabtay, Tsofit (IL); Kobi Ben Atar, Mazkeret Batya (IL); Sharon Heruti, Tel-Aviv (IL); Merav Sicron, Kfar-Saba (IL); Georgios C. Dogiamis, Chandler, AZ (US); Danniel Nahmanny, Givat Shapira (IL)

(73) Assignee: INTEL CORPORATION, Santa Clara, CA (US)

(21) Appl. No.: 18/870,433

(22) PCT Filed: Jun. 29, 2022
(86) PCT No.: PCT/US2022/035450

§ 371 Date: Nov. 28, 2024

(51) Int. Cl. G01S 7/00; G01S 13/58; G01S 13/931

(52) U.S. Cl. CPC G01S 7/006; G01S 13/584; G01S 13/931

(57) ABSTRACT

For example, a Radio Head (RH) may include a communication interface configured to communicate with a radar processor via a communication interconnect. For example, the communication interface may receive analog synchronization information from the radar processor, and communicate digital radar information with the radar processor. For example, the RH may include one or more Radio Frequency (RF) chains to communicate radar RF signals corresponding to the digital radar information via one or more antennas. For example, the one or more RF chains may be configured to process the radar RF signals based on the analog synchronization information. For example, an RF chain may include a digital/analog converter to convert between an analog signal and a digital signal. For example, the analog signal may correspond to a radar RF signal communicated by the RF chain via an antenna, and the digital signal may correspond to the digital radar information.

### TECHNICAL FIELD

Aspects described herein generally relate to radar apparatus, system and method.

### BACKGROUND

Various types of devices and systems, for example, autonomous and/or robotic devices, e.g., autonomous vehicles and robots, may be configured to perceive and navigate through their environment using sensor data of one or more sensor types.

Conventionally, autonomous perception relies heavily on light-based sensors, such as image sensors, e.g., cameras, and/or Light Detection and Ranging (LiDAR) sensors. Such light-based sensors may perform poorly under certain conditions, such as, conditions of poor visibility, or in certain inclement weather conditions, e.g., rain, snow, hail, or other forms of precipitation, thereby limiting their usefulness or reliability.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a vehicle implementing a radar, in accordance with some demonstrative aspects.

FIG. 2 is a schematic block diagram illustration of a robot implementing a radar, in accordance with some demonstrative aspects.

FIG. 3 is a schematic block diagram illustration of a radar apparatus, in accordance with some demonstrative aspects.

FIG. 4 is a schematic block diagram illustration of a Frequency-Modulated Continuous Wave (FMCW) radar apparatus, in accordance with some demonstrative aspects.

FIG. 5 is a schematic illustration of an extraction scheme, which may be implemented to extract range and speed (Doppler) estimations from digital reception radar data values, in accordance with some demonstrative aspects.

FIG. 6 is a schematic illustration of an angle-determination scheme, which may be implemented to determine Angle of Arrival (AoA) information based on an incoming radio signal received by a receive antenna array, in accordance with some demonstrative aspects.

FIG. 7 is a schematic illustration of a Multiple-Input-Multiple-Output (MIMO) radar antenna scheme, which may be implemented based on a combination of Transmit (Tx) and Receive (Rx) antennas, in accordance with some demonstrative aspects.

FIG. 8 is a schematic block diagram illustration of elements of a radar device including a radar frontend and a radar processor, in accordance with some demonstrative aspects.

FIG. 9 is a schematic illustration of a radar system including a plurality of radar devices implemented in a vehicle, in accordance with some demonstrative aspects.

FIG. 10 is a schematic illustration of a radar system, in accordance with some demonstrative aspects.

FIG. 11 is a schematic illustration of a radar system, in accordance with some demonstrative aspects.

FIG. 12 is a schematic illustration of a radar system, in accordance with some demonstrative aspects.

FIG. 13 is a schematic illustration of a radar system, in accordance with some demonstrative aspects.

FIG. 14 is a schematic illustration of a radar system, in accordance with some demonstrative aspects.

FIG. 15 is a schematic illustration of a radar system, in accordance with some demonstrative aspects.

FIG. 16 is a schematic illustration of a Radio Head (RH), in accordance with some demonstrative aspects.

FIG. 17 is a schematic illustration of an RH, in accordance with some demonstrative aspects.

FIG. 18 is a schematic illustration of an RH, in accordance with some demonstrative aspects.

FIG. 19 is a schematic illustration of a Transmit (Tx) interconnect scheme to support communication between an RH and a radar processor via a communication interconnect, in accordance with some demonstrative aspects.

FIG. 20 is a schematic illustration of a Tx interconnect scheme to support communication between an RH and a radar processor via a communication interconnect, in accordance with some demonstrative aspects.

FIG. 21 is a schematic illustration of a Tx interconnect scheme to support communication between an RH and a radar processor via a communication interconnect, in accordance with some demonstrative aspects.

FIG. 22 is a schematic illustration of a Receive (Rx) interconnect scheme to support communication between an RH and a radar processor via a communication interconnect, in accordance with some demonstrative aspects.

FIG. 23 is a schematic illustration of an Rx interconnect scheme to support communication between an RH and a radar processor via a communication interconnect, in accordance with some demonstrative aspects.

FIG. 24 is a schematic illustration of a radar system, in accordance with some demonstrative aspects.

FIG. 25 is a schematic flow chart illustration of a method of radar processing, in accordance with some demonstrative aspects.

FIG. 26 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, or design described herein as “exemplary” or “demonstrative” is not necessarily to be construed as preferred or advantageous over other aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and/or may represent any information as understood in the art.

The terms “processor” or “controller” may be understood to include any kind of technological entity that allows handling of any suitable type of data and/or information. The data and/or information may be handled according to one or more specific functions executed by the processor or controller. Further, a processor or a controller may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), and the like, or any combination thereof. Any other kind of implementation of the respective functions, which will be described below in further detail, may also be understood as a processor, controller, or logic circuit. It is understood that any two (or more) processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” is understood as a computer-readable medium (e.g., a non-transitory computer-readable medium) in which data or information can be stored for retrieval. References to “memory” may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” may be used to refer to any type of executable instruction and/or logic, including firmware.

A “vehicle” may be understood to include any type of driven object. By way of example, a vehicle may be a driven object with a combustion engine, an electric engine, a reaction engine, an electrically driven object, a hybrid driven object, or a combination thereof. A vehicle may be, or may include, an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, a rocket, among others.

A “ground vehicle” may be understood to include any type of vehicle, which is configured to traverse the ground, e.g., on a street, on a road, on a track, on one or more rails, off-road, or the like.

An “autonomous vehicle” may describe a vehicle capable of implementing at least one navigational change without driver input. A navigational change may describe or include a change in one or more of steering, braking, acceleration/deceleration, or any other operation relating to movement, of the vehicle. A vehicle may be described as autonomous even in case the vehicle is not fully autonomous, for example, fully operational with driver or without driver input. Autonomous vehicles may include those vehicles that can operate under driver control during certain time periods, and without driver control during other time periods. Additionally or alternatively, autonomous vehicles may include vehicles that control only some aspects of vehicle navigation, such as steering, e.g., to maintain a vehicle course between vehicle lane constraints, or some steering operations under certain circumstances, e.g., not under all circumstances, but may leave other aspects of vehicle navigation to the driver, e.g., braking or braking under certain circumstances. Additionally or alternatively, autonomous vehicles may include vehicles that share the control of one or more aspects of vehicle navigation under certain circumstances, e.g., hands-on, such as responsive to a driver input; and/or vehicles that control one or more aspects of vehicle navigation under certain circumstances, e.g., hands-off, such as independent of driver input. Additionally or alternatively, autonomous vehicles may include vehicles that control one or more aspects of vehicle navigation under certain circumstances, such as under certain environmental conditions, e.g., spatial areas, roadway conditions, or the like. In some aspects, autonomous vehicles may handle some or all aspects of braking, speed control, velocity control, steering, and/or any other additional operations, of the vehicle. An autonomous vehicle may include those vehicles that can operate without a driver. The level of autonomy of a vehicle may be described or determined by the Society of Automotive Engineers (SAE) level of the vehicle, e.g., as defined by the SAE, for example in SAE J3016 2018: Taxonomy and definitions for terms related to driving automation systems for on road motor vehicles, or by other relevant professional organizations. The SAE level may have a value ranging from a minimum level, e.g., level 0 (illustratively, substantially no driving automation), to a maximum level, e.g., level 5 (illustratively, full driving automation).

An “assisted vehicle” may describe a vehicle capable of informing a driver or occupant of the vehicle of sensed data or information derived therefrom.

The phrase “vehicle operation data” may be understood to describe any type of feature related to the operation of a vehicle. By way of example, “vehicle operation data” may describe the status of the vehicle, such as, the type of tires of the vehicle, the type of vehicle, and/or the age of the manufacturing of the vehicle. More generally, “vehicle operation data” may describe or include static features or static vehicle operation data (illustratively, features or data not changing over time). As another example, additionally or alternatively, “vehicle operation data” may describe or include features changing during the operation of the vehicle, for example, environmental conditions, such as weather conditions or road conditions during the operation of the vehicle, fuel levels, fluid levels, operational parameters of the driving source of the vehicle, or the like. More generally, “vehicle operation data” may describe or include varying features or varying vehicle operation data (illustratively, time varying features or data).

Some aspects may be used in conjunction with various devices and systems, for example, a radar sensor, a radar device, a radar system, a vehicle, a vehicular system, an autonomous vehicular system, a vehicular communication system, a vehicular device, an airborne platform, a waterborne platform, road infrastructure, sports-capture infrastructure, city monitoring infrastructure, static infrastructure platforms, indoor platforms, moving platforms, robot platforms, industrial platforms, a sensor device, a User Equipment (UE), a Mobile Device (MD), a wireless station (STA), a sensor device, a non-vehicular device, a mobile or portable device, and the like.

Some aspects may be used in conjunction with Radio Frequency (RF) systems, radar systems, vehicular radar systems, autonomous systems, robotic systems, detection systems, or the like.

Some demonstrative aspects may be used in conjunction with an RF frequency in a frequency band having a starting frequency above 10 Gigahertz (GHz), for example, a frequency band having a starting frequency between 10 GHz and 120 GHz. For example, some demonstrative aspects may be used in conjunction with an RF frequency having a starting frequency above 30 GHz, for example, above 45 GHZ, e.g., above 60 GHz. For example, some demonstrative aspects may be used in conjunction with an automotive radar frequency band, e.g., a frequency band between 76 GHz and 81 GHz. However, other aspects may be implemented utilizing any other suitable frequency bands, for example, a frequency band above 140 GHz, a frequency band of 300 GHz, a sub Terahertz (THz) band, a THz band, an Infra-Red (IR) band, and/or any other frequency band.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “communicating” as used herein with respect to a signal includes transmitting the signal and/or receiving the signal. For example, an apparatus, which is capable of communicating a signal, may include a transmitter to transmit the signal, and/or a receiver to receive the signal. The verb communicating may be used to refer to the action of transmitting or the action of receiving. In one example, the phrase “communicating a signal” may refer to the action of transmitting the signal by a transmitter, and may not necessarily include the action of receiving the signal by a receiver. In another example, the phrase “communicating a signal” may refer to the action of receiving the signal by a receiver, and may not necessarily include the action of transmitting the signal by a transmitter.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a MIMO (Multiple-Input Multiple-Output) array antenna, a single element antenna, a set of switched beam antennas, and/or the like. In one example, an antenna may be implemented as a separate element or an integrated element, for example, as an on-module antenna, an on-chip antenna, or according to any other antenna architecture.

Some demonstrative aspects are described herein with respect to RF radar signals. However, other aspects may be implemented with respect to, or in conjunction with, any other radar signals, wireless signals, IR signals, acoustic signals, optical signals, wireless communication signals, communication scheme, network, standard, and/or protocol. For example, some demonstrative aspects may be implemented with respect to systems, e.g., Light Detection Ranging (LiDAR) systems, and/or sonar systems, utilizing light and/or acoustic signals.

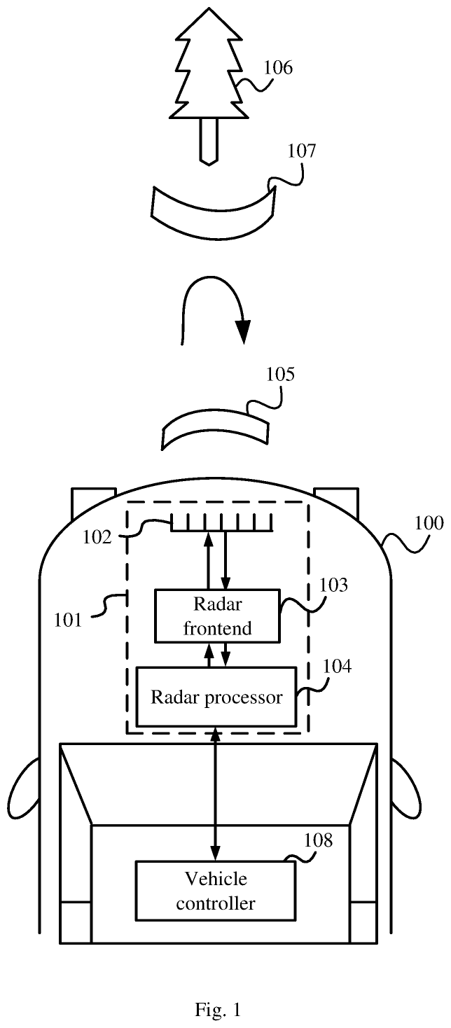

Reference is now made to FIG. 1, which schematically illustrates a block diagram of a vehicle 100 implementing a radar, in accordance with some demonstrative aspects.

In some demonstrative aspects, vehicle 100 may include a car, a truck, a motorcycle, a bus, a train, an airborne vehicle, a waterborne vehicle, a cart, a golf cart, an electric cart, a road agent, or any other vehicle.

In some demonstrative aspects, vehicle 100 may include a radar device 101, e.g., as described below. For example, radar device 101 may include a radar detecting device, a radar sensing device, a radar sensor, or the like, e.g., as described below.

In some demonstrative aspects, radar device 101 may be implemented as part of a vehicular system, for example, a system to be implemented and/or mounted in vehicle 100.

In one example, radar device 101 may be implemented as part of an autonomous vehicle system, an automated driving system, an assisted vehicle system, a driver assistance and/or support system, and/or the like.

For example, radar device 101 may be installed in vehicle 100 for detection of nearby objects, e.g., for autonomous driving.

In some demonstrative aspects, radar device 101 may be configured to detect targets in a vicinity of vehicle 100, e.g., in a far vicinity and/or a near vicinity, for example, using RF and analog chains, capacitor structures, large spiral transformers and/or any other electronic or electrical elements, e.g., as described below.

In one example, radar device 101 may be mounted onto, placed, e.g., directly, onto, or attached to, vehicle 100.

In some demonstrative aspects, vehicle 100 may include a plurality of radar aspects, vehicle 100 may include a single radar device 101.

In some demonstrative aspects, vehicle 100 may include a plurality of radar devices 101, which may be configured to cover a field of view of 360 degrees around vehicle 100.

In other aspects, vehicle 100 may include any other suitable count, arrangement, and/or configuration of radar devices and/or units, which may be suitable to cover any other field of view, e.g., a field of view of less than 360 degrees.

In some demonstrative aspects, radar device 101 may be implemented as a component in a suite of sensors used for driver assistance and/or autonomous vehicles, for example, due to the ability of radar to operate in nearly all-weather conditions.

In some demonstrative aspects, radar device 101 may be configured to support autonomous vehicle usage, e.g., as described below.

In one example, radar device 101 may determine a class, a location, an orientation, a velocity, an intention, a perceptional understanding of the environment, and/or any other information corresponding to an object in the environment.

In another example, radar device 101 may be configured to determine one or more parameters and/or information for one or more operations and/or tasks, e.g., path planning, and/or any other tasks.

In some demonstrative aspects, radar device 101 may be configured to map a scene by measuring targets' echoes (reflectivity) and discriminating them, for example, mainly in range, velocity, azimuth and/or elevation, e.g., as described below.

In some demonstrative aspects, radar device 101 may be configured to detect, and/or sense, one or more objects, which are located in a vicinity, e.g., a far vicinity and/or a near vicinity, of the vehicle 100, and to provide one or more parameters, attributes, and/or information with respect to the objects.

In some demonstrative aspects, the objects may include other vehicles; pedestrians; traffic signs; traffic lights; roads, road elements, e.g., a pavement-road meeting, an edge line; a hazard, e.g., a tire, a box, a crack in the road surface; and/or the like.

In some demonstrative aspects, the one or more parameters, attributes and/or information with respect to the object may include a range of the objects from the vehicle 100, an angle of the object with respect to the vehicle 100, a location of the object with respect to the vehicle 100, a relative speed of the object with respect to vehicle 100, and/or the like.

In some demonstrative aspects, radar device 101 may include a Multiple Input Multiple Output (MIMO) radar device 101, e.g., as described below. In one example, the MIMO radar device may be configured to utilize “spatial filtering” processing, for example, beamforming and/or any other mechanism, for one or both of Transmit (Tx) signals and/or Receive (Rx) signals.

Some demonstrative aspects are described below with respect to a radar device, e.g., radar device 101, implemented as a MIMO radar. However, in other aspects, radar device 101 may be implemented as any other type of radar utilizing a plurality of antenna elements, e.g., a Single Input Multiple Output (SIMO) radar or a Multiple Input Single output (MISO) radar.

Some demonstrative aspects may be implemented with respect to a radar device, e.g., radar device 101, implemented as a MIMO radar, e.g., as described below. However, in other aspects, radar device 101 may be implemented as any other type of radar, for example, an Electronic Beam Steering radar, a Synthetic Aperture Radar (SAR), adaptive and/or cognitive radars that change their transmission according to the environment and/or ego state, a reflect array radar, or the like.

In some demonstrative aspects, radar device 101 may include an antenna arrangement 102, a radar frontend 103 configured to communicate radar signals via the antenna arrangement 102, and a radar processor 104 configured to generate radar information based on the radar signals, e.g., as described below.

In some demonstrative aspects, radar processor 104 may be configured to process radar information of radar device 101 and/or to control one or more operations of radar device 101, e.g., as described below.

In some demonstrative aspects, radar processor 104 may include, or may be implemented, partially or entirely, by circuitry and/or logic, e.g., one or more processors including circuitry and/or logic, memory circuitry and/or logic. Additionally or alternatively, one or more functionalities of radar processor 104 may be implemented by logic, which may be executed by a machine and/or one or more processors, e.g., as described below.

In one example, radar processor 104 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In other aspects, radar processor 104 may be implemented by one or more additional or alternative elements of vehicle 100.

In some demonstrative aspects, radar frontend 103 may include, for example, one or more (radar) transmitters, and a one or more (radar) receivers, e.g., as described below.

In some demonstrative aspects, antenna arrangement 102 may include a plurality of antennas to communicate the radar signals. For example, antenna arrangement 102 may include multiple transmit antennas in the form of a transmit antenna array, and multiple receive antennas in the form of a receive antenna array. In another example, antenna arrangement 102 may include one or more antennas used both as transmit and receive antennas. In the latter case, the radar frontend 103, for example, may include a duplexer or a circulator, e.g., a circuit to separate transmitted signals from received signals.

In some demonstrative aspects, as shown in FIG. 1, the radar frontend 103 and the antenna arrangement 102 may be controlled, e.g., by radar processor 104, to transmit a radio transmit signal 105.

In some demonstrative aspects, as shown in FIG. 1, the radio transmit signal 105 may be reflected by an object 106, resulting in an echo 107.

In some demonstrative aspects, the radar device 101 may receive the echo 107, e.g., via antenna arrangement 102 and radar frontend 103, and radar processor 104 may generate radar information, for example, by calculating information about position, radial velocity (Doppler), and/or direction of the object 106, e.g., with respect to vehicle 100.

In some demonstrative aspects, radar processor 104 may be configured to provide the radar information to a vehicle controller 108 of the vehicle 100, e.g., for autonomous driving of the vehicle 100.

In some demonstrative aspects, at least part of the functionality of radar processor 104 may be implemented as part of vehicle controller 108. In other aspects, the functionality of radar processor 104 may be implemented as part of any other element of radar device 101 and/or vehicle 100. In other aspects, radar processor 104 may be implemented, as a separate part of, or as part of any other element of radar device 101 and/or vehicle 100.

In some demonstrative aspects, vehicle controller 108 may be configured to control one or more functionalities, modes of operation, components, devices, systems and/or elements of vehicle 100.

In some demonstrative aspects, vehicle controller 108 may be configured to control one or more vehicular systems of vehicle 100, e.g., as described below.

In some demonstrative aspects, the vehicular systems may include, for example, a steering system, a braking system, a driving system, and/or any other system of the vehicle 100.

In some demonstrative aspects, vehicle controller 108 may configured to control radar device 101, and/or to process one or parameters, attributes and/or information from radar device 101.

In some demonstrative aspects, vehicle controller 108 may be configured, for example, to control the vehicular systems of the vehicle 100, for example, based on radar information from radar device 101 and/or one or more other sensors of the vehicle 100, e.g., Light Detection and Ranging (LIDAR) sensors, camera sensors, and/or the like.

In one example, vehicle controller 108 may control the steering system, the braking system, and/or any other vehicular systems of vehicle 100, for example, based on the information from radar device 101, e.g., based on one or more objects detected by radar device 101.

In other aspects, vehicle controller 108 may be configured to control any other additional or alternative functionalities of vehicle 100.

Some demonstrative aspects are described herein with respect to a radar device 101 implemented in a vehicle, e.g., vehicle 100. In other aspects a radar device, e.g., radar device 101, may be implemented as part of any other element of a traffic system or network, for example, as part of a road infrastructure, and/or any other element of a traffic network or system. Other aspects may be implemented with respect to any other system, environment and/or apparatus, which may be implemented in any other object, environment, location, or place. For example, radar device 101 may be part of a non-vehicular device, which may be implemented, for example, in an indoor location, a stationary infrastructure outdoors, or any other location.

In some demonstrative aspects, radar device 101 may be configured to support security usage. In one example, radar device 101 may be configured to determine a nature of an operation, e.g., a human entry, an animal entry, an environmental movement, and the like, to identity a threat level of a detected event, and/or any other additional or alternative operations.

Some demonstrative aspects may be implemented with respect to any other additional or alternative devices and/or systems, for example, for a robot, e.g., as described below.

In other aspects, radar device 101 may be configured to support any other usages and/or applications.

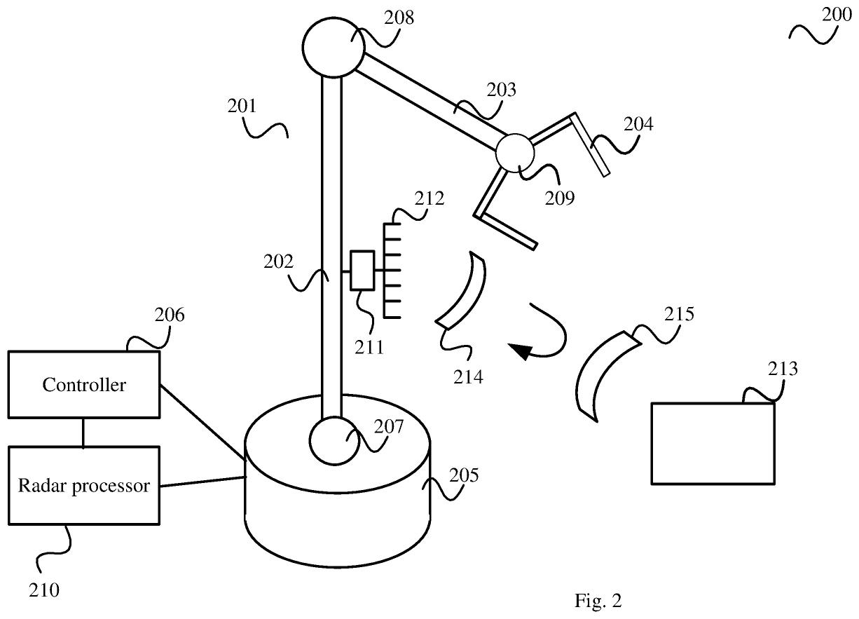

Reference is now made to FIG. 2, which schematically illustrates a block diagram of a robot 200 implementing a radar, in accordance with some demonstrative aspects.

In some demonstrative aspects, robot 200 may include a robot arm 201. The robot 200 may be implemented, for example, in a factory for handling an object 213, which may be, for example, a part that should be affixed to a product that is being manufactured. The robot arm 201 may include a plurality of movable members, for example, movable members 202, 203, 204, and a support 205. Moving the movable members 202, 203, and/or 204 of the robot arm 201, e.g., by actuation of associated motors, may allow physical interaction with the environment to carry out a task, e.g., handling the object 213.

In some demonstrative aspects, the robot arm 201 may include a plurality of joint elements, e.g., joint elements 207, 208, 209, which may connect, for example, the members 202, 203, and/or 204 with each other, and with the support 205. For example, a joint element 207, 208, 209 may have one or more joints, each of which may provide rotatable motion, e.g., rotational motion, and/or translatory motion, e.g., displacement, to associated members and/or motion of members relative to each other. The movement of the members 202, 203, 204 may be initiated by suitable actuators.

In some demonstrative aspects, the member furthest from the support 205, e.g., member 204, may also be referred to as the end-effector 204 and may include one or more tools, such as, a claw for gripping an object, a welding tool, or the like. Other members, e.g., members 202, 203, closer to the support 205, may be utilized to change the position of the end-effector 204, e.g., in three-dimensional space. For example, the robot arm 201 may be configured to function similarly to a human arm, e.g., possibly with a tool at its end.

In some demonstrative aspects, robot 200 may include a (robot) controller 206 configured to implement interaction with the environment, e.g., by controlling the robot arm's actuators, according to a control program, for example, in order to control the robot arm 201 according to the task to be performed.

In some demonstrative aspects, an actuator may include a component adapted to affect a mechanism or process in response to being driven. The actuator can respond to commands given by the controller 206 (the so-called activation) by performing mechanical movement. This means that an actuator, typically a motor (or electromechanical converter), may be configured to convert electrical energy into mechanical energy when it is activated (i.e. actuated).

In some demonstrative aspects, controller 206 may be in communication with a radar processor 210 of the robot 200.

In some demonstrative aspects, a radar fronted 211 and a radar antenna arrangement 212 may be coupled to the radar processor 210. In one example, radar fronted 211 and/or radar antenna arrangement 212 may be included, for example, as part of the robot arm 201.

In some demonstrative aspects, the radar frontend 211, the radar antenna arrangement 212 and the radar processor 210 may be operable as, and/or may be configured to form, a radar device. For example, antenna arrangement 212 may be configured to perform one or more functionalities of antenna arrangement 102 (FIG. 1), radar frontend 211 may be configured to perform one or more functionalities of radar frontend 103 (FIG. 1), and/or radar processor 210 may be configured to perform one or more functionalities of radar processor 104 (FIG. 1), e.g., as described above.

In some demonstrative aspects, for example, the radar frontend 211 and the antenna arrangement 212 may be controlled, e.g., by radar processor 210, to transmit a radio transmit signal 214.

In some demonstrative aspects, as shown in FIG. 2, the radio transmit signal 214 may be reflected by the object 213, resulting in an echo 215.

In some demonstrative aspects, the echo 215 may be received, e.g., via antenna arrangement 212 and radar frontend 211, and radar processor 210 may generate radar information, for example, by calculating information about position, speed (Doppler) and/or direction of the object 213, e.g., with respect to robot arm 201.

In some demonstrative aspects, radar processor 210 may be configured to provide the radar information to the robot controller 206 of the robot arm 201, e.g., to control robot arm 201. For example, robot controller 206 may be configured to control robot arm 201 based on the radar information, e.g., to grab the object 213 and/or to perform any other operation.

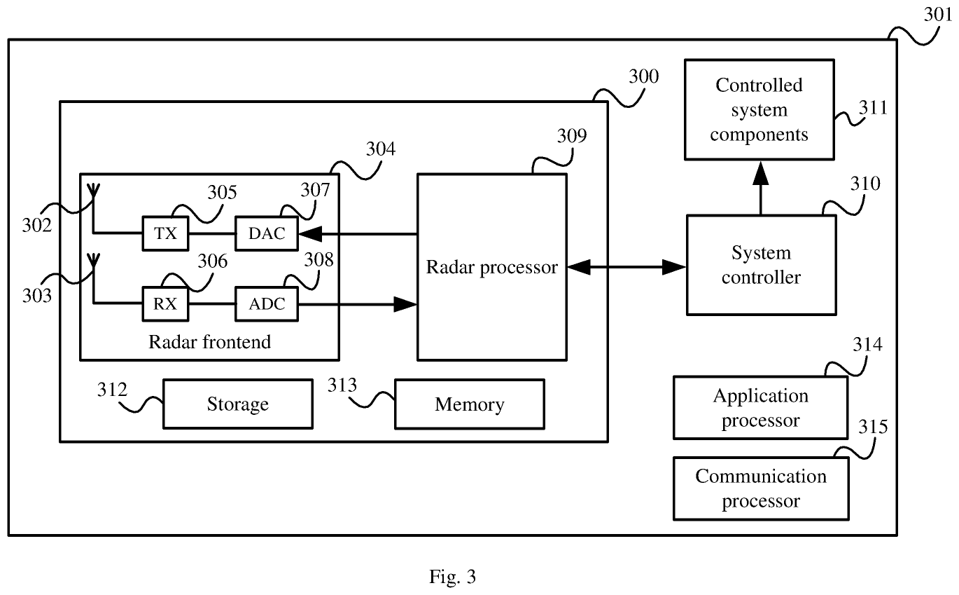

Reference is made to FIG. 3, which schematically illustrates a radar apparatus 300, in accordance with some demonstrative aspects.

In some demonstrative aspects, radar apparatus 300 may be implemented as part of a device or system 301, e.g., as described below.

For example, radar apparatus 300 may be implemented as part of, and/or may configured to perform one or more operations and/or functionalities of, the devices or systems described above with reference to FIG. 1 an/or FIG. 2. In other aspects, radar apparatus 300 may be implemented as part of any other device or system 301.

In some demonstrative aspects, radar device 300 may include an antenna arrangement, which may include one or more transmit antennas 302 and one or more receive antennas 303. In other aspects, any other antenna arrangement may be implemented.

In some demonstrative aspects, radar device 300 may include a radar frontend 304, and a radar processor 309.

In some demonstrative aspects, as shown in FIG. 3, the one or more transmit antennas 302 may be coupled with a transmitter (or transmitter arrangement) 305 of the radar frontend 304; and/or the one or more receive antennas 303 may be coupled with a receiver (or receiver arrangement) 306 of the radar frontend 304, e.g., as described below.

In some demonstrative aspects, transmitter 305 may include one or more elements, for example, an oscillator, a power amplifier and/or one or more other elements, configured to generate radio transmit signals to be transmitted by the one or more transmit antennas 302, e.g., as described below.

In some demonstrative aspects, for example, radar processor 309 may provide digital radar transmit data values to the radar frontend 304. For example, radar frontend 304 may include a Digital-to-Analog Converter (DAC) 307 to convert the digital radar transmit data values to an analog transmit signal. The transmitter 305 may convert the analog transmit signal to a radio transmit signal which is to be transmitted by transmit antennas 302.

In some demonstrative aspects, receiver 306 may include one or more elements, for example, one or more mixers, one or more filters and/or one or more other elements, configured to process, down-convert, radio signals received via the one or more receive antennas 303, e.g., as described below.

In some demonstrative aspects, for example, receiver 306 may convert a radio receive signal received via the one or more receive antennas 303 into an analog receive signal. The radar frontend 304 may include an Analog-to-Digital Converter (ADC) 308 to generate digital radar reception data values based on the analog receive signal. For example, radar frontend 304 may provide the digital radar reception data values to the radar processor 309.

In some demonstrative aspects, radar processor 309 may be configured to process the digital radar reception data values, for example, to detect one or more objects, e.g., in an environment of the device/system 301. This detection may include, for example, the determination of information including one or more of range, speed (Doppler), direction, and/or any other information, of one or more objects, e.g., with respect to the system 301.

In some demonstrative aspects, radar processor 309 may be configured to provide the determined radar information to a system controller 310 of device/system 301. For example, system controller 310 may include a vehicle controller, e.g., if device/system 301 includes a vehicular device/system, a robot controller, e.g., if device/system 301 includes a robot device/system, or any other type of controller for any other type of device/system 301.

In some demonstrative aspects, system controller 310 may be configured to control one or more controlled system components 311 of the system 301, e.g. a motor, a brake, steering, and the like, e.g. by one or more corresponding actuators.

In some demonstrative aspects, radar device 300 may include a storage 312 or a memory 313, e.g., to store information processed by radar 300, for example, digital radar reception data values being processed by the radar processor 309, radar information generated by radar processor 309, and/or any other data to be processed by radar processor 309.

In some demonstrative aspects, device/system 301 may include, for example, an application processor 314 and/or a communication processor 315, for example, to at least partially implement one or more functionalities of system controller 310 and/or to perform communication between system controller 310, radar device 300, the controlled system components 311, and/or one or more additional elements of device/system 301.

In some demonstrative aspects, radar device 300 may be configured to generate and transmit the radio transmit signal in a form, which may support determination of range, speed, and/or direction, e.g., as described below.

For example, a radio transmit signal of a radar may be configured to include a plurality of pulses. For example, a pulse transmission may include the transmission of short high-power bursts in combination with times during which the radar device listens for echoes.

For example, in order to more optimally support a highly dynamic situation, e.g., in an automotive scenario, a continuous wave (CW) may instead be used as the radio transmit signal. However, a continuous wave, e.g., with constant frequency, may support velocity determination, but may not allow range determination, e.g., due to the lack of a time mark that could allow distance calculation.

In some demonstrative aspects, radio transmit signal 105 (FIG. 1) may be transmitted according to technologies such as, for example, Frequency-Modulated continuous wave (FMCW) radar, Phase-Modulated Continuous Wave (PMCW) radar, Orthogonal Frequency Division Multiplexing (OFDM) radar, and/or any other type of radar technology, which may support determination of range, velocity, and/or direction, e.g., as described below.

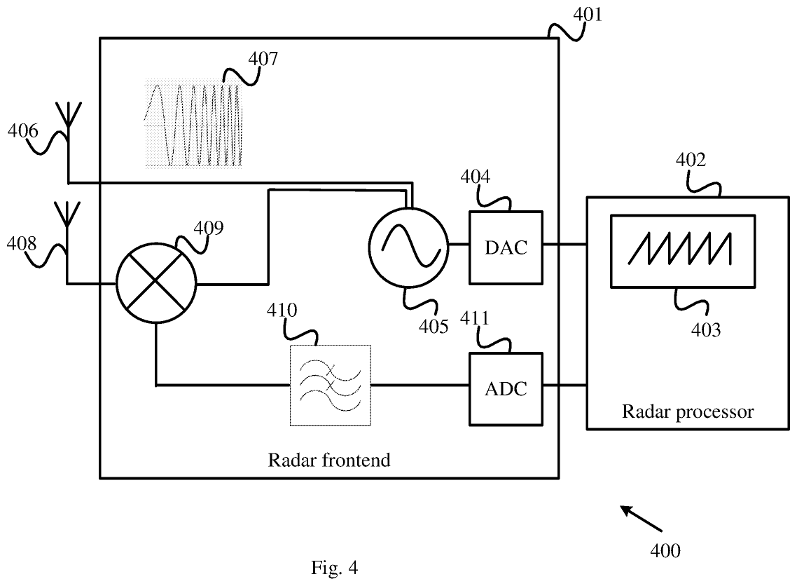

Reference is made to FIG. 4, which schematically illustrates a FMCW radar apparatus, in accordance with some demonstrative aspects.

In some demonstrative aspects, FMCW radar device 400 may include a radar frontend 401, and a radar processor 402. For example, radar frontend 304 (FIG. 3) may include one or more elements of, and/or may perform one or more operations and/or functionalities of, radar frontend 401; and/or radar processor 309 (FIG. 3) may include one or more elements of, and/or may perform one or more operations and/or functionalities of, radar processor 402.

In some demonstrative aspects, FMCW radar device 400 may be configured to communicate radio signals according to an FMCW radar technology, e.g., rather than sending a radio transmit signal with a constant frequency.

In some demonstrative aspects, radio frontend 401 may be configured to ramp up and reset the frequency of the transmit signal, e.g., periodically, for example, according to a saw tooth waveform 403. In other aspects, a triangle waveform, or any other suitable waveform may be used.

In some demonstrative aspects, for example, radar processor 402 may be configured to provide waveform 403 to frontend 401, for example, in digital form, e.g., as a sequence of digital values.

In some demonstrative aspects, radar frontend 401 may include a DAC 404 to convert waveform 403 into analog form, and to supply it to a voltage-controlled oscillator 405. For example, oscillator 405 may be configured to generate an output signal, which may be frequency-modulated in accordance with the waveform 403.

In some demonstrative aspects, oscillator 405 may be configured to generate the output signal including a radio transmit signal, which may be fed to and sent out by one or more transmit antennas 406.

In some demonstrative aspects, the radio transmit signal generated by the oscillator 405 may have the form of a sequence of chirps 407, which may be the result of the modulation of a sinusoid with the saw tooth waveform 403.

In one example, a chirp 407 may correspond to the sinusoid of the oscillator signal frequency-modulated by a “tooth” of the saw tooth waveform 403, e.g., from the minimum frequency to the maximum frequency.

In some demonstrative aspects, FMCW radar device 400 may include one or more receive antennas 408 to receive a radio receive signal. The radio receive signal may be based on the echo of the radio transmit signal, e.g., in addition to any noise, interference, or the like.

In some demonstrative aspects, radar frontend 401 may include a mixer 409 to mix the radio transmit signal with the radio receive signal into a mixed signal.

In some demonstrative aspects, radar frontend 401 may include a filter, e.g., a Low Pass Filter (LPF) 410, which may be configured to filter the mixed signal from the mixer 409 to provide a filtered signal. For example, radar frontend 401 may include an ADC 411 to convert the filtered signal into digital reception data values, which may be provided to radar processor 402. In another example, the filter 410 may be a digital filter, and the ADC 411 may be arranged between the mixer 409 and the filter 410.

In some demonstrative aspects, radar processor 402 may be configured to process the digital reception data values to provide radar information, for example, including range, speed (velocity/Doppler), and/or direction (AoA) information of one or more objects.

In some demonstrative aspects, radar processor 402 may be configured to perform a first Fast Fourier Transform (FFT) (also referred to as “range FFT”) to extract a delay response, which may be used to extract range information, and/or a second FFT (also referred to as “Doppler FFT”) to extract a Doppler shift response, which may be used to extract velocity information, from the digital reception data values.

In other aspects, any other additional or alternative methods may be utilized to extract range information. In one example, in a digital radar implementation, a correlation with the transmitted signal may be used, e.g., according to a matched filter implementation.

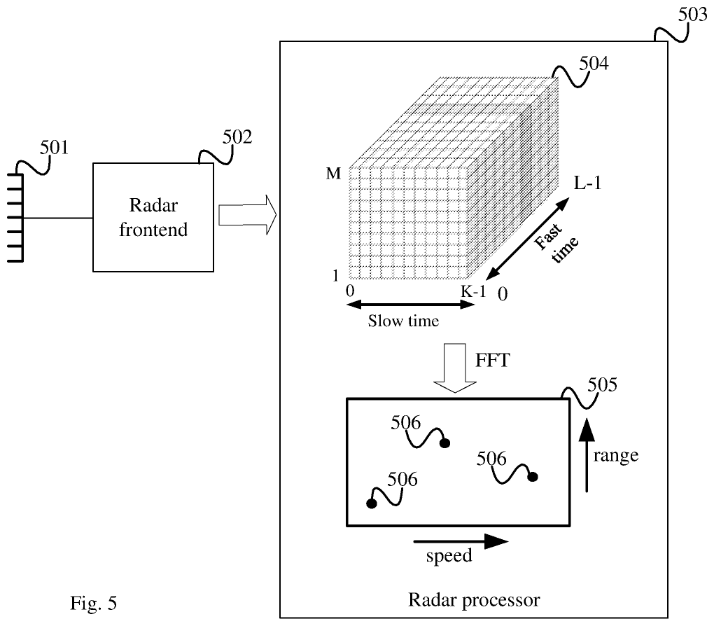

Reference is made to FIG. 5, which schematically illustrates an extraction scheme, which may be implemented to extract range and speed (Doppler) estimations from digital reception radar data values, in accordance with some demonstrative aspects. For example, radar processor 104 (FIG. 1), radar processor 210 (FIG. 2), radar processor 309 (FIG. 3), and/or radar processor 402 (FIG. 4), may be configured to extract range and/or speed (Doppler) estimations from digital reception radar data values according to one or more aspects of the extraction scheme of FIG. 5.

In some demonstrative aspects, as shown in FIG. 5, a radio receive signal, e.g., including echoes of a radio transmit signal, may be received by a receive antenna array 501. The radio receive signal may be processed by a radio radar frontend 502 to generate digital reception data values, e.g., as described above. The radio radar frontend 502 may provide the digital reception data values to a radar processor 503, which may process the digital reception data values to provide radar information, e.g., as described above.

In some demonstrative aspects, the digital reception data values may be represented in the form of a data cube 504. For example, the data cube 504 may include digitized samples of the radio receive signal, which is based on a radio signal transmitted from a transmit antenna and received by M receive antennas. In some demonstrative aspects, for example, with respect to a MIMO implementation, there may be multiple transmit antennas, and the number of samples may be multiplied accordingly.

In some demonstrative aspects, a layer of the data cube 504, for example, a horizontal layer of the data cube 504, may include samples of an antenna, e.g., a respective antenna of the M antennas.

In some demonstrative aspects, data cube 504 may include samples for K chirps. For example, as shown in FIG. 5, the samples of the chirps may be arranged in a so-called “slow time”-direction.

In some demonstrative aspects, the data cube 504 may include L samples, e.g., L=512 or any other number of samples, for a chirp, e.g., per each chirp. For example, as shown in FIG. 5, the samples per chirp may be arranged in a so-called “fast time”-direction of the data cube 504.

In some demonstrative aspects, radar processor 503 may be configured to process a plurality of samples, e.g., L samples collected for each chirp and for each antenna, by a first FFT. The first FFT may be performed, for example, for each chirp and each antenna, such that a result of the processing of the data cube 504 by the first FFT may again have three dimensions, and may have the size of the data cube 504 while including values for L range bins, e.g., instead of the values for the L sampling times.

In some demonstrative aspects, radar processor 503 may be configured to process the result of the processing of the data cube 504 by the first FFT, for example, by processing the result according to a second FFT along the chirps, e.g., for each antenna and for each range bin.

For example, the first FFT may be in the “fast time” direction, and the second FFT may be in the “slow time” direction.

In some demonstrative aspects, the result of the second FFT may provide, e.g., when aggregated over the antennas, a range/Doppler (R/D) map 505. The R/D map may have FFT peaks 506, for example, including peaks of FFT output values (in terms of absolute values) for certain range/speed combinations, e.g., for range/Doppler bins. For example, a range/Doppler bin may correspond to a range bin and a Doppler bin. For example, radar processor 503 may consider a peak as potentially corresponding to an object, e.g., of the range and speed corresponding to the peak's range bin and speed bin.

In some demonstrative aspects, the extraction scheme of FIG. 5 may be implemented for an FMCW radar, e.g., FMCW radar 400 (FIG. 4), as described above. In other aspects, the extraction scheme of FIG. 5 may be implemented for any other radar type. In one example, the radar processor 503 may be configured to determine a range/Doppler map 505 from digital reception data values of a PMCW radar, an OFDM radar, or any other radar technologies. For example, in adaptive or cognitive radar, the pulses in a frame, the waveform and/or modulation may be changed over time, e.g., according to the environment.

Referring back to FIG. 3, in some demonstrative aspects, receive antenna arrangement 303 may be implemented using a receive antenna array having a plurality of receive antennas (or receive antenna elements). For example, radar processor 309 may be configured to determine an angle of arrival of the received radio signal, e.g., echo 107 (FIG. 1) and/or echo 215 (FIG. 2). For example, radar processor 309 may be configured to determine a direction of a detected object, e.g., with respect to the device/system 301, for example, based on the angle of arrival of the received radio signal, e.g., as described below.

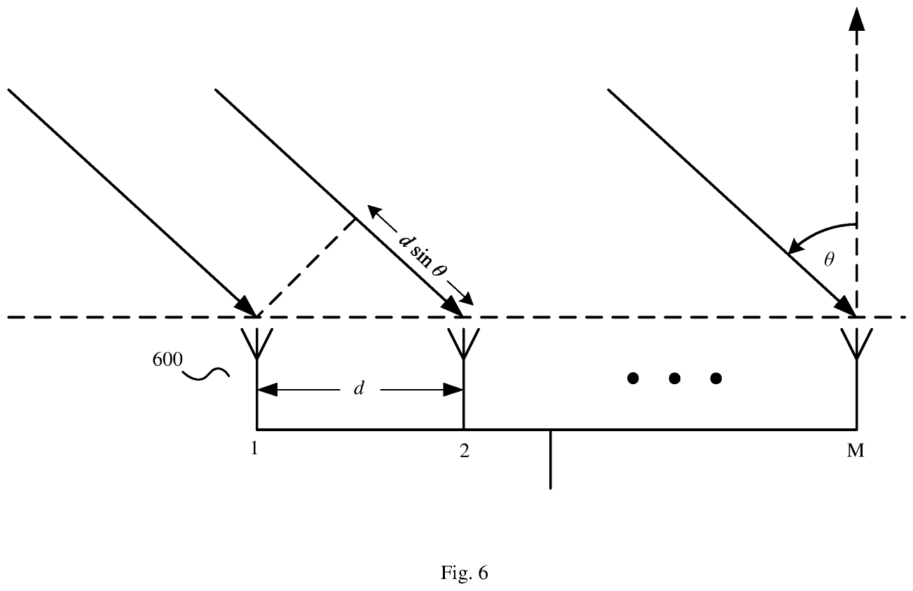

Reference is made to FIG. 6, which schematically illustrates an angle-determination scheme, which may be implemented to determine Angle of Arrival (AoA) information based on an incoming radio signal received by a receive antenna array 600, in accordance with some demonstrative aspects.

FIG. 6 depicts an angle-determination scheme based on received signals at the receive antenna array. In some demonstrative aspects, for example, in a virtual MIMO array, the angle-determination may also be based on the signals transmitted by the array of Tx antennas.

FIG. 6 depicts a one-dimensional angle-determination scheme. Other multi-dimensional angle determination schemes, e.g., a two-dimensional scheme or a three-dimensional scheme, may be implemented.

In some demonstrative aspects, as shown in FIG. 6, the receive antenna array 600 may include M antennas (numbered, from left to right, 1 to M).

As shown by the arrows in FIG. 6, it is assumed that an echo is coming from an object located at the top left direction. Accordingly, the direction of the echo, e.g., the incoming radio signal, may be towards the bottom right. According to this example, the further to the left a receive antenna is located, the earlier it will receive a certain phase of the incoming radio signal.

For example, a phase difference, denoted Δφ, between two antennas of the receive antenna array 600 may be determined, e.g., as follows:

$$Δ φ = \frac{2 π}{λ} \cdot d \cdot sin ( θ )$$

wherein λ denotes a wavelength of the incoming radio signal, d denotes a distance between the two antennas, and θ denotes an angle of arrival of the incoming radio signal, e.g., with respect to a normal direction of the array.

In some demonstrative aspects, radar processor 309 (FIG. 3) may be configured to utilize this relationship between phase and angle of the incoming radio signal, for example, to determine the angle of arrival of echoes, for example by performing an FFT, e.g., a third FFT (“angular FFT”) over the antennas.

In some demonstrative aspects, multiple transmit antennas, e.g., in the form of an antenna array having multiple transmit antennas, may be used, for example, to increase the spatial resolution, e.g., to provide high-resolution radar information. For example, a MIMO radar device may utilize a virtual MIMO radar antenna, which may be formed as a convolution of a plurality of transmit antennas convolved with a plurality of receive antennas.

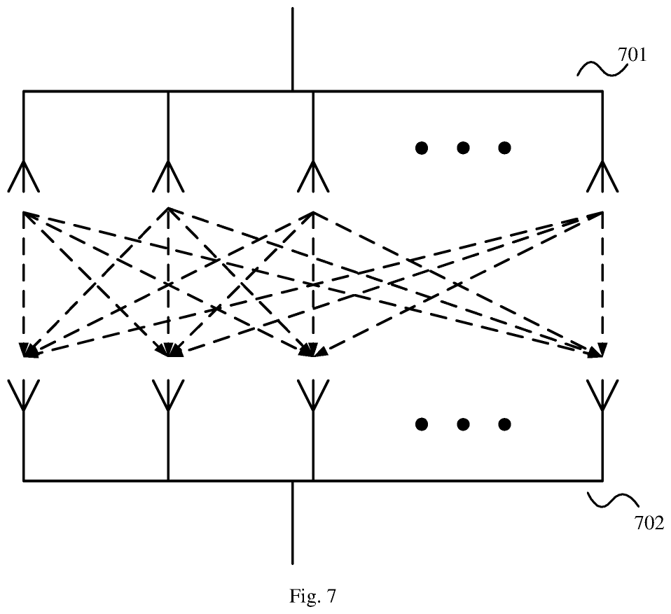

Reference is made to FIG. 7, which schematically illustrates a MIMO radar antenna scheme, which may be implemented based on a combination of Transmit (Tx) and Receive (Rx) antennas, in accordance with some demonstrative aspects.

In some demonstrative aspects, as shown in FIG. 7, a radar MIMO arrangement may include a transmit antenna array 701 and a receive antenna array 702. For example, the one or more transmit antennas 302 (FIG. 3) may be implemented to include transmit antenna array 701, and/or the one or more receive antennas 303 (FIG. 3) may be implemented to include receive antenna array 702.

In some demonstrative aspects, antenna arrays including multiple antennas both for transmitting the radio transmit signals and for receiving echoes of the radio transmit signals, may be utilized to provide a plurality of virtual channels as illustrated by the dashed lines in FIG. 7. For example, a virtual channel may be formed as a convolution, for example, as a Kronecker product, between a transmit antenna and a receive antenna, e.g., representing a virtual steering vector of the MIMO radar.

In some demonstrative aspects, a transmit antenna, e.g., each transmit antenna, may be configured to send out an individual radio transmit signal, e.g., having a phase associated with the respective transmit antenna.

For example, an array of N transmit antennas and M receive antennas may be implemented to provide a virtual MIMO array of size N×M. For example, the virtual MIMO array may be formed according to the Kronecker product operation applied to the Tx and Rx steering vectors.

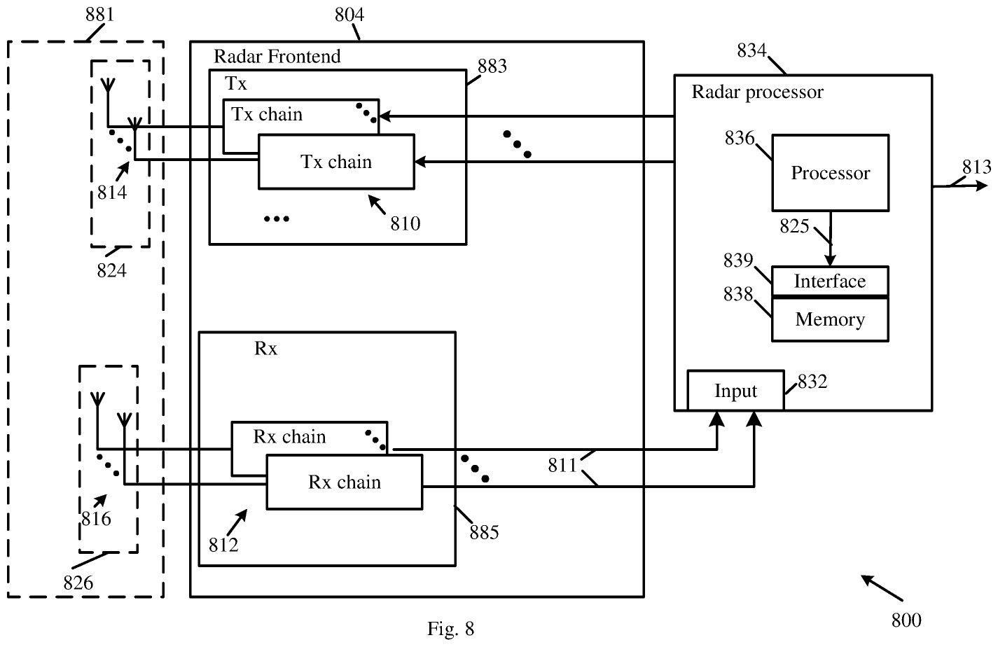

FIG. 8 is a schematic block diagram illustration of elements of a radar device 800, in accordance with some demonstrative aspects. For example, radar device 101 (FIG. 1), radar device 300 (FIG. 3), and/or radar device 400 (FIG. 4), may include one or more elements of radar device 800, and/or may perform one or more operations and/or functionalities of radar device 800.

In some demonstrative aspects, as shown in FIG. 8, radar device 800 may include a radar frontend 804 and a radar processor 834. For example, radar frontend 103 (FIG. 1), radar frontend 211 (FIG. 1), radar frontend 304 (FIG. 3), radar frontend 401 (FIG. 4), and/or radar frontend 502 (FIG. 5), may include one or more elements of radar frontend 804, and/or may perform one or more operations and/or functionalities of radar frontend 804.

In some demonstrative aspects, radar frontend 804 may be implemented as part of a MIMO radar utilizing a MIMO radar antenna 881 including a plurality of Tx antennas 814 configured to transmit a plurality of Tx RF signals (also referred to as “Tx radar signals”); and a plurality of Rx antennas 816 configured to receive a plurality of Rx RF signals (also referred to as “Rx radar signals”), for example, based on the Tx radar signals, e.g., as described below.

In some demonstrative aspects, MIMO antenna array 881, antennas 814, and/or antennas 816 may include or may be part of any type of antennas suitable for transmitting and/or receiving radar signals. For example, MIMO antenna array 881, antennas 814, and/or antennas 816, may be implemented as part of any suitable configuration, structure, and/or arrangement of one or more antenna elements, components, units, assemblies, and/or arrays. For example, MIMO antenna array 881, antennas 814, and/or antennas 816, may be implemented as part of a phased array antenna, a multiple element antenna, a set of switched beam antennas, and/or the like. In some aspects, MIMO antenna array 881, antennas 814, and/or antennas 816, may be implemented to support transmit and receive functionalities using separate transmit and receive antenna elements. In some aspects, MIMO antenna array 881, antennas 814, and/or antennas 816, may be implemented to support transmit and receive functionalities using common and/or integrated transmit/receive elements.

In some demonstrative aspects, MIMO radar antenna 881 may include a rectangular MIMO antenna array, and/or curved array, e.g., shaped to fit a vehicle design. In other aspects, any other form, shape and/or arrangement of MIMO radar antenna 881 may be implemented.

In some demonstrative aspects, radar frontend 804 may include one or more radios configured to generate and transmit the Tx RF signals via Tx antennas 814; and/or to process the Rx RF signals received via Rx antennas 816, e.g., as described below.

In some demonstrative aspects, radar frontend 804 may include at least one transmitter (Tx) 883 including circuitry and/or logic configured to generate and/or transmit the Tx radar signals via Tx antennas 814.

In some demonstrative aspects, radar frontend 804 may include at least one receiver (Rx) 885 including circuitry and/or logic to receive and/or process the Rx radar signals received via Rx antennas 816, for example, based on the Tx radar signals.

In some demonstrative aspects, transmitter 883, and/or receiver 885 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like.

In some demonstrative aspects, transmitter 883 may include a plurality of Tx chains 810 configured to generate and transmit the Tx RF signals via Tx antennas 814, e.g., respectively; and/or receiver 885 may include a plurality of Rx chains 812 configured to receive and process the Rx RF signals received via the Rx antennas 816, e.g., respectively.

In some demonstrative aspects, radar processor 834 may be configured to generate radar information 813, for example, based on the radar signals communicated by MIMO radar antenna 881, e.g., as described below. For example, radar processor 104 (FIG. 1), radar processor 210 (FIG. 2), radar processor 309 (FIG. 3), radar processor 402 (FIG. 4), and/or radar processor 503 (FIG. 5), may include one or more elements of radar processor 834, and/or may perform one or more operations and/or functionalities of radar processor 834.

In some demonstrative aspects, radar processor 834 may be configured to generate radar information 813, for example, based on radar Rx data 811 received from the plurality of Rx chains 812. For example, radar Rx data 811 may be based on the radar Rx signals received via the Rx antennas 816.

In some demonstrative aspects, radar processor 834 may include an input 832 to receive radar input data, e.g., including the radar Rx data 811 from the plurality of Rx chains 812.

In some demonstrative aspects, radar processor 834 may include, or may be implemented, partially or entirely, by circuitry and/or logic, e.g., one or more processors including circuitry and/or logic, memory circuitry and/or logic. Additionally or alternatively, one or more functionalities of radar processor 834 may be implemented by logic, which may be executed by a machine and/or one or more processors, e.g., as described below.

In some demonstrative aspects, radar processor 834 may include at least one processor 836, which may be configured, for example, to process the radar Rx data 811, and/or to perform one or more operations, methods, and/or algorithms.

In some demonstrative aspects, radar processor 834 may include at least one memory 838, e.g., coupled to the processor 836. For example, memory 838 may be configured to store data processed by radar processor 834. For example, memory 838 may store, e.g., at least temporarily, at least some of the information processed by the processor 836, and/or logic to be utilized by the processor 836.

In some demonstrative aspects, processor 836 may interface with memory 838, for example, via a memory interface 839.

In some demonstrative aspects, processor 836 may be configured to access memory 838, e.g., to write data to memory 838 and/or to read data from memory 838, for example, via memory interface 839.

In some demonstrative aspects, memory 838 may be configured to store at least part of the radar data, e.g., some of the radar Rx data or all of the radar Rx data, for example, for processing by processor 836, e.g., as described below.

In some demonstrative aspects, memory 838 may be configured to store processed data, which may be generated by processor 836, for example, during the process of generating the radar information 813, e.g., as described below.

In some demonstrative aspects, memory 838 may be configured to store range information and/or Doppler information, which may be generated by processor 836, for example, based on the radar Rx data. In one example, the range information and/or Doppler information may be determined based on a Cross-Correlation (XCORR) operation, which may be applied to the radar Rx data. Any other additional or alternative operation, algorithm and/or procedure may be utilized to generate the range information and/or Doppler information.

In some demonstrative aspects, memory 838 may be configured to store AoA information, which maybe generated by processor 836, for example, based on the radar Rx data, the range information and/or Doppler information. In one example, the AoA information may be determined based on an AoA estimation algorithm. Any other additional or alternative operation, algorithm and/or procedure may be utilized to generate the AoA information.

In some demonstrative aspects, radar processor 834 may be configured to generate the radar information 813 including one or more of range information, Doppler information, and/or AoA information.

In some demonstrative aspects, the radar information 813 may include Point Cloud 1 (PC1) information, for example, including raw point cloud estimations, e.g., Range, Radial Velocity, Azimuth and/or Elevation.

In some demonstrative aspects, the radar information 813 may include Point Cloud 2 (PC2) information, which may be generated, for example, based on the PC1 information. For example, the PC2 information may include clustering information, tracking information, e.g., tracking of probabilities and/or density functions, bounding box information, classification information, orientation information, and the like.

In some demonstrative aspects, the radar information 813 may include target tracking information corresponding to a plurality of targets in an environment of the radar device 800, e.g., as described below.

In some demonstrative aspects, radar processor 834 may be configured to generate the radar information 813 in the form of four Dimensional (4D) image information, e.g., a cube, which may represent 4D information corresponding to one or more detected targets.

In some demonstrative aspects, the 4D image information may include, for example, range values, e.g., based on the range information, velocity values, e.g., based on the Doppler information, azimuth values, e.g., based on azimuth AoA information, elevation values, e.g., based on elevation AoA information, and/or any other values.

In some demonstrative aspects, radar processor 834 may be configured to generate the radar information 813 in any other form, and/or including any other additional or alternative information.

In some demonstrative aspects, radar processor 834 may be configured to process the signals communicated via MIMO radar antenna 881 as signals of a virtual MIMO array formed by a convolution of the plurality of Rx antennas 816 and the plurality of Tx antennas 814.

In some demonstrative aspects, radar frontend 804 and/or radar processor 834 may be configured to utilize MIMO techniques, for example, to support a reduced physical array aperture, e.g., an array size, and/or utilizing a reduced number of antenna elements. For example, radar frontend 804 and/or radar processor 834 may be configured to transmit orthogonal signals via one or more Tx arrays 824 including a plurality of N elements, e.g., Tx antennas 814, and processing received signals via one or more Rx arrays 826 including a plurality of M elements, e.g., Rx antennas 816.

In some demonstrative aspects, utilizing the MIMO technique of transmission of the orthogonal signals from the Tx arrays 824 with N elements and processing the received signals in the Rx arrays 826 with M elements may be equivalent, e.g., under a far field approximation, to a radar utilizing transmission from one antenna and reception with N*M antennas. For example, radar frontend 804 and/or radar processor 834 may be configured to utilize MIMO antenna array 881 as a virtual array having an equivalent array size of N*M, which may define locations of virtual elements, for example, as a convolution of locations of physical elements, e.g., the antennas 814 and/or 816.

In some demonstrative aspects, a radar system may include a plurality of radar devices 800. For example, vehicle 100 (FIG. 1) may include a plurality of radar devices 800, e.g., as described below.

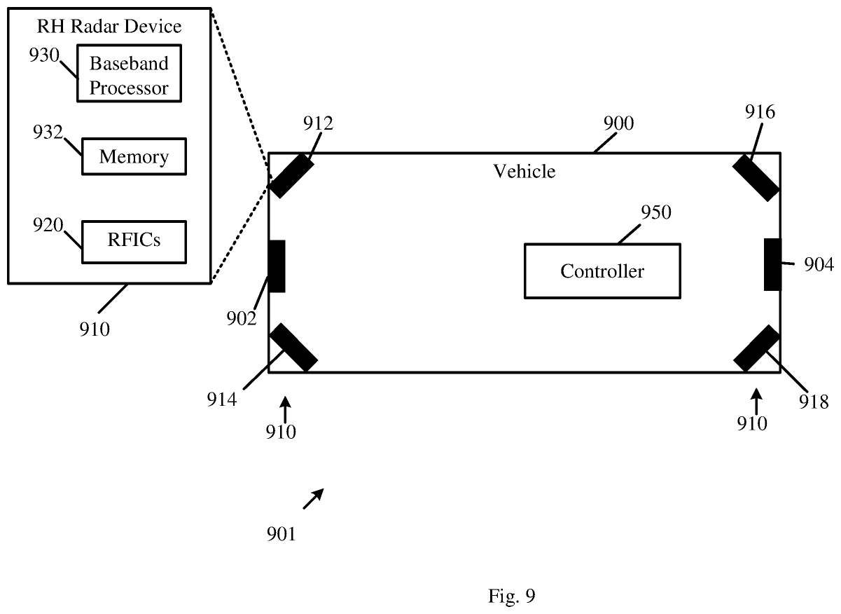

Reference is made to FIG. 9, which schematically illustrates a radar system 901 including a plurality of Radio Head (RH) radar devices (also referred to as RHs) 910 implemented in a vehicle 900, in accordance with some demonstrative aspects.

In some demonstrative aspects, as shown in FIG. 9, the plurality of RH radar devices 910 may be located, for example, at a plurality of positions around vehicle 900, for example, to provide radar sensing at a large field of view around vehicle 900, e.g., as described below.

In some demonstrative aspects, as shown in FIG. 9, the plurality of RH radar devices 910 may include, for example, six RH radar devices 910, e.g., as described below.

In some demonstrative aspects, the plurality of RH radar devices 910 may be located, for example, at a plurality of positions around vehicle 900, which may be configured to support 360-degrees radar sensing, e.g., a field of view of 360 degrees surrounding the vehicle 900, e.g., as described below.

In one example, the 360-degrees radar sensing may allow to provide a radar-based view of substantially all surroundings around vehicle 900, e.g., as described below.

In other aspects, the plurality of RH radar devices 910 may include any other number of RH radar devices 910, e.g., less than six radar devices or more than six radar devices.

In other aspects, the plurality of RH radar devices 910 may be positioned at any other locations and/or according to any other arrangement, which may support radar sensing at any other field of view around vehicle 900, e.g., 360-degrees radar sensing or radar sensing of any other field of view.

In some demonstrative aspects, as shown in FIG. 9, vehicle 900 may include a first RH radar device 902, e.g., a front RH, at a front-side of vehicle 900.

In some demonstrative aspects, as shown in FIG. 9, vehicle 900 may include a second RH radar device 904, e.g., a back RH, at a back-side of vehicle 900.

In some demonstrative aspects, as shown in FIG. 9, vehicle 900 may include one or more of RH radar devices at one or more respective corners of vehicle 900. For example, vehicle 900 may include a first corner RH radar device 912 at a first corner of vehicle 900, a second corner RH radar device 914 at a second corner of vehicle 900, a third corner RH radar device 916 at a third corner of vehicle 900, and/or a fourth corner RH radar device 918 at a fourth corner of vehicle 900.

In some demonstrative aspects, vehicle 900 may include one, some, or all, of the plurality of RH radar devices 910 shown in FIG. 9. For example, vehicle 900 may include the front RH radar device 902 and/or back RH radar device 904.

In other aspects, vehicle 900 may include any other additional or alternative radar devices, for example, at any other additional or alternative positions around vehicle 900. In one example, vehicle 900 may include a side radar, e.g., on a side of vehicle 900.

In some demonstrative aspects, as shown in FIG. 9, vehicle 900 may include a radar system controller 950 configured to control one or more, e.g., some or all, of the RH radar devices 910.

In some demonstrative aspects, at least part of the functionality of radar system controller 950 may be implemented by a dedicated controller, e.g., a dedicated system controller or central controller, which may be separate from the RH radar devices 910, and may be configured to control some or all of the RH radar devices 910.

In some demonstrative aspects, at least part of the functionality of radar system controller 950 may be implemented as part of at least one RH radar device 910.

In some demonstrative aspects, at least part of the functionality of radar system controller 950 may be implemented by a radar processor of an RH radar device 910. For example, radar processor 834 (FIG. 8) may include one or more elements of radar system controller 950, and/or may perform one or more operations and/or functionalities of radar system controller 950.

In some demonstrative aspects, at least part of the functionality of radar system controller 950 may be implemented by a system controller of vehicle 900. For example, vehicle controller 108 (FIG. 1) may include one or more elements of radar system controller 950, and/or may perform one or more operations and/or functionalities of radar system controller 950.

In other aspects, one or more functionalities of system controller 950 may be implemented as part of any other element of vehicle 900.

In some demonstrative aspects, as shown in FIG. 9, an RH radar device 910 of the plurality of RH radar devices 910, may include a baseband processor 930 (also referred to as a “Baseband Processing Unit (BPU)”), which may be configured to control communication of radar signals by the RH radar device 910, and/or to process radar signals communicated by the RH radar device 910. For example, baseband processor 930 may include one or more elements of radar processor 834 (FIG. 8), and/or may perform one or more operations and/or functionalities of radar processor 834 (FIG. 8).

In other aspects, an RH radar device 910 of the plurality of RH radar devices 910 may exclude one or more, e.g., some or all, functionalities of baseband processor 930. For example, controller 950 may be configured to perform one or more, e.g., some or all, functionalities of the baseband processor 930 for the RH.

In one example, controller 950 may be configured to perform baseband processing for all RH radar devices 910, and all RH radio devices 910 may be implemented without baseband processors 930.

In another example, controller 950 may be configured to perform baseband processing for one or more first RH radar devices 910, and the one or more first RH radio devices 910 may be implemented without baseband processors 930; and/or one or more second RH radar devices 910 may be implemented with one or more functionalities, e.g., some or all functionalities, of baseband processors 930.

In another example, one or more, e.g., some or all, RH radar devices 910 may be implemented with one or more functionalities, e.g., partial functionalities or full functionalities, of baseband processors 930.

In some demonstrative aspects, baseband processor 930 may include one or more components and/or elements configured for digital processing of radar signals communicated by the RH radar device 910, e.g., as described below.

In some demonstrative aspects, baseband processor 930 may include one or more FFT engines, matrix multiplication engines, DSP processors, and/or any other additional or alternative baseband, e.g., digital, processing components.

In some demonstrative aspects, as shown in FIG. 9, RH radar device 910 may include a memory 932, which may be configured to store data processed by, and/or to be processed by, baseband processor 930. For example, memory 932 may include one or more elements of memory 838 (FIG. 8), and/or may perform one or more operations and/or functionalities of memory 838 (FIG. 8).

In some demonstrative aspects, memory 932 may include an internal memory, and/or an interface to one or more external memories, e.g., an external Double Data Rate (DDR) memory, and/or any other type of memory.

In other aspects, an RH radar device 910 of the plurality of RH radar devices 910 may exclude memory 932. For example, the RH radar device 910 may be configured to provide radar data to controller 950, e.g., in the form of raw radar data.

In some demonstrative aspects, as shown in FIG. 9, RH radar device 910 may include one or more RF units, e.g., in the form of one or more RF Integrated Chips (RFICs) 920, which may be configured to communicate radar signals, e.g., as described below.

For example, an RFIC 920 may include one or more elements of front-end 804 (FIG. 8), and/or may perform one or more operations and/or functionalities of front-end 804 (FIG. 8).

In some demonstrative aspects, the plurality of RFICs 920 may be operable to form a radar antenna array including one or more Tx antenna arrays and one or more Rx antenna arrays.

For example, the plurality of RFICs 920 may be operable to form MIMO radar antenna 881 (FIG. 8) including Tx arrays 824 (FIG. 8), and/or Rx arrays 826 (FIG. 8).

In some demonstrative aspects, the plurality of RH radar devices 910 may be installed, for example, as integrated units around vehicle 900, for example, in the front, the rear, and/or corners of vehicle 900. For example, the plurality of RH radar devices 910 may be installed at a low position, e.g., at a bumper level of a bumper of vehicle 900, and/or or at a high position, e.g., on top of the vehicle 900, for example, on a roof of the vehicle.

In one example, radar devices may be positioned at dedicated high positions on vehicle 900, for example, to allow long-range detection and/or a clear Field of View (FoV).

In some demonstrative aspects, for example, in some use cases, scenarios, and/or implementations, there may be a need to address one or more technical issues of techniques implementing radar systems using radar devices, e.g., possibly of different types, each performing an entire radar functionality, e.g., from antenna processing to point cloud information or a detection list, e.g., as described below.

In one example, using different types of radar devices that perform the entire radar functionality may result in a complicated radar system.

In another example, an implementation integrating in a single radar unit all components of a radar device, e.g., RF antennas, RF and analog chains, compute algorithmic engines doing cross-correlation, Doppler processing and/or AoA processing, and/or compute engines for stateful post-processing, may result in a radar device having a relatively large size, a relatively heavy weight, and/or a relatively high power consumption.

In another example, an implementation integrating in a single radar unit all components of a radar device may suffer mechanical and/or heat-dissipation issues. For example, when all components are integrated in the same radar unit, the entire unit should be placed at a vehicle side wall, for example, due to a requirement that the antennas are to be placed at the vehicle side wall. Accordingly, this positioning of the entire radar unit at the vehicle side wall may cause mechanical and/or heat-dissipation issues.

In another example, in an implementation of a radar system including radar devices placed at separate positions, e.g., in a vehicle, it may be difficult to share data of the separate radar devices, and/or to share compute resources between the radar devices. Accordingly, such implementations may provide a non-optimized solution, as these implementations may have limited possibilities to support load-balancing and/or failover architectures.

In some demonstrative aspects, for example, in some use cases, scenarios, and/or implementations, there may be a need to address one or more technical issues of techniques implementing radar systems using joint processing of multiple radar devices, e.g., as described below.

For example, higher layer processing or joint processing of the radar devices may be performed on a single radar device or as a fusion of point cloud information or detection lists from the radar devices.

For example, joint processing may be performed based on point cloud fusion of point cloud information from multiple radar devices. The joint processing may be based on raw point cloud information from the plurality of radar devices as an input to a fusion function.

In one example, the joint processing may be limited and/or bound by a tradeoff between hard performance versus implementation efficiency, e.g., power consumption, form factors, weight, cost, or the like. For example, the larger the aperture, the better the performance. However, the better performance may be at a cost of a high complexity and/or a bulky implementation.

In some demonstrative aspects, there may be a need to address one or more technical issues of a Multi Static (MS) radar configuration, which may be implemented, for example, to enable improved radar resolution. For example, radar transmit and receive antennas of a MS radar configuration may be located at different places and/or at different RHs. For example, coherent MS radar configuration may provide improved resolution compared to a non-coherent MS radar configuration. For example, syncing different RHs to a level of picoseconds may not be a trivial task.

In some demonstrative aspects, there may be a need to provide a technical solution for joint processing of radar devices.

In some demonstrative aspects, radar system 901 may be configured to provide a technical solution to implement a radar system according to a distributed radar system architecture, which may support high performance, for example, with a light weight, low power, a compact form-factor and/or a low cost radar system, e.g., as described below.

In some demonstrative aspects, the distributed radar system architecture may be configured to support a digital de-chirp radar architecture, e.g., as described below.

In some demonstrative aspects, the distributed radar system architecture may be configured to provide a technical solution according, for example, to a view point of an entire vehicle, for example, to provide a sensing suit for autonomous vehicles, which may have high performance and/or a low implementation penalty. For example, the distributed radar system architecture may be configured to provide a technical solution to “break” the tradeoff between performance and implementation of an integrated radar system.

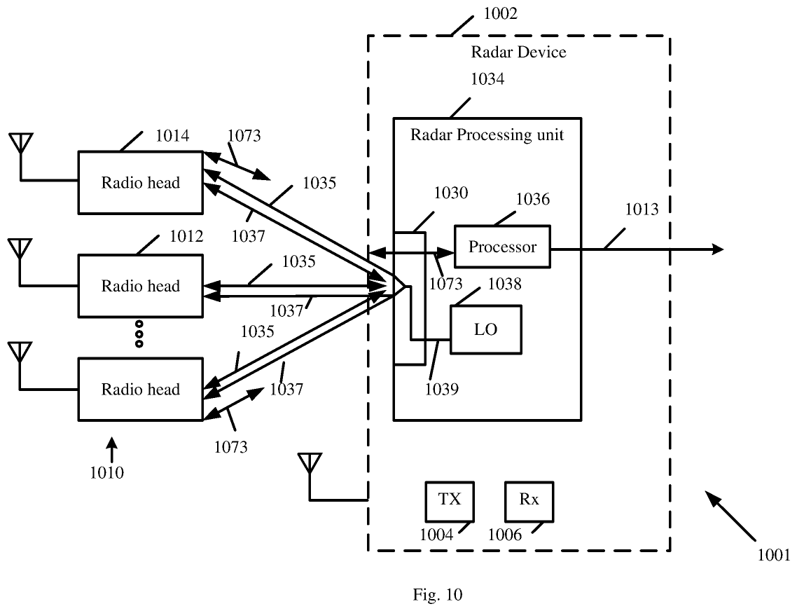

Reference is made to FIG. 10, which schematically illustrates a radar system 1001, in accordance with some demonstrative aspects. For example, radar system 901 (FIG. 9) may include one or more elements of radar system 1001, and/or may perform one or more operations and/or functionalities of radar system 1001.

In some demonstrative aspects, as shown in FIG. 10, radar system 1001 may include a plurality of RHs 1010. For example, one or more, e.g., some or all, RH radar devices of the plurality of RH radar devices 910 (FIG. 9) may include one or more elements of one or more RHs 1010, and/or may perform one or more operations and/or functionalities of one or more RHs 1010. For example, an RH radar device 910 (FIG. 9) may include one or more elements of an RH 1010, and/or may perform one or more operations and/or functionalities of an RH 1010.

In some demonstrative aspects, the plurality of RHs 1010 may include a first RH 1012, and/or a second RH 1014, e.g., as described below.

In some demonstrative aspects, as shown in FIG. 10, radar system 1001 may include a radar processing unit (also referred to as “main unit”, “main processor, “central processor”, “radar processor” or “radar controller”) 1034, which may be configured, for example, to generate processed radar information 1013, for example, based on radar communications by the plurality of RHs 1010, e.g., as described below.

In some demonstrative aspects, as shown in FIG. 10, radar processing unit 1034 may include a communication interface 1030 configured to communicate with the plurality of RHs 1010, e.g., as described below.

In some demonstrative aspects, the communication interface 1030 may be configured with a redundancy factor greater than 1, e.g., as described below.

In other aspects, communication interface 1030 may be configured without redundancy.

In some demonstrative aspects, radar processing unit 1034 may include a processor 1036 configured to coordinate radar communications by the plurality of RHs 1010 and to generate processed radar information 1013, for example, based on the radar communications by the plurality of RHs 1010, e.g., as described below.

In some demonstrative aspects, processor 1036 may include, or may be implemented, partially or entirely, by circuitry and/or logic, e.g., one or more processors including circuitry and/or logic, memory circuitry and/or logic. Additionally or alternatively, one or more functionalities of processor 1036 may be implemented by logic, which may be executed by a machine and/or one or more processors, e.g., as described below.

In some demonstrative aspects, processor 1036 may be configured to transmit synchronization information 1035 to the plurality of RHs 1010, for example, via the communication interface 1030, e.g., as described below.

In some demonstrative aspects, the synchronization information 1035 may be configured to synchronize the radar communications by the plurality of RHs 1010, e.g., as described below.

In some demonstrative aspects, processor 1036 may be configured to communicate radar information 1037 with the plurality of RHs 1010, for example, via the communication interface 1030, e.g., as described below.

In some demonstrative aspects, radar information 1037 may include, for example, radar Tx information and/or radar Rx information, which may be communicated with the plurality of RHs 1010, e.g., as described below.

In some demonstrative aspects, processor 1036 may be configured to communicate the radar Tx information and/or the radar Rx information with the plurality of RHs 1010, for example, via the communication interface 1030, e.g., as described below.

In some demonstrative aspects, the radar Tx information may be configured to configure radar Tx signals to be transmitted by one or more Tx chains of the plurality of RHs 1010, e.g., as described below.

In some demonstrative aspects, the radar Rx information may be based on radar Rx signals received by one or more Rx chains of the plurality of RHs 1010, e.g., as described below.

In some demonstrative aspects, the communication interface 1030 may include a high bandwidth (BW) cable, e.g., as described below.

In some demonstrative aspects, the communication interface 1030 may include a dielectric waveguide communication interface, for example, to communicate the synchronization information, and/or the radar information 1037, e.g., the radar Tx information and/or the radar Rx information, with the plurality of RHs 1010 via a dielectric waveguide interconnect, e.g., as described below.

In some demonstrative aspects, the communication interface 1030 may include an Active Optical Cable (AOC) communication interface, for example, to communicate the synchronization information, and/or the radar information 1037, e.g., the radar Tx information and/or the radar Rx information, with the plurality of RHs 1010 via an AOC interconnect, e.g., as described below.

In some demonstrative aspects, the communication interface 1030 may include a fiber optic communication interface, for example, to communicate the synchronization information, and/or the radar information 1037, e.g., the radar Tx information and/or the radar Rx information, with the plurality of RHs 1010 via a fiber optic interconnect, e.g., as described below.

In other aspects, the communication interface 1030 may include any other additional or alternative communication interface, for example, to communicate the synchronization information, and/or the radar information 1037, e.g., the radar Tx information and/or the radar Rx information, with the plurality of RHs 1010 via any other interconnect.

In some demonstrative aspects, the synchronization information 1035 may be configured to synchronize the radar communications by the plurality of RHs 1010, for example, in phase and/or in time, e.g., as described below.

In some demonstrative aspects, the synchronization information 1035 may include a common Local Oscillator (LO) signal 1039, for example, from an LO 1038, which may be distributed to the plurality of RHs 1010, for example, via the communication interface 1030, e.g., as described below.

In other aspects, an RH 1010, e.g., each RH 1010, may include a local LO. For example, synchronization information 1035 may include a synchronization signal for timing synchronization between local LOs of the RHs 1010, for example, to maintain coherency.

In some demonstrative aspects, the communication interface 1030 may be configured to transmit the common LO signal 1039 to the plurality of RHs 1010, for example, in the form of an analog LO signal, e.g., as described below.

In other aspects, the communication interface 1030 may be configured to transmit the common LO signal 1039 to the plurality of RHs 1010 in any other form.

In some demonstrative aspects, synchronization information 1035 may include time synchronization information to synchronize in time the radar communications by the plurality of RHs 1010.

In some demonstrative aspects, the synchronization information 1035 may include any other additional or alternative information to synchronize the radar communications by the plurality of RHs 1010, for example, in phase and/or in time.

In some demonstrative aspects, processor 1036 may be configured to transmit the radar Tx information to one or more of the RHs 1010, for example, via the communication interface 1030, e.g., as described below.

In some demonstrative aspects, processor 1036 may be configured to generate the radar Tx information, for example, to configure a MIMO radar transmission via a MIMO array formed by antennas of two or more, e.g., some or all, of the plurality of RHs 1010, e.g., as described below.

In some demonstrative aspects, processor 1036 may be configured to generate the radar Tx information to configure a simultaneous radar transmission by at least a first Rh and second RH, for example, RH 1012 and/or RH 1014, e.g., as described below.

In some demonstrative aspects, the simultaneous radar transmission may include transmission of first radar Tx signals by the first RH, e.g., RH 1012, and transmission of second radar Tx signals by the second RH, e.g., RH 1014, e.g., as described below.

In some demonstrative aspects, radar system 1001 may be configured to provide a technical solution to support implementation of one or more RHs 1010, e.g., some or all RHs 1010, as digital RHs (also referred to as “smart” RHs), which may be configured to communicate digital radar information with the radar processing unit 1034, e.g., as described below.

In some demonstrative aspects, an RH 1010, e.g., some of the RHs 1010 or each RH 1010, may be configured as a smart RH to communicate radar information 1037 in the form of digital information, with the radar processor 1036, and to receive from the radar processor 1036 the synchronization information 1039 in the form of analog information, e.g., as described below.

In some demonstrative aspects, the “smart” radar heads, may be implemented, for example, as part of a distributed radar system architecture, e.g., of radar system 1001, which may be configured to support a digital and/or an analog de-chirp radar architecture, e.g., as described below.

In some demonstrative aspects, radar system 1001 may be configured to provide a technical solution to support implementation of a high data rate link to communicate digital samples between radar processing unit 1034 to an RH 1010, and to communicate analog synchronization signals, e.g., in a direction (“Tx direction”) from a radar processor to an RH, for example, from radar processing unit 1034 to an RH 1010, e.g., as described below.

In some demonstrative aspects, radar system 1001 may be configured according to a smart RH architecture, which may be configured to provide a technical solution to support reduction of a data rate over the high data rate link, for example, based on one or more radar signal processing and/or compression mechanisms, e.g., as described below.

In some demonstrative aspects, the “smart” RH architecture may be implemented to support a technical solution, which may be less prone to Electromagnetic interference (EMI), and therefore, may be more protected, e.g., as the radar information is communicated between the radar processing unit 1034 and the smart RH 1010 in a digital form.

In some demonstrative aspects, the “smart” RH architecture may be implemented to provide a technical solution utilizing one or more “smart” Tx RHs, which may support an efficient and/or a low cost implementation, e.g., as described below. For example, digital Tx radar information communicated over a communication interconnect between radar processing unit 1034 and a smart Tx RH 1010 may have a relatively very low data rate.

In some demonstrative aspects, the communication interface 1030 may be configured to transmit to an RH 1010, e.g., RH 1012 and/or RH 1014, one or more digital Tx signals for the RH, e.g., as described below.

In some demonstrative aspects, the one or more digital Tx signals for the RH may include information to configure one or more Tx signals for one or more respective Tx chains of the RH, e.g., as described below.

In some demonstrative aspects, the Tx signals for the RH may include one or more digital Base-Band (BB) Tx signals for one or more respective Tx chains of the RH, e.g., as described below.

In some demonstrative aspects, the Tx signals for the RH may include one or more digital Intermediate Frequency (IF) Tx signals for one or more respective Tx chains of the RH, e.g., as described below.

In some demonstrative aspects, the one or more digital Tx signals for the RH may include information to configure one or more RF Tx signals for one or more respective Tx chains of the RH, e.g., as described below.

In some demonstrative aspects, the information to configure one or more Tx signals for one or more respective Tx chains of the RH may include a waveform signal for a Tx chain and/or information to define the waveform for the Tx chain, for example, one or more Tx chirp signal parameters, and/or the like.

In some demonstrative aspects, processor 1036 may be configured to process the radar Rx information received via the communication interface 1030, and to generate the processed radar information 1013, for example, based on the radar Rx information, e.g., as described below.

In some demonstrative aspects, processor 1036 may be configured to receive via communication interface 1030 one or more digital Rx signals from an RH 1010, for example, RH 1012 and/or RH 1014, e.g., as described below.

In some demonstrative aspects, the one or more digital Rx signals from the RH 1012 may be based on signals received by one or more respective Rx chains of the RH 1012; and/or the one or more digital Rx signals from the RH 1014 may be based on signals received by one or more respective Rx chains of the RH 1014, e.g., as described below.

In some demonstrative aspects, the one or more digital Rx signals from an RH 1010, e.g., RH 1012 and/or RH 1014, may include compressed Rx information representing Rx radar samples corresponding to the signals received by the one or more Rx chains of the RH 1010, e.g., as described below. For example, RH 1010, e.g., RH 1012 and/or RH 1014, may be configured to generate the compressed Rx information according to a predefined compression scheme, for example, to reduce the amount of data communicated over the communication interface 1030.

In some demonstrative aspects, processor 1036 may be configured to decompress the compressed Rx information, for example, from the RH 1010, e.g., as described below.

In some demonstrative aspects, processor 1036 may be configured to transmit radar Tx parameter information to the RH 1010, e.g., RH 1012 and/or RH 1014, for example, via the communication interface 1030, e.g., as described below.

In some demonstrative aspects, the radar Tx parameter information may correspond to a radar transmission to be received by the one or more Rx chains of the RH 1010, e.g., RH 1012 and/or RH 1014, e.g., as described below.

In some demonstrative aspects, processor 1036 may be configured to decompress the compressed Rx information from the RH 1010, e.g., RH 1012 and/or RH 1014, for example, based on the radar Tx parameter information provided to the RH 1010, e.g., RH 1012 and/or RH 1014, e.g., as described below.

In some demonstrative aspects, processor 1036 and/or the RH 1010 may be configured to utilize one or more compression methods, which may be based, for example, on a specific radar processing stage, e.g., a range processing stage, a pulse-compression stage, a Doppler processing stage, and/or any other additional or alternative processing stage. In one example, the radar processing stage may be based on a Matched Filter, a Miss-Matched Filter, and/or any other mechanism. In this case, information about a relevant Tx transmission may be communicated to the Rx part of the RH 1010. For example, the radar Tx parameter information may be related to a plurality of Tx channels and/or heads.

In some demonstrative aspects, processor 1036 may be configured to receive via communication interface 1030 the radar Rx information, which may include first radar Rx information from a first RH, e.g., RH 1012, and second radar Rx information from a second RH, e.g., RH 1014, e.g., as described below.

In some demonstrative aspects, processor 1036 may be configured to generate the processed radar information 1013, for example, based on joint processing of the first radar Rx information from the first RH 1012 and the second radar Rx information from the second RH 1014, e.g., as described below.

In some demonstrative aspects, processor 1036 may be configured to generate the radar Tx information to configure a radar transmission from a particular RH, for example, RH 1012, e.g., as described below.

In some demonstrative aspects, processor 1036 may be configured to generate the processed radar information 1013, for example, by processing radar Rx information from the particular RH, e.g., from RH 1012, for example, based on the radar Tx information provided to the particular RH, e.g., as described below.

In some demonstrative aspects, processor 1036 may be configured to generate the radar Tx information to configure a radar transmission from a first RH, for example, RH 1012, e.g., as described below.

In some demonstrative aspects, processor 1036 may be configured to generate the processed radar information 1013 based on radar Rx information from a second RH, for example, RH 1014, e.g., as described below.

In some demonstrative aspects, the radar Rx information from the second RH 1014 may be based on the radar transmission from the first RH 1012, e.g., as described below.

In some demonstrative aspects, processor 1036 may be configured to generate the radar Tx information to configure a first radar transmission from a first RH, e.g., RH 1012, and a second radar transmission from a second RH, e.g., RH 1014.

In some demonstrative aspects, processor 1036 may be configured to generate the processed radar information 1013 based on radar Rx information from one or more RHs 1010, which may be configured to receive and process the first radar transmission and/or the second radar transmission.

For example, processor 1036 may be configured to generate the processed radar information 1013 based on radar Rx information from the first RH, from the second RH, from both the first RH and the second RH, from a third RH 1010, from the third RH and a fourth RH 1010, and/or based on any other combination of RHs 1010, which may be configured to receive and process the first radar transmission and/or the second radar transmission.

In some demonstrative aspects, processor 1036 may be configured to communicate radar control information 1073 with one or more RHs of the plurality of RHs 1010, for example, via the communication interface 1030, e.g., as described below.

In some demonstrative aspects, the radar control information 1073 for an RH 1010 may include control information to control one or more functionalities of the RH 1010, e.g., as described below.

In some demonstrative aspects, the radar control information 1073 for an RH 1010 may include Tx control information to control one or more Tx functionalities of the RH 1010.

For example, the Tx control information may include Tx parameter information to configure one or more Tx parameters to be utilized by the RH for transmission of radar Tx signals.

For example, the Tx parameter information may include waveform information to configure a Tx waveform to be utilized by the RH for transmission of radar Tx signals. For example, the Tx parameter information may include information to configure a center frequency, a bandwidth, a start time, a state machine state, and/or any other Tx parameter.

For example, the Tx control information may include Tx calibration information to configure a calibration scheme to be utilized by the RH for transmission of radar Tx signals, e.g., to account of LO delay variance, manufacturing tolerance, changes in position, and/or any other calibration purpose. For example, the Tx calibration information may include information to configure a Direct Current (DC) offset, a self-calibration, and/or any other calibration information.

In some demonstrative aspects, the radar control information 1073 for an RH 1010 may include Rx control information to control one or more Rx functionalities of the RH 1010.

For example, the Rx control information may include Rx parameter information to configure one or more Rx parameters to be utilized by the RH for processing radar Rx signals.

For example, the Rx parameter information may include waveform information to configure an Rx waveform to be received by the RH. For example, the Rx parameter information may include information to configure a center frequency, a bandwidth, a start time, a state machine state, and/or any other Rx parameter.

For example, the Rx control information may include Rx calibration information to configure a calibration scheme to be utilized by the RH for reception of radar Rx signals, e.g., to account of LO delay variance, manufacturing tolerance, changes in position, and/or any other calibration purpose. For example, the Rx calibration information may include information to configure a DC offset, a delay, a self-calibration, and/or any other calibration information.

In some demonstrative aspects, the radar control information 1073 may include control information (“RH control information”) from an RH 1010 to the radar processing unit 1034.

In some demonstrative aspects, control information from an RH 1010 to the radar processing unit 1034 may include information retrieved from one or more registers in the RH 1010.

In some demonstrative aspects, control information from an RH 1010 to the radar processing unit 1034 may include status information to indicate a status of one or more operations performed by the RH 1010, e.g., a Tx status message to indicate a status of a transmission performed by the RH 1010.

In some demonstrative aspects, control information from an RH 1010 to the radar processing unit 1034 may include acknowledgement (ack) information to acknowledge one or more operations, e.g., to acknowledge receipt of information and/or instructions from the radar processing unit 1034, and/or to confirm execution of instructions from the radar processing unit 1034.

In some demonstrative aspects, control information from an RH 1010 to the radar processing unit 1034 may include a request from RH 1010 to the radar processing unit 1034, for example, a retransmission request.

In some demonstrative aspects, control information from an RH 1010 to the radar processing unit 1034 may include operating information, for example, to indicate one or more operating conditions of RH 1010, e.g., a temperature or the like.

In some demonstrative aspects, control information from an RH 1010 to the radar processing unit 1034 may include error information, for example, to indicate an error and/or malfunction of RH 1010.

In some demonstrative aspects, processor 1036 may be configured to communicate radar control information 1073 together with the radar information 1037, e.g., on a same channel via the communication interface 1030. For example, the processor 1036 may be configured to communicate radar control information 1073 together with the radar information 1037 over a digital link via communication interface 1030. In one example, processor 1036 may be configured to digitally interleave radar control information 1073 with the radar information 1037.

In some demonstrative aspects, processor 1036 may be configured to communicate radar control information 1073 on a control channel via the communication interface 1030, e.g., separate from a channel for the radar information 1037. In one example, the radar control information 1073 may be communicated over a digital channel, e.g., a low-rate digital channel which may be dedicated to communicate the radar control information 1073.

In some demonstrative aspects, processor 1036 may be configured to generate the processed radar information 1013, for example, based on installation information corresponding to an installation configuration of one or more of the plurality of RHs 1010, e.g., as described below.

In some demonstrative aspects, the installation information may include position information corresponding to positions of one or more of the plurality of RHs 1010, e.g., as described below.

For example, the position information corresponding to an RH may include location information corresponding to a location of the RH, e.g., location coordinates of the RH; orientation information corresponding to an orientation of the RH, e.g., a direction and/or angle of the RH, and/or any other type of information corresponding to a positioning, placement, directionality, and/or arrangement of the RH.

In some demonstrative aspects, the installation information may include FoV information corresponding to FoVs of one or more of the plurality of RHs 1010, e.g., as described below.

In one example, the FoV information for an RH may include FoV-blockage information to indicate a blocking of the FoV of the RH, for example, by the vehicle, e.g., as described below.

In some demonstrative aspects, the installation information may include configuration information corresponding to installed configurations of one or more of the plurality of RHs 1010.

For example, the installation information corresponding to an RH may include information of a type of the RH; information of a version of the RH, e.g., a hardware version, a software version, and/or a firmware version; and/or information of capabilities of the RH, e.g., RF capabilities, processing capabilities, hardware capabilities, and/or software capabilities.

In other aspects, the installation information may include any other additional or alternative information corresponding to an installation, position, setting, and/or configuration of one or more of the plurality of RHs 1010.

In some demonstrative aspects, the radar processing unit 1034 may be implemented, for example, as part of a radar device 1002 of radar system 1000, e.g., as described below.

In other aspects, radar processing unit 1034 may be implemented, for example, as a separate element of radar system 1000.

In other aspects, radar processing unit 1034 may be implemented, for example, as part of any other element and/or component of radar system 1000.

In some demonstrative aspects, radar device 1002 may include a transmitter 1004 and/or a receiver 1006, e.g., as described below. For example, radar device 1002 may include one or more elements of a radio device 800 (FIG. 8), and/or may perform one or more operations and/or functionalities of radio device 800 (FIG. 8).

In some demonstrative aspects, processor 1036 may be configured to control the transmitter 1004 to transmit radar Tx signals of the radar device 1002, e.g., as described below.

In some demonstrative aspects, processor 1036 may be configured to generate the processed radar information 1013 based on radar Rx signals received by the receiver 1006, e.g., as described below.

In some demonstrative aspects, processor 1036 may be configured to synchronize the radar communications by the plurality of RHs 1010, for example, to radar communications of the radar device 1002, e.g., as described below. For example, processor 1036 may be configured to generate the synchronization information 1035 to synchronize the radar communications by the plurality of RHs 1010, for example, to radar communications of the radar device 1002.

In some demonstrative aspects, as shown in FIG. 10, radar processing unit 1034 may be shared between a plurality of N RHs 1010.

In some demonstrative aspects, an RH 1010, e.g., each RH 1010, may be capable of up and/or down conversion of signals, e.g., BB and/or IF signals, from/to an RF band, for example, an automotive radar RF band, which may be used for communication of radar signals for automotive use, and/or any other use.

In some demonstrative aspects, radar processing unit 1034 may be configured to perform signal processing of the radar communications performed by RHs 1010 and/or to control and/or synchronize the radar communications performed by RHs 1010.

In some demonstrative aspects, for example, radar processing unit 1034 may be configured to perform range processing. Doppler processing, AoA processing, Inter-frame processing, e.g., Synthetic Aperture Radar (SAR) processing, detection, reporting, interference management, and/or any other additional or alternative functionalities.

In some demonstrative aspects, radar processing unit 1034 may be configured to communicate with the plurality of RHs 1010, e.g., via interface 1030, Tx information, e.g., in the form of a signal waveform and/or any other Tx information, for an RH 1010 with Tx capabilities and/or for an RH which may have a capability to process Rx signals based on the Tx information, e.g., as described below.

In some demonstrative aspects, radar processing unit 1034 may be configured to communicate with the plurality of RHs 1010, e.g., via interface 1030, Rx information, e.g., received signals and/or any other Rx information, which may be received from an RH having Rx capabilities, e.g., as described below. For example, the Rx information from an RH may include information based on received echoes, received interference, and/or any other signals received by the RH.

In some demonstrative aspects, radar processing unit 1034 may be configured to communicate calibration information with one or more RHs of the plurality of RHs 1010, e.g., via interface 1030. In one example, the calibration information may be generated and/or communicated between radar processing unit 1034 and the RHs 1010, per RH and/or per RH RF chain.

In some demonstrative aspects, radar processing unit 1034 may be configured to transmit to the plurality of RHs 1010 the synchronization information 1035 including coherent phase, frequency, and/or time synchronization (sync) signals. For example, the coherent phase, frequency, and/or time synchronization (sync) signals may be provided by a centralized sync-generator module(/s), e.g., LO 1038, which may be implemented by radar processing unit 1034.

In one example, radar processing unit 1034 may be configured to transmit the synchronization information 1035 including two sync signals from two different generation modules, for example, to support different time and phase synchronization signals.

In some demonstrative aspects, the synchronization information 1035 may include a phase sync signal and/or a frequency sync signal. For example, the phase sync signal may include an LO signal, e.g. LO signal 1039, which may be distributed from radar processing unit 1034 to the plurality of RHs 1010.

In some demonstrative aspects, radar system 1001 may be implemented to provide a technical solution to support coherent operation, e.g., phase level coherency, of the plurality of RHs 1010.

In some demonstrative aspects, radar system 1001 may be configured to implement a centralized processing by a central radar processing unit, e.g., radar processing unit 1034, which may be aware of configuration information corresponding to a configuration of the RHs 1010, for example, an array size of an array of antennas utilized by RHs 1010, a geometry of the RHs 1010, vehicle placements of the RHS 1010, an orientation of the RHs 1010, and/or any other additional or alternative information corresponding to the configuration of the RHs 1010. For example, the central radar processing unit, e.g., radar processing unit 1034, may be configured to process radar information corresponding to radar communications performed by the RHs 1010, for example, based on the configuration information corresponding to the configuration of the RHs 1010, e.g., as described below.

In some demonstrative aspects, radar system 1001 may be implemented to provide a technical solution to support central processing of radar information of the plurality of RHs 1010, for example, by radar processing unit 1034. Accordingly, radar system 1001 may be implemented to provide a technical solution to support joint processing, e.g., coherent or incoherent joint processing, and/or data based or model based joint processing, of radar information of the plurality of RHs 1010.

In some demonstrative aspects, radar system 1001 may be implemented to provide a technical solution to support a “local” coherent MS implementation, e.g., with a relatively wide effective aperture.

In some demonstrative aspects, radar system 1001 may be implemented to provide a technical solution to support a distributed MIMO array providing a very wide aperture, for example, with reduced complexity.

In some demonstrative aspects, radar system 1001 may be implemented to provide a technical solution based on distribution of an LO signal, e.g., LO signal 1039, to the plurality of RHs 1010. Accordingly, radar system 1001 may be implemented to provide a technical solution, which does not require a dedicated LO-sync loop function, which may be costly and/or may generate estimation errors.

In some demonstrative aspects, radar system 1001 may be implemented to provide a technical solution based on distribution of an LO signal, e.g., LO signal 1039, to the plurality of RHs 1010, for example, to achieve substantially absolute synchronization, which may enable sophisticated time and/or frequency based co-existence between the plurality of RHs 1010.

In some demonstrative aspects, radar system 1001 may be implemented to provide a technical solution to support ease of installation. For example, a form factor of an RH 1010, e.g., including an antenna, may be as small as O(1 cm). Accordingly, the plurality of RHs 1010 may be installed almost anywhere in a vehicle, e.g., even at an edge of a windshield of the vehicle. For example, the plurality of RHs 1010 may be located to provide an improved FoV and/or point of view for system 1001.

In some demonstrative aspects, radar system 1001 may be implemented to provide a technical solution to support using of small, compact, low power and/or light weight RHs 1010. For example, some or all processing capabilities, which may be major heat generators and power-hungry elements of a radar system, may be implemented at a central/main processor, e.g., radar processing unit 1034. Accordingly, radar system 1001 may be implemented to provide a technical solution to support reduced power consumption and/or heat dissipation real states.

In some demonstrative aspects, radar system 1001 may be implemented to provide a technical solution using the same LO signal distributed for all RHs 1010. Accordingly, radar system 1001 may be implemented to provide a technical solution, which may not require an adaptive calibration function, for example, to sync independent LOs.

In some demonstrative aspects, radar system 1001 may be implemented to provide a technical solution to support a MS radar system configuration and/or a distributed antenna scheme, which may provide superior performance.

In some demonstrative aspects, radar system 1001 may be implemented to provide a technical solution to leverage scale to yield an economic design, e.g., as described below.

In one example, an installation position of radar processing unit 1034 may be arbitrary and, accordingly, the installation position may enable vehicle and/or equipment manufacturers, e.g., Original Equipment Manufacturers (OEMs), to optimize radar system installation, for example, for power distribution, weight balancing, heat dissipation, and/or the like.

In some demonstrative aspects, radar system 1001 may be implemented to provide a technical solution to support a single-power and/or single heat dissipation system, e.g., which may be applied only for radar processing unit 1034.

In some demonstrative aspects, radar system 1001 may be implemented to provide a technical solution to support a single data connection to a vehicle system, e.g., from radar processing unit 1034.

In some demonstrative aspects, radar system 1001 may be implemented to provide a technical solution to support a software implementation of radar processing (partial or full) in a vehicular processor and/or controller, for example, a vehicle Domain Control Unit (DCU), a Zone Control Unit (ZCU), an Electronic Control Unit (ECU), a High Power Computer (HPC) of the vehicle, and/or the like.

In some demonstrative aspects, radar system 1001 may be implemented to provide a technical solution to support a single Baseband Processing Unit (BPU), e.g., a single radar processor or radar MicroProcessor Unit (MPU). For example, processor 1036 may be configured to process signals from the plurality of RHs 1010. Accordingly, a number of different BPU chips may be reduced. Therefore, better and/or more efficient stock and/or product line management may be achieved.

In some demonstrative aspects, radar system 1001 may be implemented to provide a technical solution to support improved diversity and/or efficiency, for example, by decoupling between a radar processing unit and the RHs, for example, as long as they adhere to a same interconnect.

In one example, some vehicles, e.g., higher end vehicles, may be installed with higher end RHs, radar processing units and/or both, while other vehicles, e.g., lower end vehicles, may be installed with lower end RHs, radar processing units and/or both. For example, the higher end radar processing units may be utilized to provide additional features and/or access computation capacity.

In some demonstrative aspects, radar system 1001 may be implemented to provide a technical solution to support product de-coupling, e.g., of next generation products.

In one example, one or more of the RHs 1010 may be upgraded to a next generation, while the radar processing unit 1034 may remain at a configuration of a current generation, e.g., while having a SW update.

In another example, the radar processing unit 1034 may be upgraded, while, one or more of the RHs 1010 may remain at the same configuration.

In some demonstrative aspects, radar system 1001 may be implemented to provide a technical solution to support implementation of various types of RHs 1010, for example, RHs having large arrays versus RHs having small arrays, RHs having conformal arrays versus RHs having non-conformal arrays, and/or the like.

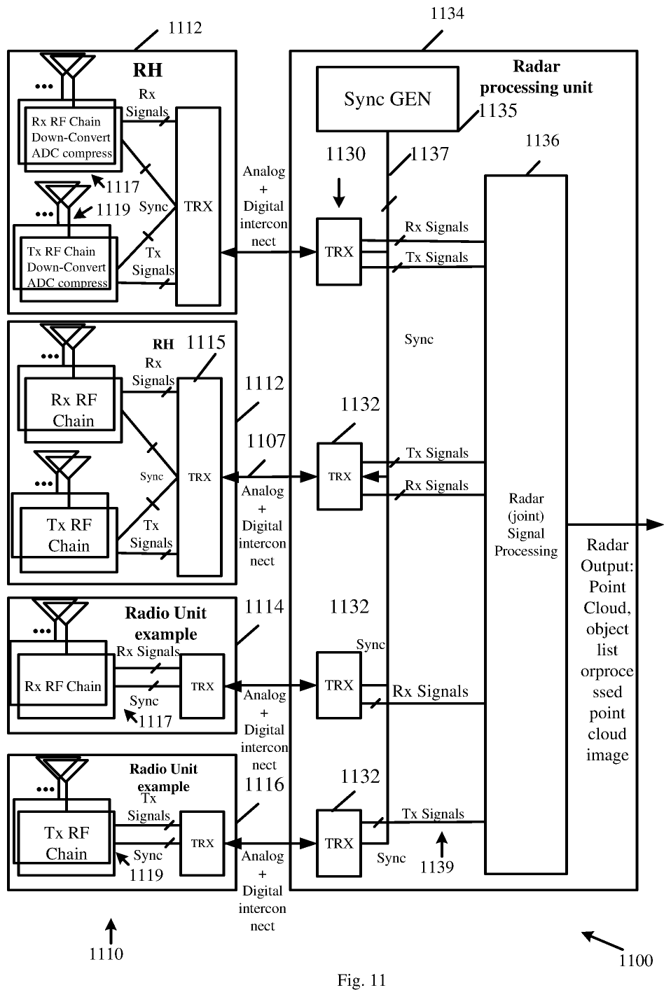

Reference is made to FIG. 11, which schematically illustrates a radar system 1101, in accordance with some demonstrative aspects. For example, radar system 1001 (FIG. 10) may include one or more elements of radar system 1101, and/or may perform one or more operations and/or functionalities of radar system 1101.

In some demonstrative aspects, as shown in FIG. 11, radar system 1101 may include a radar processing unit 1134, which may be configured to coordinate radar communications by a plurality of RHs 1110. For example, radar processing unit 1034 (FIG. 10) may include one or more elements of radar processing unit 1134, and/or may perform one or more operations and/or functionalities of radar processing unit 1134; and/or the plurality of RHs 1010 (FIG. 10) may include one or more elements of the plurality of the RHs 1110, and/or may perform one or more operations and/or functionalities of plurality of RHs 1110.

In some demonstrative aspects, as shown in FIG. 11, radar processing unit 1134 may include a communication interface 1130 configured to communicate with the plurality of RHs 1110. For example, communication interface 1030 (FIG. 10) may include one or more elements of communication interface 1130, and/or may perform one or more operations and/or functionalities of communication interface 1130.

In some demonstrative aspects, as shown in FIG. 11, communication interface 1130 may include a plurality of transceivers (TRX) 1132 to communicate with a respective plurality of transceivers (TRX) 1115 of the plurality of RHs 1110.

In some demonstrative aspects, as shown in FIG. 11, radar system 1101 may include a plurality of interconnects 1107, which may be configured to connect between the plurality of TRX 1132 to TRX 1115.

In some demonstrative aspects, an interconnect 1107 between TRX 1132 and TRX 1115 may include a Fiber and/or Dielectric-Waveguide interconnect.

In some demonstrative aspects, an interconnect 1107 may include a copper interconnect, e.g., including Ethernet for data and coax for sync. In one example, a copper interconnect may have some limitation, e.g., in terms of EMI and/or data rates.

In some demonstrative aspects, a TRX, e.g., a TRX 1132, may be configured to aggregate a multiplicity of Rx and Tx channels, for example, to transfer signals and/or samples between radar processing unit 1134 and an RH 1110.

In some demonstrative aspects, as shown in FIG. 11, the plurality of the RHs 1110 may include a plurality of different types of RHs.

In some demonstrative aspects, as shown in FIG. 11, the plurality of the RHs 1110 may include one or more RHs 1112 having both Tx capabilities and Rx capabilities. For example, the one or more RHs 1112 may include one or more Rx chains 1117, and one or more Tx chains 1119.

In one example, Rx chains 1117 may include a downconverter, an optional ADC, and/or any other Rx elements; and/or Tx chains 1119 may include an upconverter or a Tx signal generator, and/or any other Tx elements.

In some demonstrative aspects, as shown in FIG. 11, the plurality of the RHs 1110 may include one or more RHs 1114 having only Rx capabilities. For example, the one or more RHs 1114 may include one or more Rx chains 1117.

In some demonstrative aspects, as shown in FIG. 11, the plurality of the RHs 1110 may include one or more RHs 1116 having only Tx capabilities. For example, the one or more RHs 1116 may include one or more Tx chains 1119.

In some demonstrative aspects, as shown in FIG. 11, radar system 1101 may incorporate different types of RHs 1110. For example, radar system 1101 may include Tx/Rx RHs, e.g., RHs 112, including Tx and Rx chains and antennas; a Tx-only RHs, e.g., RHs 1116, and/or Rx-only RHs, e.g., RHs 1114.

In some demonstrative aspects, an interconnect between radar processor 1143 and an RH 1110, e.g., interconnect 1107, may include an aggregation of a plurality of channels, e.g., as described below.

In some demonstrative aspects, the plurality of channels may include ab aggregation of multiple digital signals, e.g., sampled signals.

In some demonstrative aspects, radar system 1101 may be configured to provide a technical solution to support distribution of common sync signal/s for time and/or frequency, which may be distributed and shared, e.g., via communication interface 1130, to the RH 1110 across radar system 1101.

In some demonstrative aspects, radar processing unit 1134 may include a synchronization generator 1135, e.g., an LO, to generate an analog LO signal 1137, which may be distributed, e.g., via communication interface 1130, to the RHs 1110 across radar system 1101.

In some demonstrative aspects, the TRX 1132 may be configured to distribute sync signals from the synchronization generator 1135 to the RHS 1110, for example, with a high degree of accuracy.

In some demonstrative aspects, radar processing unit 1134 may be configured to support calibration, e.g., to account for different delay uncertainty and/or placement uncertainty of the RHs 1110.

In some demonstrative aspects, radar system 1101 may be implemented to provide a technical solution to support centralized processing, e.g., and optional joint radar processing, by a central radar processing unit, e.g., radar processing unit 1134, which may generate sync signals, timing signals, digital radar Tx signals, digital data, control signals, host reporting, and/or I/F signals, for the RHs 1110.

In some demonstrative aspects, communication interface 1130 may be configured to support a TRX module function, for example, to distribute Sync signals, e.g., sync signal 1137, and/or Tx and Rx signals between radar processing unit 1134 and the RHs 1110 of radar system 1101.

In some demonstrative aspects, radar system 1101 may be configured according a topology, for example, where some Tx channels and/or Rx channels may not be on a same board or unit. According to this topology, these Tx channels and/or Rx channels may have one or more delays, e.g., unknown temperature dependent delay-differences, which may be caused by interconnect 1107 and/or different routing of sync signals 1137.

In some demonstrative aspects, radar processing unit 1134 may be configured to calibrate the delays, for example, by comparison to a measurement through an RH, which may include both Rx and Tx chains, e.g., RH 1112.

In some demonstrative aspects, communication interface 1130 may be configured to support communicating radar control information on a control channel via the communication interconnect 1007, for example, between an RH 1110 and radar processing unit 1134.

In some demonstrative aspects, radar system 1101 may be configured according a topology (controllerless-RH topology), in which may include one or more controllerless RH, e.g., as described below.

In some demonstrative aspects, a controllerless RH, e.g., RH 1110 may be implemented by excluding one or more. e.g., some or all, functionalities of an RH controller of the RH. In one example, the controllerless RH may exclude all functionalities of an RH controller. In another example, the controllerless RH may include a sequencer.

In some demonstrative aspects, the controllerless-RH topology may include a main unit, e.g., radar processing unit 1134, which may be configured to implement and/or control one or more, e.g., some or all, functionalities of an RH controller for a controllerless RH, e.g., as described below.

In some demonstrative aspects, the controllerless-RH topology maybe configured to provide a technical solution to support an implementation of an RH with reduced cost.

In some demonstrative aspects, radar processing unit 1134 may be configured to communicate digital signals and analog and digital signals, via an interconnect 1107.

In some demonstrative aspects, the analog signals may include synchronization information, e.g., analog LO signal 1137.

In some demonstrative aspects, radar processing unit 1134 may be configured to receive Rx digital signals from an RH 1110 via an interconnect 1107.

In some demonstrative aspects, the Rx digital signals may include signals after sampling, e.g., at the RH 1110.

In some demonstrative aspects, an RH may be configured to provide the Rx digital signals, for example, after partial radar processing and/or compression, which may be utilized in a digital de-chirp implementation, for example, to reduce a bit rate over the interconnect 1107.

In some demonstrative aspects, radar processing unit 1134 may be configured to transmit Tx digital signals to an RH 1110 via an interconnect 1107.

In some demonstrative aspects, the Tx digital signals may be in a form of a stream of samples; a Tx waveform template, which may be downloaded to a local memory in an RH 1110; and/or a list of parameters to be used by a generator module, e.g., within the RH 1110.

In some demonstrative aspects, the Tx digital signals may be implemented to provide a technical solution to support agility of radar system 1101. For example, the agility in the Tx side may be utilized to support interference avoidance and/or adaptive and cognitive radar implementations, e.g., in which the Tx signal may be dynamically modified and/or changed, for example, throughout a ride of the vehicle, for example, based on an environmental status of an environment of the vehicle.

In some demonstrative aspects, radar system 1101 may be configured according to a Multi-Static (MS) radar configuration, for example, implementing a main unit, e.g., radar processing unit 1134, to receive all samples from some or all of the plurality of RHs 1110, and to jointly process them, e.g., as described below.

In some demonstrative aspects, the MS radar configuration may be partially applied, e.g., for partial functionality of radar system 1101 at a time. For example, radar processing unit 1134 may be configured to control RHs 1110 such that one or more RHs 1110, e.g., some or all RHs 1110, transmit radar signals, while one or more RHs 1110, e.g., some or all RHs 1110, receive the radar signals. In one example, radar processing unit 1134 may be configured to control RHs 1110 such that one RH 1110 transmits radar signals, while all RHs 1110 receive the radar signals. In another example, radar processing unit 1134 may be configured to control RHs 1110 such that all RHs 1110 transmit radar signals, while one RH 1110 receives the radar signals. In other aspects, radar processing unit 1134 may be configured to control RHs 1110 according to any other temporal any other combination of Tx and Rx elements, e.g., from a super set of the entire antenna elements available from the plurality of RHs 1110.

In some demonstrative aspects, radar system 1101 may be configured according to an architecture (satellite architecture), in which a main processing unit, e.g., radar processing unit 1134, and a radio unit, e.g., an RH 1110, are integrated. For example, radar processing unit 1134 may be implemented together with an RH 1112. For example, the radar system 1101 may include a main unit, e.g., including an RH and a radar processor, and a plurality of RH satellites, e.g., having only an RH functionality.

In some demonstrative aspects, the main unit may be augmented with the satellite units, for example, to enhance performance for joint processing over a larger aperture size. For example, radar system 1101 may be configured to utilize a virtual radar array formed by antenna arrays of the main unit and antenna arrays of the satellites.

In some demonstrative aspects, the RHs 1110 may be implemented to provide a distributed antenna including antenna elements, e.g., which do not reside in a same module.

In some demonstrative aspects, the distributed antenna may be implemented as a uniform antenna array, e.g., a Uniform Linear Array (ULA), or as a non-uniform antenna array, e.g., a non-ULA; as a 2D or 3D antenna, e.g., when elements are not on a same 2D plane; and/or as a conformal or non-conformal array.

In some demonstrative aspects, Tx and Rx arrays of the distributed antenna may be interchangeable.

In some demonstrative aspects, radar processing unit 1134 may include a processor 1136 configured to coordinate radar communications by the plurality of RHs 1111, and to generate radar information 1113, for example, based on the radar communications by the plurality of RHs 1110. For example, processor 1036 (FIG. 10) may include one or more elements of processor 1136, and/or may perform one or more operations and/or functionalities of processor 1136.

In some demonstrative aspects, processor 1136 may include, or may be implemented, partially or entirely, by circuitry and/or logic, e.g., one or more processors including circuitry and/or logic, memory circuitry and/or logic. Additionally or alternatively, one or more functionalities of processor 1136 may be implemented by logic, which may be executed by a machine and/or one or more processors.

In some demonstrative aspects, processor 1136 may be configured to communicate digital radar information 1139 with the plurality of RHs 1110, for example, via the communication interface 1130.

In some demonstrative aspects, digital radar information 1139 may include, for example, digital radar Tx information and/or digital radar Rx information, which may be communicated with the plurality of RHs 1110.

In some demonstrative aspects, the digital radar Tx information may be configured to configure radar Tx signals to be transmitted by one or more Tx chains of the plurality of RHs 1110.

In some demonstrative aspects, the digital radar Rx information may be based on radar Rx signals received by one or more Rx chains of the plurality of RHs 1110.

In some demonstrative aspects, as shown in FIG. 11, radar system 1100 may be implemented according to a system architecture utilizing two types of units, e.g., the plurality of RHs 1100 and the radar processor 1136.

In some demonstrative aspects, as shown in FIG. 11, an RH 1100, e.g., each RH 1100, may include RF antennas and one or more first digital signal processing stages.

In some demonstrative aspects, an RH 1100, e.g., each RH 1100, may reside at a vehicle side wall of a vehicle.

In some demonstrative aspects, radar processor 1136 may include radar components configured to perform digital signal processing of radar signals, control, and/or SW tasks.

In some demonstrative aspects, radar processor 1136 may reside at any suitable position of the vehicle.

In some demonstrative aspects, as shown in FIG. 11, radar processing unit 1134 and the plurality of RHs 1100 may be connected via the plurality of interconnects 1107, e.g., using a plurality of high-BW cables.

In some demonstrative aspects, radar processing unit 1134 may process the radar Rx information from the plurality of RHs 1100, for example, in a centralized manner.

In some demonstrative aspects, radar processor 1136 may be configured to provide a technical solution to improve system performance of radar system 1101, and/or to reduce system power consumption, system area, and/or system cost of radar system 1101, e.g., as described below.

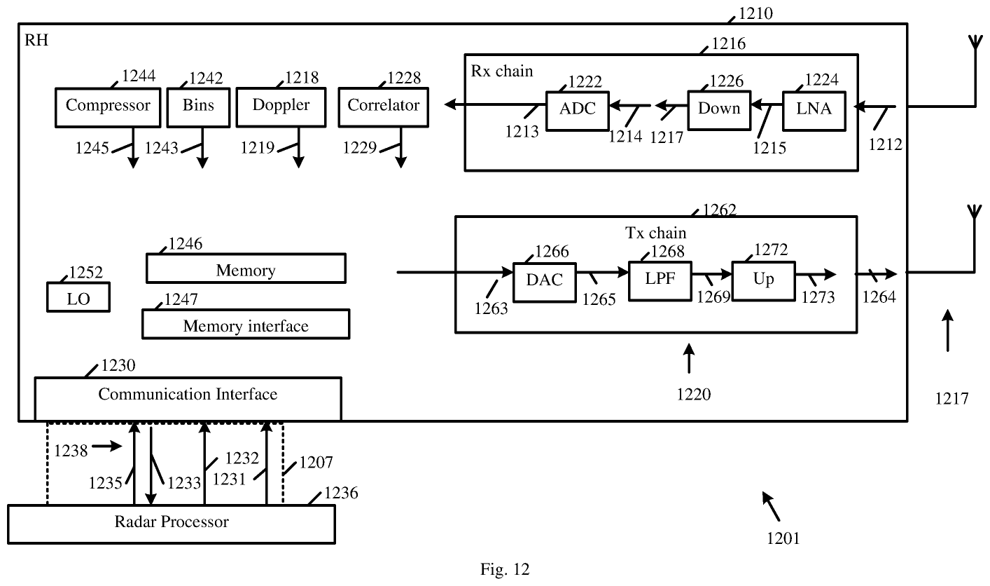

Reference is made to FIG. 12, which schematically illustrates a radar system 1201, in accordance with some demonstrative aspects. For example, radar system 1101 (FIG. 11) may include one or more elements of radar system 1201, and/or may perform one or more operations and/or functionalities of radar system 1201.

In some demonstrative aspects, as shown in FIG. 12, radar system 1201 may include a radar processor 1236. For example, radar processor 1236 may include one or more elements of radar processing unit 1134 (FIG. 11) and/or radar processor 1136 (FIG. 11), and/or may perform one or more operations and/or functionalities of radar processing unit 1134 (FIG. 11) and/or radar processor 1136 (FIG. 11).

In some demonstrative aspects, as shown in FIG. 12, radar system 1201 may include one or more RHs, e.g., including an RH 1210. For example, RH 1110 (FIG. 11) may include one or more elements of RH 1210, and/or may perform one or more operations and/or functionalities of RH 1210.

In some demonstrative aspects, as shown in FIG. 12, RH 1210 may include a communication interface 1230 configured to communicate with radar processor 1236 via a communication interconnect 1207, e.g., as described below. For example, TRX 1115 (FIG. 11) may include one or more elements of communication interface 1230, and/or may perform one or more operations and/or functionalities of communication interface 1230; and/or communication interconnect 1107 (FIG. 11) may include one or more elements of communication interconnect 1207, and/or may perform one or more operations and/or functionalities of communication interconnect 1207.

In some demonstrative aspects, communication interface 1230 may be configured to receive analog synchronization information 1232 from the radar processor 1236, and to communicate digital radar information 1238 with the radar processor 1236, e.g., as described below.

In some demonstrative aspects, the digital radar information 1238 may include digital radar Rx information 1233, e.g., as described below.

In some demonstrative aspects, the digital radar information 1238 may include digital radar Tx information 1235, e.g., as described below.

In some demonstrative aspects, communication interface 1230 may be configured to communicate the digital radar information 1238 modulated over one or more first electromagnetic waveforms via a waveguide interconnect, and/or to communicate the analog synchronization information 1232 over a second electromagnetic waveform via the waveguide interconnect, e.g., as described below. In other aspects, communication interface 1230 may be configured to communicate the digital radar information 1238 and the analog synchronization information 1232 modulated over a common electromagnetic waveform.

In some demonstrative aspects, communication interface 1230 may include a fiber optic communication interface configured to communicate the analog synchronization information 1232, and/or the digital radar information 1238 via a fiber optic interconnect, e.g., as described below.

In some demonstrative aspects, communication interface 1230 may include an AOC communication interface configured to communicate the analog synchronization information 1232, and/or the digital radar information 1238 via an AOC interconnect, e.g., as described below.

In some demonstrative aspects, communication interface 1230 may include a dielectric waveguide communication interface configured to communicate the analog synchronization information 1232, and/or the digital radar information 1238 via a dielectric waveguide interconnect, e.g., as described below.

In some demonstrative aspects, communication interface 1230 may include a cable communication interface to communicate the analog synchronization information 1232, and/or the digital radar information 1238 via a conductive cable interconnect, e.g., as described below.

In other aspects, communication interface 1230 may include any other additional or alternative type of communication interface to communicate the analog synchronization information 1232 and/or the digital radar information 1238.

In some demonstrative aspects, as shown in FIG. 12, radar system 1201 may include one or more RF chains 1220 to communicate radar RF signals corresponding to the digital radar information 1238 via one or more antennas 1217, e.g., as described below.

In some demonstrative aspects, RF chains 1220 may be configured to process the radar RF signals, for example, based on the analog synchronization information 1232, e.g., as described below.

In some demonstrative aspects, an RF chain 1220 may include a digital/analog converter to convert between an analog signal and a digital signal, e.g., as described below.

In some demonstrative aspects, the analog signal may correspond to a radar RF signal communicated by the RF chain 1220 via an antenna 1217, e.g., as described below.

In some demonstrative aspects, the digital signal may correspond to the digital radar information 1238, e.g., as described below.

In some demonstrative aspects, RH 1210 may include an LO generator 1252 configured to generate an LO signal based on the analog synchronization information 1232, e.g., as described below.

In some demonstrative aspects, the one or more RF chains 1220 may be configured to process the radar RF signals, for example, based on the LO signal, e.g., from the LO generator 1252.

In other aspects, RH 1210 may be implemented without an LO generator, e.g., as described below.

In some demonstrative aspects, the analog synchronization information 1232 may include an analog LO signal, e.g., as described below.

In some demonstrative aspects, the one or more RF chains 1220 may be configured to process the radar RF signals, for example, based on the analog LO signal, e.g., in the analog synchronization information 1232.

In some demonstrative aspects, the analog synchronization information 1232 may include time synchronization information to synchronize in time the radar RF signals, e.g., as described below.

In some demonstrative aspects, the one or more RF chains 1220 may be configured to process the radar RF signals, for example, based on the time synchronization information, e.g., in the analog synchronization information 1232.

In some demonstrative aspects, the one or more RF chains 1220 may include a plurality of RF chains 1220, e.g., as described below.

In some demonstrative aspects, the digital radar information 1238 may be in a form of a serial stream including an aggregation of a plurality of digital streams, e.g., as described below.

In some demonstrative aspects, the plurality of digital streams may include digital radar information corresponding to the plurality of RF chains 1220, respectively, e.g., as described below.

In other aspects, the digital radar information 1238 may be in any other form.

In some demonstrative aspects, as shown in FIG. 12, the one or more RF chains 1220 may include an Rx chain 1216 configured to receive a radar Rx signal 1212 and to generate an Rx BB signal 1214, e.g., as described below.

In some demonstrative aspects, Rx chain 1216 may be configured to generate Rx BB signal 1214, for example, by processing the radar Rx signal 1212, for example, based on the analog synchronization information 1232, e.g., as described below.

In some demonstrative aspects, as shown in FIG. 12, Rx chain 1216 may include an ADC 1222 configured to convert the Rx BB signal 1214 into a digital Rx signal 1213, e.g., as described below.

In some demonstrative aspects, the communication interface 1230 may be configured to transmit to the radar processor 1236 the digital radar Rx information 1233, for example, based on the digital Rx signal 1213.

In some demonstrative aspects, as shown in FIG. 12, Rx chain 1216 may include a Low Noise Amplifier (LNA) 1224 to provide an amplified Rx signal 1215, for example, based on the radar Rx signal 1212, e.g., as described below.

In some demonstrative aspects, as shown in FIG. 12, Rx chain 1216 may include a frequency downconverter 1226 to provide a downconverted Rx signal 1217, for example, by downconverting the amplified Rx signal 1215, for example, based on the analog synchronization information 1232, e.g., as described below.

In some demonstrative aspects, the Rx BB signal 1214 may be based on the downconverted Rx signal 1217, e.g., as described below.

In some demonstrative aspects, as shown in FIG. 12, RH 1210 may include a correlator 1228 configured to generate correlation information 1229, for example, based on a correlation between the digital Rx signal 1213 and Tx radar information corresponding to a radar Tx signal, e.g., as described below.

In some demonstrative aspects, the digital radar Rx information 1233 may be based on the correlation information 1229, e.g., as described below.

In some demonstrative aspects, communication interface 1230 may be configured to receive the Tx radar information corresponding to the radar Tx signal, from the radar processor 1236, for example, as part of Tx radar information 1235, e.g., as described below.

In some demonstrative aspects, as shown in FIG. 12, RH 1210 may include a Doppler processor 1218 configured to determine Doppler information 1219, for example, based on the digital Rx signal 1213, e.g., as described below.

In some demonstrative aspects, the digital radar Rx information 1233 may be based, for example, on the Doppler information 1219, e.g., as described below.

In some demonstrative aspects, as shown in FIG. 12, RH 1210 may include an active bin selector 1242 configured to select one or more active Range-Doppler (RD) bins 1243, for example, based on the Doppler information 1219, e.g., as described below.

In some demonstrative aspects, the digital radar Rx information 1233 may be based, for example, on radar information corresponding to the active RD bins 1243, e.g., as described below.

In some demonstrative aspects, as shown in FIG. 12, RH 1210 may include a compressor 1244 configured to generate the digital radar Rx information 1233 including compressed Rx information 1245 based on the digital Rx signal 1213, e.g., as described below.

In some demonstrative aspects, as shown in FIG. 12, RH 1210 may include a memory 1246 to store processed information, for example, based on the digital Rx signal 1213, e.g., as described below.

In some demonstrative aspects, the digital radar Rx information 1233 may be based, for example, on the processed information stored in memory 1246, e.g., as described below.

In some demonstrative aspects, as shown in FIG. 12, the one or more RF chains 1220 may include a Tx chain 1262 to transmit a radar Tx signal 1264, for example, based on the digital radar Tx information 1235, e.g., as described below.

In some demonstrative aspects, communication interface 1230 may be configured to receive from the radar processor 1236 the digital radar Tx information 1235 to define a digital Tx signal 1263, e.g., as described below.

In some demonstrative aspects, as shown in FIG. 12, Tx chain 1262 may include a Digital-to-Analog Converter (DAC) 1266 configured to convert the digital Tx signal 1263 into a Tx BB signal 1265, e.g., as described below.

In some demonstrative aspects, Tx chain 1262 may be configured to transmit the radar Tx signal 1264, for example, by processing the Tx BB signal 1265, for example, based on the analog synchronization information 1232, e.g., as described below.

In some demonstrative aspects, as shown in FIG. 12, Tx chain 1262 may include a Low-Pass-Filter (LPF) 1268 to provide a filtered Tx signal 1269, for example, based on the Tx BB signal 1265, e.g., as described below.

In some demonstrative aspects, as shown in FIG. 12, Tx chain 1262 may include a frequency upconverter 1272 to provide an upconverted Tx signal 1273, for example, by upconverting the filtered Tx signal 1269, for example, based on the analog synchronization information 1232, e.g., as described below.

In some demonstrative aspects, as shown in FIG. 12, the radar Tx signal 1264 may be based on the upconverted Tx signal 1273, e.g., as described below.

In some demonstrative aspects, the digital radar Tx information 1235 may include waveform information to define a radar Tx waveform, e.g., as described below.

In some demonstrative aspects, RH 1210 may be configured to generate the digital Tx signal 1263, for example, based on the waveform information, e.g., as described below.

In some demonstrative aspects, the digital radar Tx information 1235 may include a sequence of digital radar Tx samples of the digital Tx signal 1263, e.g., as described below.

In some demonstrative aspects, memory 1246 may be configured to store the sequence of digital radar Tx samples, e.g., as described below.

In some demonstrative aspects, RH 1210 may be configured to transmit a plurality of repetitions of a radar Tx transmission, which may be based, for example, on the sequence of digital radar Tx samples, e.g., as described below.

In some demonstrative aspects, RH 1210 may be configured to stream the sequence of digital radar Tx samples, for example, as an input to the DAC 1266 of the Tx chain 1262, e.g., as described below.

In some demonstrative aspects, the communication interface 1230 may be configured to receive RH control information 1231 from the radar processor 1236, e.g., as described below.

In some demonstrative aspects, the RH 1210 may be configured to control one or more functionalities of the RH 1210 based on the RH control information 1231, e.g., as described below.

In some demonstrative aspects, the RH control information 1231 may include register information to identify one or more memory address-mapped registers corresponding to an element of the RH 1210, e.g., as described below.

In some demonstrative aspects, the RH control information 1231 may include control instructions to control one or more functionalities of the element of the RH 1210, e.g., as described below.

In some demonstrative aspects, the RH 1210 may include a memory interface 1247, for example, to write the control instructions to the one or more memory registers, for example, based on the register information, e.g., as described below.

In some demonstrative aspects, the RH control information 1231 may include information to set a cutoff frequency of LPF 1268.

In some demonstrative aspects, the RH control information 1231 may include information to set a parameter of a digital/analog converter, e.g., a parameter of DAC 1266 and/or ADC 1222.

In some demonstrative aspects, the RH control information 1231 may include information to set a parameter of an RF amplifier in the RF chain, for example, LNA 1224.

In some demonstrative aspects, the RH control information 1231 may include information to set a waveform coding for the RF chain. For example, the RH control information 1231 may include information to indicate an OFDM coding, a phase modulation coding, FMCW with coding, or the like.

In other aspects, the RH control information 1231 may include any other additional or alternative information to set any other additional or alternative elements of the RH 1210.

In some demonstrative aspects, the RH 1210 may include a controller to control one or more functionalities of RH 1210, for example, based on the RH control information 1231 from the radar processor 1236, e.g., as described below.

In some demonstrative aspects, the RH 1210 may include a controllerless RH, which may be controllable, e.g., directly, for example, based on the RH control information 1231 from the radar processor 1236, e.g., as described below.

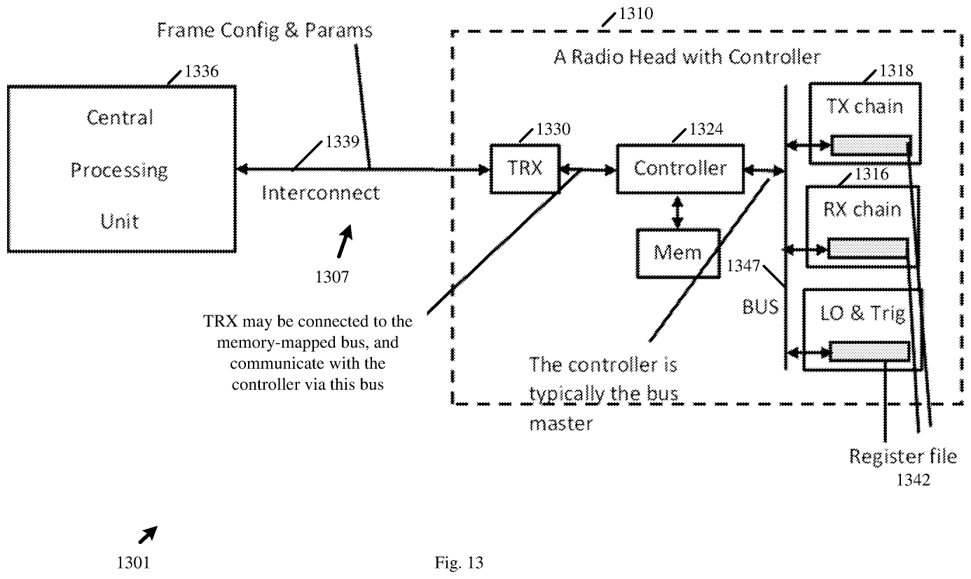

Reference is made to FIG. 13, which schematically illustrates a radar system 1301, in accordance with some demonstrative aspects. For example, radar system 1101 (FIG. 11) may include one or more elements of radar system 1301, and/or may perform one or more operations and/or functionalities of radar system 1301.

In some demonstrative aspects, as shown in FIG. 13, radar system 1301 may include a radar processor 1336. For example, radar processor 1336 may include one or more elements of radar processing unit 1134 (FIG. 11) and/or radar processor 1136 (FIG. 11), and/or may perform one or more operations and/or functionalities of radar processing unit 1134 (FIG. 11) and/or radar processor 1136 (FIG. 11).

In some demonstrative aspects, as shown in FIG. 13, radar system 1301 may include one or more RHs, e.g., including an RH 1310. For example, RH 1110 (FIG. 11) may include one or more elements of RH 1310, and/or may perform one or more operations and/or functionalities of RH 1310.

In some demonstrative aspects, as shown in FIG. 13, RH 1310 may include a communication interface 1330 configured to communicate with radar processor 1336 via a communication interconnect 1307, e.g., as described below. For example, TRX 1115 (FIG. 11) may include one or more elements of communication interface 1330, and/or may perform one or more operations and/or functionalities of communication interface 1330; and/or communication interconnect 1107 (FIG. 11) may include one or more elements of communication interconnect 1307, and/or may perform one or more operations and/or functionalities of communication interconnect 1307.

In some demonstrative aspects, as shown in FIG. 13, RH 1310 may include a controller 1324 configured to control one or more functionalities of the RH 1310 based on RH control information 1339.

In some demonstrative aspects, as shown in FIG. 13, communication interface 1330 may be configured to receive the RH control information 1339 from radar processor 1336.

In some demonstrative aspects, controller 1324 may be configured to control one or more functionalities of an element of the RH 1310, e.g., an element of a Tx chain 1318 and/or an Rx chain 1316 of the RH 1310.

In some demonstrative aspects, the controller 1324 may be configured to identify, e.g., based on the RH control information 1339, control instructions to control one or more functionalities of the element of the RH 1310.

In some demonstrative aspects, the controller 1324 may be configured to write the control instructions to one or more memory registers 1342, which may be mapped to the element of the RH 1310. For example, the controller 1324may utilize a memory interface 1347, e.g., a BUS, for example, to write the control instructions to the one or more memory registers 1342.

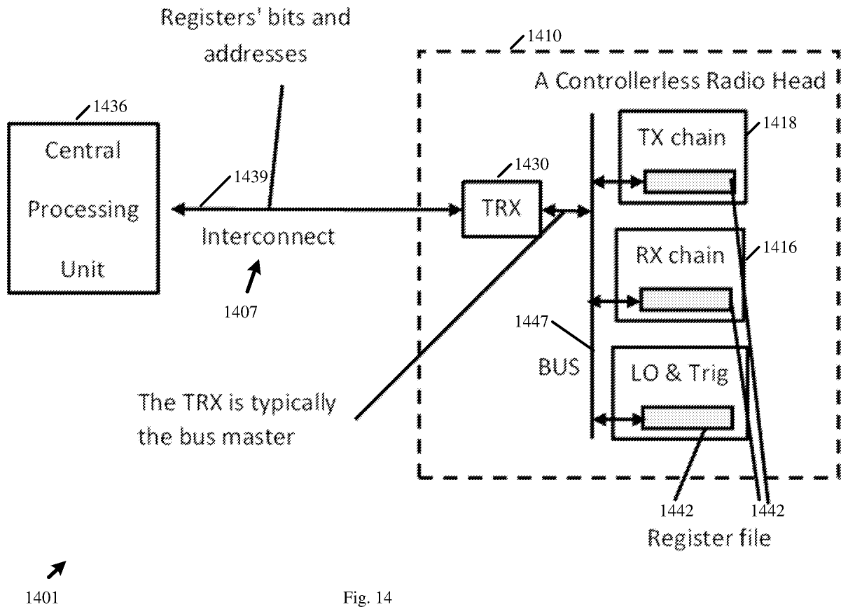

Reference is made to FIG. 14, which schematically illustrates a radar system 1401, in accordance with some demonstrative aspects. For example, radar system 1101 (FIG. 11) may include one or more elements of radar system 1401, and/or may perform one or more operations and/or functionalities of radar system 1401.

In some demonstrative aspects, as shown in FIG. 14, radar system 1401 may include a radar processor 1436. For example, radar processor 1436 may include one or more elements of radar processing unit 1144 (FIG. 11) and/or radar processor 1146 (FIG. 11), and/or may perform one or more operations and/or functionalities of radar processing unit 1144 (FIG. 11) and/or radar processor 1146 (FIG. 11).

In some demonstrative aspects, as shown in FIG. 14, radar system 1401 may include one or more RHs, e.g., including a controllerless RH 1410. For example, RH 1110 (FIG. 11) may include one or more elements of RH 1410, and/or may perform one or more operations and/or functionalities of RH 1410.

In some demonstrative aspects, controllerless RH 1410 may be controllable, e.g., directly, for example, based on RH control information 1439 from the radar processor 1436, e.g., as described below.

In some demonstrative aspects, controllerless RH 1410 may be implemented to exclude one or more, e.g., some or all, controller functionalities of an RH controller, for example, the RH controller 1324 (FIG. 13), e.g., as described below.

In some demonstrative aspects, as shown in FIG. 14, RH 1410 may include a communication interface 1430 configured to communicate with radar processor 1436 via a communication interconnect 1407, e.g., as described below. For example, TRX 1115 (FIG. 11) may include one or more elements of communication interface 1430, and/or may perform one or more operations and/or functionalities of communication interface 1430; and/or communication interconnect 1107 (FIG. 11) may include one or more elements of communication interconnect 1407, and/or may perform one or more operations and/or functionalities of communication interconnect 1407.

In some demonstrative aspects, as shown in FIG. 14, communication interface 1430 may be configured to receive the RH control information 1439 from radar processor 1436.

In some demonstrative aspects, controllerless RH 1410 may be controllable, e.g., directly, e.g., by radar processor 1436, for example, based on the control information 1439 from the radar processor 1436.

In some demonstrative aspects, radar processor 1436 may be configured to generate RH control information 1439 to control one or more functionalities of the RH 1410.

In some demonstrative aspects, the RH control information 1439 may include register information to identify one or more memory registers 1442, which may be mapped to an element of the RH 1410, e.g., an element of a Tx chain 1418 and/or an Rx chain 1416 of the RH 1410.

In some demonstrative aspects, the RH control information 1439 may include control instructions to control one or more functionalities of the element of the RH 1410.

In some demonstrative aspects, the RH 1410 may include a memory interface 1447, e.g., a BUS, for example, to write, e.g., to directly write, the control instructions to the one or more memory registers 1442, for example, based on the register information.

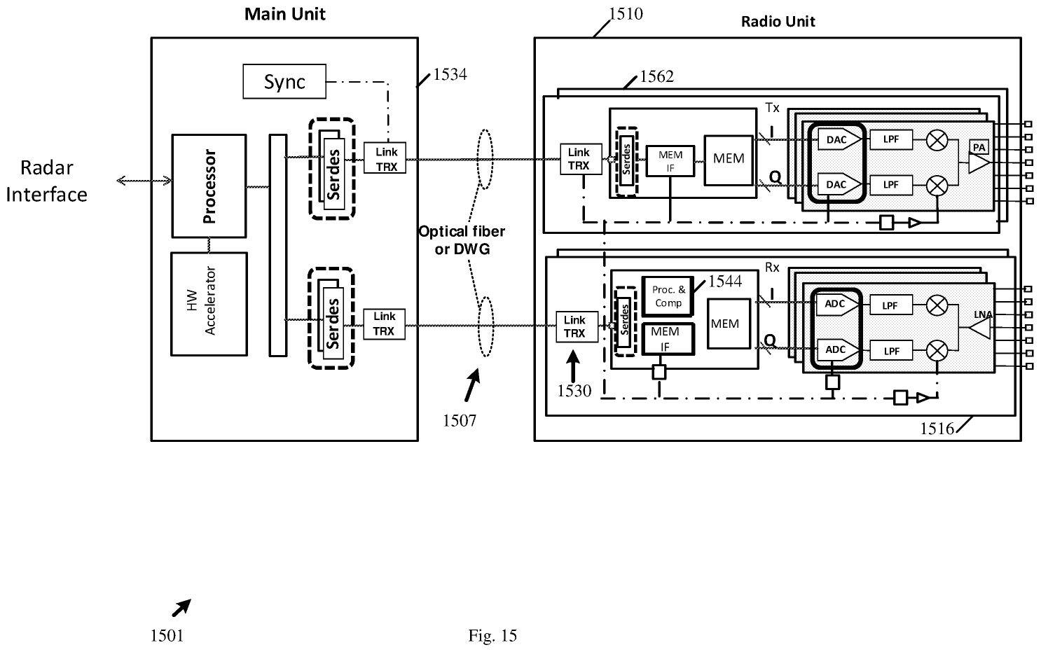

Reference is made to FIG. 15, which schematically illustrates a radar system 1501, in accordance with some demonstrative aspects. For example, radar system 1201 (FIG. 12) may include one or more elements of radar system 1501, and/or may perform one or more operations and/or functionalities of radar system 1501.

In some demonstrative aspects, as shown in FIG. 15, radar system 1501 may include a radar processing unit (also referred to as “main unit”, “main processor, “central processor”, “radar processor” or “radar controller”) 1534. For example, radar processor 1236 (FIG. 12) may include one or more elements of radar processing unit 1534, and/or may perform one or more operations and/or functionalities of radar processing unit 1534.

In some demonstrative aspects, as shown in FIG. 15, radar system 1501 may include one or more RHs, e.g., including an RH 1510. For example, RH 1210 (FIG. 12) may include one or more elements of RH 1510, and/or may perform one or more operations and/or functionalities of RH 1510.

In some demonstrative aspects, as shown in FIG. 15, RH 1510 may include a communication interface 1530 configured to communicate with radar processing unit 1534 via a communication interconnect 1507.

In some demonstrative aspects, as shown in FIG. 15, RH 1510 may include one or more Rx chains, e.g., including an Rx chain 1516, and/or one or more Tx chains, e.g., including a Tx chain 1562.

In some demonstrative aspects, as shown in FIG. 15, Tx chain 1562 may be configured to perform Tx radar processing of Tx signals to be transmitted by RH 1510. For example, Tx chain 1562 may be configured to perform Tx radar processing, which may include, for example, DAC, filtering, corrections, RF up conversion, and/or any other Tx radar processing.

In some demonstrative aspects, as shown in FIG. 15, Rx chain 1516 may be configured to perform Rx radar processing of Rx signals received by RH 1510. For example, Rx chain 1516 may be configured to perform Rx radar processing, which may include, for example, sampling, e.g., by an ADC, an optional compression, and/or any other Rx radar processing.

In some demonstrative aspects, as shown in FIG. 15, Rx chain 1516 may include a compressor 1544 configured to compress digital radar Rx information.

In some demonstrative aspects, compressor 1544 may be configured to apply a compression mechanism, which may be configured to reduce a data rate, e.g., of digital radar Rx data communicated over digital communication interconnect 1507.

In some demonstrative aspects, the compression mechanism may be configured to perform one or more radar functionalities, which may be usually performed in Hardware, e.g., in radar processing unit 1534. For example, compressor 1544 may be configured to apply the compression mechanism to provide a technical solution to reduce computation load on radar processing unit 1534, for example, by load balancing between RH 1510 and radar processing unit 1534.

In some demonstrative aspects, the compression mechanism may include a lossless compression or a lossy compression, e.g., as describe below.

In some demonstrative aspects, compressor 1544 may be configured to perform the compression, for example, by sampling the digital radar Rx information and compressing the samples, for example, utilizing an entropy-based compression. For example, this compression mechanism may yield a relatively high, e.g., a highest, data rate per a particular link capacity, and/or may support a high level of flexibility.

In some demonstrative aspects, compressor 1544 may be configured to perform the compression, for example, by sampling the digital radar Rx information and applying a Matched Filter (MF) to the samples, e.g., by a MF, for example, according to a delay hypothesis grid. This compression mechanism may be implemented as a pulse compression method.

In some demonstrative aspects, an output of the MF may be compressed, for example, to reduce a data rate. For example, the MF operation may utilize knowledge of var transmitters and their pulse template.

In some demonstrative aspects, compressor 1544 may be configured to perform the compression, for example, by sampling the digital radar Rx information and performing a Doppler processing, Doppler corrections, and applying an MF to the samples. In one example, the MF operation may be performed before the Doppler operation. In another example, the MF operation may be performed after the Doppler operation.

In some demonstrative aspects, a result of the compression mechanism using the Doppler operation and the MF operation may be a Range-Doppler (RD) matrix or map. For example, the RD map may usually be very sparse, and hence may be scanned for active bins, for example, to determine an Active Bin Set (ABS).

In some demonstrative aspects, the active bins, e.g., the ABS, may be sent to radar processing unit 1534 for further processing, e.g., direction processing, AoA processing, and/or any other processing.

In one example, reduction of the Rx information to the ABS may be substantial, e.g., an order of magnitude less, for example, compared to the size of information in a full set of RD bins.

In some demonstrative aspects, the ABS may be processed, e.g., to provide a co-variance matrix form, and/or compressed for an additional reduction of data throughput.

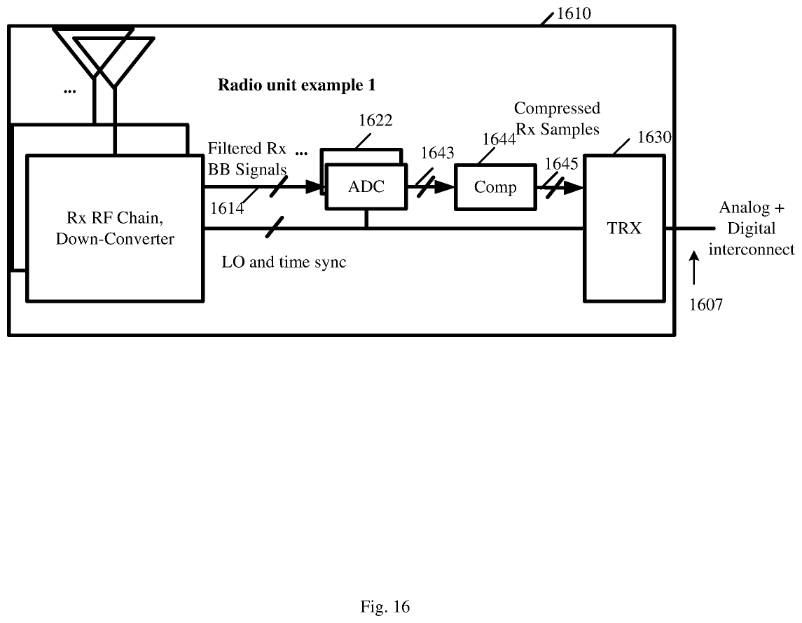

Reference is made to FIG. 16, which schematically illustrates an RH 1610. For example, RH 1210 (FIG. 12) may include one or more elements of RH 1610, and/or may perform one or more operations and/or functionalities of RH 1610.

In some demonstrative aspects, as shown in FIG. 16, RH 1610 may include an ADC 1622 configured to generate radar digital samples 1643, for example, based on Rx BB signals 1614.

In some demonstrative aspects, as shown in FIG. 16, RH 1610 may include a compressor 1644 configured to generate compressed Rx information 1645, for example, based on the radar digital samples 1643.

In some demonstrative aspects, compressor 1644 may be configured to compress a plurality of streams of radar digital samples 1643, for example, from a plurality of Rx RF chains, into a plurality of streams of compressed Rx information 1645. For example, compressor 1644 may be configured to separately compress a first stream of radar digital samples 1643 from a first Rx RF chain into a first stream of compressed Rx information 1645, and a second stream of radar digital samples 1643 from a second Rx RF chain into a second stream of compressed Rx information 1645.

In some demonstrative aspects, compressor 1644 may be configured to compress a combination of a plurality of streams of radar digital samples 1643, for example, into a combined stream of compressed Rx information 1645. For example, compressor 1644 may be configured to jointly compress two or more streams of radar digital samples 1643 from two or more Rx RF chains into a combined stream of compressed Rx information 1645.

In one example, compressor 1644 may generate compressed Rx information 1645, for example, based on an entropy-based compression mechanism and/or any other compression mechanism.

In some demonstrative aspects, as shown in FIG. 16, RH 1610 may include a communication interface 1630 configured to transfer the compressed Rx information 1645, for example, via a communication interconnect 1607, to a radar processor, e.g., radar processor 1236 (FIG. 12), for further processing.

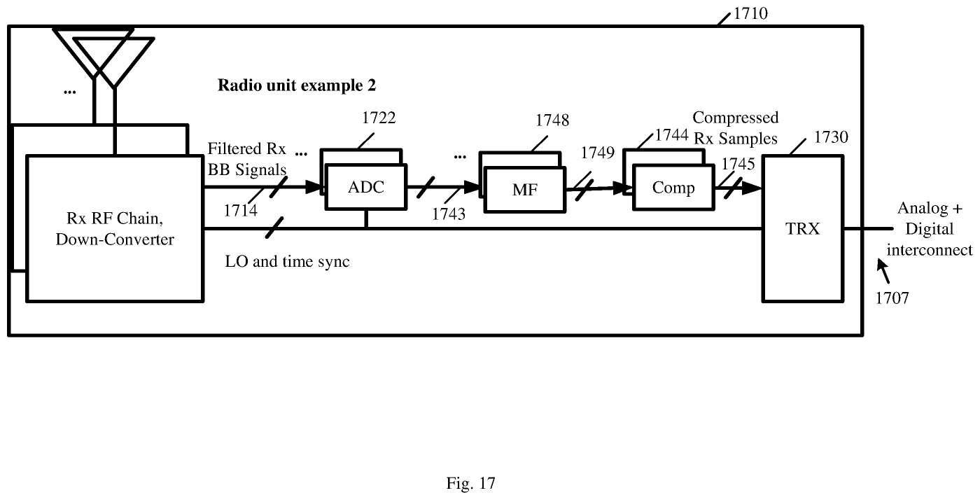

Reference is made to FIG. 17, which schematically illustrates an RH 1710. For example, RH 1210 (FIG. 12) may include one or more elements of RH 1710, and/or may perform one or more operations and/or functionalities of RH 1710.

In some demonstrative aspects, as shown in FIG. 17, RH 1710 may include an ADC 1722 configured to generate radar digital samples 1743, for example, based on Rx BB signals 1714.

In some demonstrative aspects, as shown in FIG. 17, RH 1710 may include a correlator, e.g., a matched filter (MF), 1748 configured to generate a filtered signal 1749, for example, based on radar digital samples 1743.

Some demonstrative aspects are described herein with respect to an RH including a correlator, e.g., correlator 1748, implemented by a matched filter. In other aspects, the RH may include any other additional or alternative correlator, e.g., a pulse compressor, mismatch filter, and/or any other signal correlator, e.g., to perform one or more correlator functionalities in addition to, or instead of, the MF.

In one example, correlator (MF) 1748 may compress the radar digital samples 1743, for example, according to a delay hypothesis grid. In one example, the MF operation may utilize knowledge of var transmitters and their pulse template.

In some demonstrative aspects, the correlator (MF) 1748 may be configured to process the to process radar digital samples 1743, for example, based on a radar Tx signal template. For example, the correlator (MF) 1748 may be configured to correlate the radar digital samples 1743 with the radar Tx signal template. For example, the radar Tx signal template may be received by RH 1710 from radar processing unit 1034 (FIG. 1), e.g., as described above.

In some demonstrative aspects, as shown in FIG. 17, RH 1710 may include a compressor 1744 configured to generate compressed Rx information 1745, for example, based on the filtered signal 1749.

In some demonstrative aspects, as shown in FIG. 17, an output of correlator (MF) 1748 may be compressed, e.g., by compressor 1744, for example, to reduce a data rate.

In some demonstrative aspects, compressor 1744 may be configured to compress a plurality of streams of filtered signals 1749, for example, from a plurality of Rx RF chains, into a plurality of streams of compressed Rx information 1745. For example, compressor 1744 may be configured to separately compress a first stream of filtered signals 1749 from a first Rx RF chain into a first stream of compressed Rx information 1745, and a second stream of filtered signals 1749 from a second Rx RF chain into a second stream of compressed Rx information 1745.

In some demonstrative aspects, compressor 1744 may be configured to compress a combination of a plurality of streams of filtered signals 1749, for example, into a combined stream of compressed Rx information 1745. For example, compressor 1744 may be configured to jointly compress two or more streams of filtered signals 1749 from two or more Rx RF chains into a combined stream of compressed Rx information 1745.

In some demonstrative aspects, as shown in FIG. 17, RH 1710 may include a communication interface 1730 configured to transfer the compressed Rx information 1745, for example, via a communication interconnect 1707, to a radar processor, e.g., radar processor 1236 (FIG. 12), for further processing.

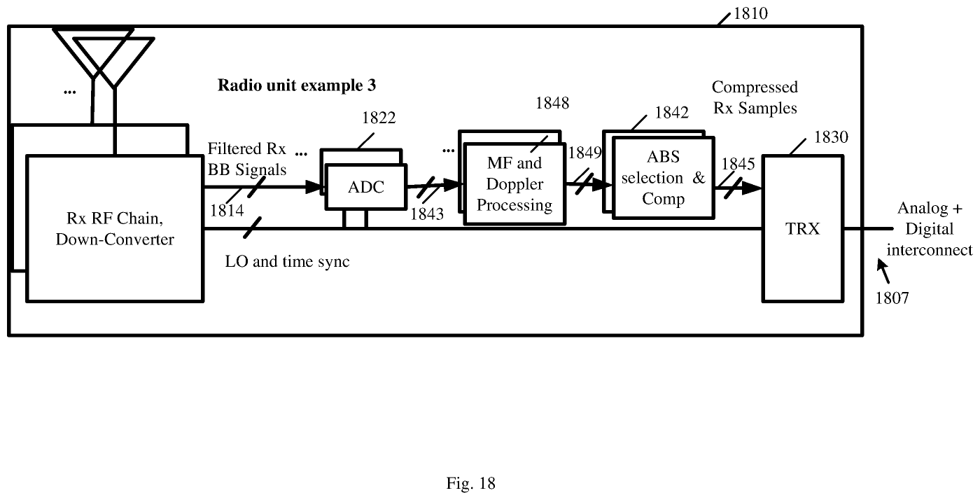

Reference is made to FIG. 18, which schematically illustrates an RH 1810. For example, RH 1210 (FIG. 12) may include one or more elements of RH 1810, and/or may perform one or more operations and/or functionalities of RH 1810.

In some demonstrative aspects, as shown in FIG. 18, RH 1810 may include an ADC 1822 configured to generate radar digital samples 1843, for example, based on Rx BB signals 1814.

In some demonstrative aspects, as shown in FIG. 18, RH 1810 may include an correlator, e.g., MF, and a Doppler processor 1848 configured to generate Doppler information 1849, for example, based on radar digital samples 1843.

In some demonstrative aspects, the correlator (MF) and Doppler processor 1848 may be configured to perform Doppler processing, Doppler corrections, and/or apply a MF to the radar digital samples 1843. In one example, the MF operation may be performed before the Doppler operation. In another example, the MF operation may be performed after the Doppler operation.

In some demonstrative aspects, the Doppler information 1849 may include an RD matrix or map. In one example, the RD matrix map may be scanned for active bins, for example, to determine an ABS, for example, in case the RD matrix map is relatively sparse.

In some demonstrative aspects, as shown in FIG. 18, RH 1810 may include an active bin selector 1842 configured to select one or more active RD bins, e.g., an ABS 1845, for example, based on the Doppler information 1849.

In some demonstrative aspects, as shown in FIG. 18, RH 1810 may include a communication interface 1830 configured to transfer, for example, via a communication interconnect 1807, the ABS 1845 to a radar processor, e.g., radar processor 1236 (FIG. 12), for further processing, for example, direction processing, AoA processing, and/or any other processing.

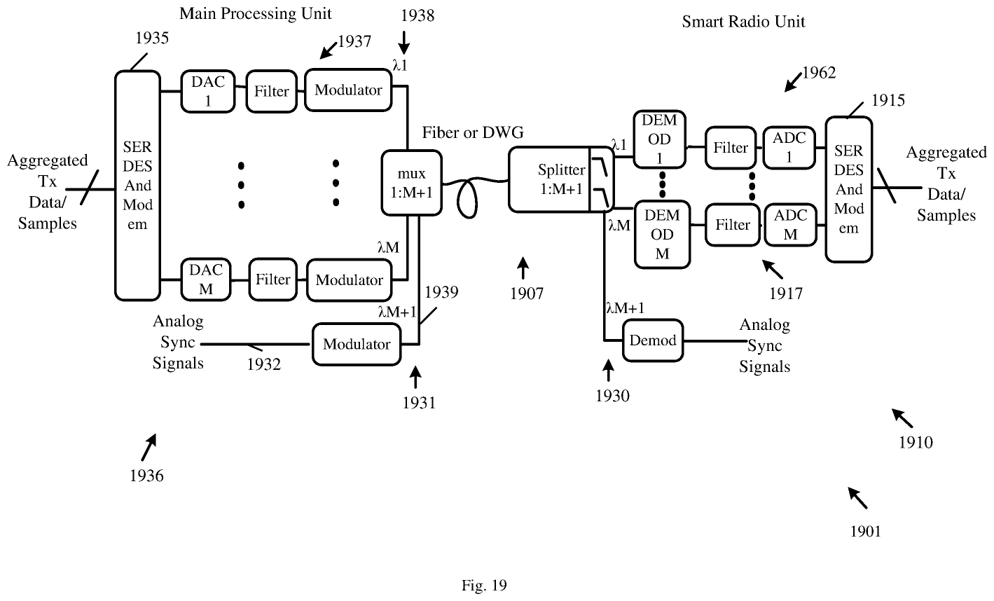

Reference is made to FIG. 19, which schematically illustrates a Tx interconnect scheme 1901 to support communication between an RH 1910 and a radar processor 1936 via a communication interconnect 1907. For example, RH 1190 (FIG. 12) may include one or more elements of RH 1910, and/or may perform one or more operations and/or functionalities of RH 1910; radar processor 1236 (FIG. 12) may include one or more elements of radar processor 1936, and/or may perform one or more operations and/or functionalities of radar processor 1936; and/or communication interconnect 1207 (FIG. 12) may include one or more elements of communication interconnect 1907, and/or may perform one or more operations and/or functionalities of communication interconnect 1907.

In some demonstrative aspects, communication interconnect 1907 may be configured to transfer information and/or data in a direction (Tx direction) from radar processor 1936 to RH 1910.

In some demonstrative aspects, as shown in FIG. 19, RH 1910 may include a Tx chain 1962.

In some demonstrative aspects, as shown in FIG. 19, communication interconnect 1907 may include a fiber optic interconnect and/or a dielectric waveguide interconnect. In other aspects, any other additional or alternative interconnect may be implemented.

In some demonstrative aspects, as shown in FIG. 19, RH 1910 may include a communication interface 1930, e.g., a fiber optic interface and/or a dielectric waveguide interface; and/or radar processor 1936 may include a communication interface 1931, e.g., a fiber optic interface and/or a dielectric waveguide interface.

In some demonstrative aspects, as shown in FIG. 19, communication interconnect 1907 may transfer analog synchronization information 1932 and digital radar Tx information 1938 from radar processor 1936 to RH 1910.

In some demonstrative aspects, as shown in FIG. 19, radar processor 1936 may include a SERDES and a modem 1935, and a PHY layer 1937 to transmit the digital radar Tx information 1938 over the communication interconnect 1907.

In some demonstrative aspects, as shown in FIG. 19, RH 1910 may include a PHY layer 1917 and a SERDES and modem 1915 to process the digital radar Tx information 1938 received over the communication interconnect 1907, for example, to recover bits of the digital radar Tx information 1938, for example, according to a reverse processing of processing performed by the radar processor 1936.

In some demonstrative aspects, as shown in FIG. 19, a channel 1939, e.g., a dedicated frequency channel, may be configured to transfer the analog synchronization information 1932, e.g., in an analog manner. For example, the channel 1939 may include an optional up-conversion, amplification, media propagation, LNA, and/or an optional down-conversion.

In some demonstrative aspects, a control channel, e.g., a side bi-directional control channel, may be allocated for control information between radar processor 1936 and RH 1910.

In some demonstrative aspects, the control channel may support implementation of RH 1910 as a controllerless RH, e.g., controllerless RH 1410 (FIG. 14).

In some demonstrative aspects, the analog synchronization information 1932 may be digitally transferred between radar processor 1936 and RH 1910.

In some demonstrative aspects, as shown in FIG. 19, RH 1910 may receive the analog synchronization information 1932 in an analog fashion.

In some demonstrative aspects, the digital radar Tx information 1238 may be configured to include a waveform to be transmitted. For example, the waveform may be provided to RH 1910 in a digital template.

In some demonstrative aspects, the digital template may be in a form of a stream of samples, or a list of parameters, for example, to configure a HW module, e.g., a chirp generator, a coded phase modulation generator or a coded OFDM generator, and/or any other HW module to process transmission of a radar Tx signal based on the digital template.

In some demonstrative aspects, the stream of samples may be stored in a local memory of RH 1910, e.g., memory 1246 (FIG. 12), and may be played back, e.g., repeatedly, from the local memory.

In some demonstrative aspects, the stream of samples may feed a DAC, for example, in a streaming like method, e.g., with buffering or without buffering.

In some demonstrative aspects, Tx chain 1962 may include a waveform generator configured to generate a set of waveforms. For example, the digital radar Tx information 1938 may include programming words and/or parameters, e.g., in a low bit rate, for example, to configure the waveform generator.

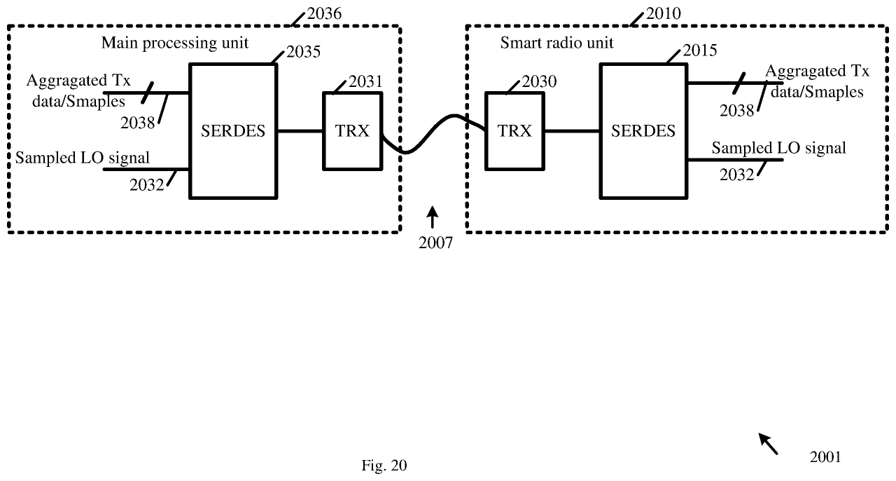

Reference is made to FIG. 20, which schematically illustrates a Tx interconnect scheme 2001 to support communication between an RH 2010 and a radar processor 2036 via a communication interconnect 2007. For example, RH 1210 (FIG. 12) may include one or more elements of RH 2010, and/or may perform one or more operations and/or functionalities of RH 2010; radar processor 1236 (FIG. 12) may include one or more elements of radar processor 2036, and/or may perform one or more operations and/or functionalities of radar processor 2036; and/or communication interconnect 1207 (FIG. 12) may include one or more elements of communication interconnect 2007, and/or may perform one or more operations and/or functionalities of communication interconnect 2007.

In some demonstrative aspects, communication interconnect 2007 may be configured to transfer information and/or data in a direction (Tx direction) from radar processor 2036 to RH 2010.

In some demonstrative aspects, communication interconnect 2007 may include a fiber optic interconnect and/or a dielectric waveguide interconnect. In other aspects, any other additional or alternative interconnect may be implemented.

In some demonstrative aspects, as shown in FIG. 20, RH 2010 may include a communication interface 2030, e.g., a fiber optic interface and/or a dielectric waveguide interface; and/or radar processor 2036 may include a communication interface 2031, e.g., a fiber optic interface and/or a dielectric waveguide interface.

In one example, the synchronization information 2032 may include, for example, an LO synchronization signal and/or any other additional or alternative synchronization information, e.g., as described above.

In some demonstrative aspects, communication of the synchronization information 2032, e.g., including the LO synchronization signal. May be implemented in a digital form via a digital interface between radar processor 2036 and RH 2010, for example, via communication interconnect 2007, e.g., as described below.

In some demonstrative aspects, as shown in FIG. 20, communication interconnect 2007 may be configured to transfer, in a digital form, both the synchronization information 2032 and digital radar Tx information 2038 from radar processor 2036 to RH 2010.

In some demonstrative aspects, as shown in FIG. 20, radar processor 2036 may include a SERDES 2035 to generate a serial stream based on the synchronization information 2032 and digital radar Tx information 2038 for transmission over the communication interconnect 2007.

In some demonstrative aspects, as shown in FIG. 20, RH 2010 may include a SERDES 2015 to process the serial stream received over the communication interconnect 2007, for example, to separate the serial stream into a first stream including the synchronization information 2032 and a second stream including the digital radar Tx information 2038.

In some demonstrative aspects, radar processor 2036 may be configured to generate the synchronization information 2032 in the form of a signal, for example, by sampling the LO synchronization signal. For example, as shown in FIG. 20, radar processor 2036 may be configured to route the sampled LO synchronization signal 2032 to one or more inputs, e.g., a single input or multiple inputs, of the SERDES 2035. For example, the sampled LO synchronization signal 2032 may be routed to the SERDES 2035 as a 50% duty cycle digital signal, or any other digital signal with any other duty cycle.

In some demonstrative aspects, as shown in FIG. 20, RH 2010 may be configured to recover the LO synchronization signal 2032, for example, to be used as a local clock signal at RH 2010, for example, for processing transmission of radar Tx signals based on the digital radar Tx information 2038, e.g., as described above.

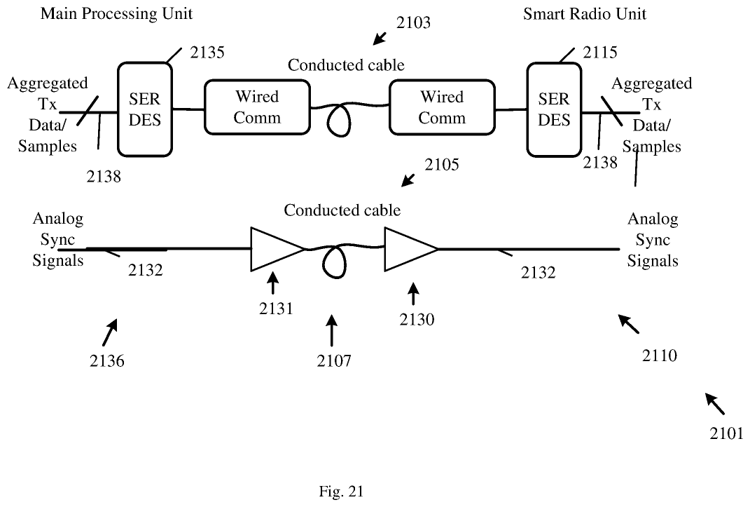

Reference is made to FIG. 21, which schematically illustrates a Tx interconnect scheme 2101 to support communication between an RH 2110 and a radar processor 2136 via a communication interconnect 2107. For example, RH 1210 (FIG. 12) may include one or more elements of RH 2110, and/or may perform one or more operations and/or functionalities of RH 2110; radar processor 1236 (FIG. 12) may include one or more elements of radar processor 2136, and/or may perform one or more operations and/or functionalities of radar processor 2136; and/or communication interconnect 1207 (FIG. 12) may include one or more elements of communication interconnect 2107, and/or may perform one or more operations and/or functionalities of communication interconnect 2107.

In some demonstrative aspects, communication interconnect 2107 may be configured to transfer information and/or data in a direction (Tx direction) from radar processor 2136 to RH 2110.

In some demonstrative aspects, as shown in FIG. 21, communication interconnect 2107 may include a first conducted cable interconnect 2105 and a second conducted cable interconnect 2103.

In some demonstrative aspects, first conducted cable interconnect 2105 may include, for example, a coax cable, which may be configured to transfer analog synchronization information 2132, e.g., via a dedicated channel.

In some demonstrative aspects, second conducted cable interconnect 2103 may be configured to transfer digital radar Tx information 2138, for example, via an Ethernet link or any other link, e.g., fast link conducted communication system.

In some demonstrative aspects, as shown in FIG. 21, radar processor 2136 may include a cable communication interface 2131, which may be configured to transmit the analog synchronization information 2132 and the digital radar Tx information 2138 via communication interconnect 2107.

In some demonstrative aspects, as shown in FIG. 21, RH 2110 may include a cable communication interface 2130, which may be configured to receive the analog synchronization information 2132 and the digital radar Tx information 2138 via communication interconnect 2107.

In some demonstrative aspects, as shown in FIG. 21, the second conducted cable 2103 may be configured to send the digital radar Tx information 2138 in a digital manner, e.g., from radar processor 2136 to RH 2110.

In some demonstrative aspects, as shown in FIG. 21, radar processor 2136 may include a SERDES 2135 to transmit the digital radar Tx information 2138 over the communication interconnect 2107.

In some demonstrative aspects, as shown in FIG. 21, RH 2110 may include a SERDES 2115 to process the digital radar Tx information 2138 received over the communication interconnect 2107, for example, to recover bits of the digital radar Tx information 2138, for example, according to a reverse processing of processing performed by the radar processor 2136.

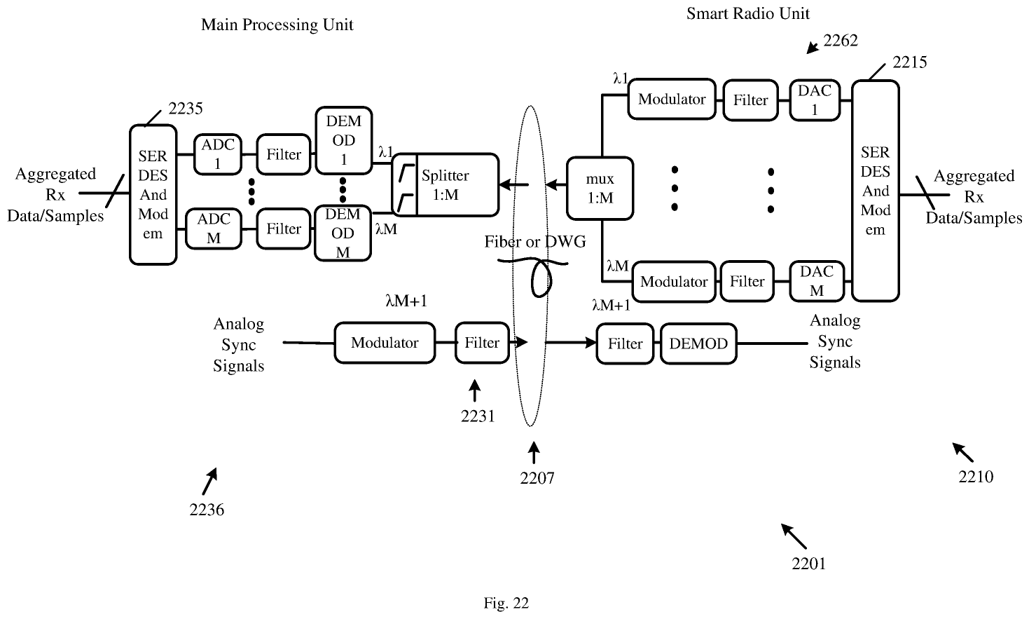

Reference is made to FIG. 22, which schematically illustrates an Rx interconnect scheme 2201 to support communication between an RH 2210 and a radar processor 2236 via a communication interconnect 2207. For example, RH 1210 (FIG. 12) may include one or more elements of RH 2210, and/or may perform one or more operations and/or functionalities of RH 2210; radar processor 1236 (FIG. 12) may include one or more elements of radar processor 2236, and/or may perform one or more operations and/or functionalities of radar processor 2236; and/or communication interconnect 1207 (FIG. 12) may include one or more elements of communication interconnect 2207, and/or may perform one or more operations and/or functionalities of communication interconnect 2207.

In some demonstrative aspects, as shown in FIG. 22, communication interconnect 2207 may include a fiber optic interconnect and/or a dielectric waveguide interconnect. In other aspects, any other additional or alternative interconnect may be implemented.

In some demonstrative aspects, as shown in FIG. 22, communication interconnect 2207 may be configured to transfer digital radar Rx information 2238 in a direction (Rx direction) from RH 2210 to radar processor 2236.

In some demonstrative aspects, as shown in FIG. 22, communication interconnect 2207 may be configured to transfer analog synchronization information 2232 in a direction (Tx direction) from radar processor 2236 to RH 2210.

In some demonstrative aspects, as shown in FIG. 22, RH 2210 may include a communication interface 2262, e.g., a fiber optic interface and/or a dielectric waveguide interface; and/or radar processor 2236 may include a communication interface 2231, e.g., a fiber optic interface and/or a dielectric waveguide interface, which may be configured to process communication over the communication interconnect 2207.

In some demonstrative aspects, as shown in FIG. 22, communication interface 2262 may include a SERDES and modem 2215, and a PHY layer 2217 to transmit the digital radar Rx information 2238 over the communication interconnect 2207.

In some demonstrative aspects, as shown in FIG. 22, radar processor 2236 may include a PHY layer 2237 and a SERDES and modem 2235 to process the digital radar Rx information 2238 received over the communication interconnect 2207, for example, to recover bits of the digital radar Rx information 2238, for example, according to a reverse processing of processing performed by the RH 2210.

In some demonstrative aspects, as shown in FIG. 22, a channel 2239, e.g., e.g., a dedicated frequency channel, may be configured to transfer the analog synchronization information 2232, e.g., in an analog manner. For example, the channel 2239 may include an optional up-conversion, amplification, media propagation, LNA, and/or an optional down-conversion.

In some demonstrative aspects, a control channel, e.g., a side bi-directional control channel, may be allocated for control information between radar processor 2236 and RH 2210.

In some demonstrative aspects, the control channel may support implementation of RH 2210 as a controllerless RH, e.g., controllerless RH 1410 (FIG. 14). In some demonstrative aspects, Rx interconnect scheme 2201 may be configured as substantially a “mirror” image of the Tx interconnect scheme 1901 (FIG. 19), for example, with one or more differences, e.g., as described below.

In some demonstrative aspects, the analog synchronization information 2232 may be transferred via a Tx direction link from the radar processor 2236 to the RH 2210, e.g., the Tx direction link via interconnect 1907 (FIG. 19), for example, in case RH 2210 is implemented to support both Tx capabilities and Rx capabilities. For example, the Rx direction link may be implemented a digital only link, e.g., to transfer the digital radar Rx information 2238, without transferring the analog synchronization information 2232. For example, the RH 2110 may be configured to receive the analog synchronization information 2232 via the Tx direction link and to distribute, the analog synchronization information 2232 to an Rx chain of the RH 2210, e.g., Rx chain 2216 (FIG. 12).

In some demonstrative aspects, the analog synchronization information 2232 may be provided in the “Tx direction” via communication interconnect 2207, for example, when RH 2210 is implemented to support Rx capabilities for providing the digital radar Rx information 2238, e.g., without support of Tx capabilities for handling digital radar Tx information 1938 (FIG. 19).

In some demonstrative aspects, as shown in FIG. 22, RH 2210 may be configured to generate Rx digital radar information 2238 including data from a plurality of Rx channels, which may be sent over one or more physical links over communication interconnect 2207, e.g., as described below.

In some demonstrative aspects, RH 2210 may be configured to transfer the Rx digital radar information 2238 including data from a plurality of Rx channels over a same physical link over communication interconnect 2207.

In some demonstrative aspects, the data from the plurality of Rx channels may be interleaved, e.g., according to a time interleaving mechanism, for example, to reduce a number of needed buffers. In one example, data from an Rx channel may be packetized with a special header.

In some demonstrative aspects, the data from the plurality of Rx channels may be transmitted in a physical link over communication interconnect 2207, for example, by sending data from each channel of the plurality of Rx channels in a serial manner, e.g., one after the other.

In some demonstrative aspects, the data from the plurality of Rx channels may be transmitted in a physical link over communication interconnect 2207, for example, using a different ‘virtual’ link for each channel of the plurality of Rx channels. For example, a channel, e.g., each channel, of the plurality of Rx channels, may be communicated over a different frequency. In one example, control information may be communicating using a separate ‘virtual’ link.

In some demonstrative aspects, the RH 2210 may be configured to transmit the digital Rx information 2232 to more than one radar processor 2236 and/or more than one BPU, e.g., to support load balancing.

In one example, RH 2210 may utilize two or more physical links, e.g., via two or more communication interconnections 2207, for example, to connect the RH 2210 to two or more radar processors 2236 and/or BPUs.

In another example, RH 2210 may be implemented to utilize a single physical link, e.g., via a communication interface 2207, to communicate with two or more radar processors 2236 and/or BPUs.

In some demonstrative aspects, a TRX interface of radar processor 2236 may be configured to switch a connection of the radar processor 2236 between RHs.

For example, RH 2110 may be configured to mark a destination BPU to process the Rx digital radar information 2238. For example, the destination BPU may be indicated by packetizing the data and adding a special header, and/or by using a different frequency for different destination BPUs.

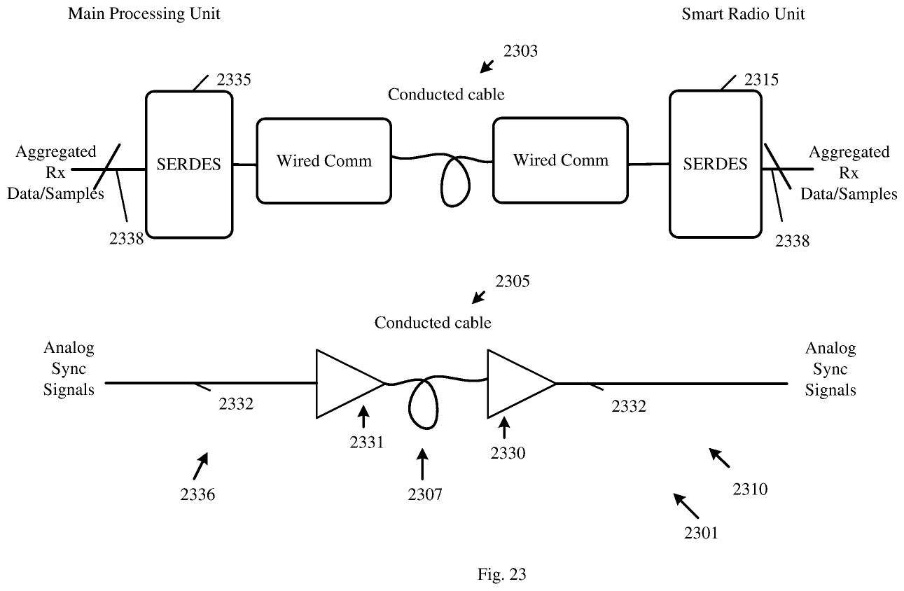

Reference is made to FIG. 23, which schematically illustrates an Rx interconnect scheme 2301 to support communication between an RH 2310 and a radar processor 2336 via a communication interconnect 2307. For example, RH 1210 (FIG. 12) may include one or more elements of RH 2310, and/or may perform one or more operations and/or functionalities of RH 2310; radar processor 1236 (FIG. 12) may include one or more elements of radar processor 2336, and/or may perform one or more operations and/or functionalities of radar processor 2336; and/or communication interconnect 1207 (FIG. 12) may include one or more elements of communication interconnect 2307, and/or may perform one or more operations and/or functionalities of communication interconnect 2307.

In some demonstrative aspects, as shown in FIG. 23, communication interconnect 2307 may be configured to transfer digital radar Rx information 2338 in a direction (Rx direction) from RH 2310 to radar processor 2336.

In some demonstrative aspects, as shown in FIG. 23, communication interconnect 2307 may be configured to transfer analog synchronization information 2332 in a direction (Tx direction) from radar processor 2336 to RH 2310.

In some demonstrative aspects, as shown in FIG. 23, communication interconnect 2307 may include a first conducted cable interconnect 2305 and a second conducted cable interconnect 2303.

In some demonstrative aspects, first conducted cable interconnect 2305 may include, for example, a coax cable, which may be configured to transfer analog synchronization information 2332, e.g., via a dedicated channel.

In some demonstrative aspects, second conducted cable interconnect 2303 may be configured to transfer digital radar Rx information 2338, for example, via an Ethernet link or any other link, e.g., fast link conducted communication system.

In some demonstrative aspects, as shown in FIG. 23, radar processor 2336 may include a cable communication interface 2331, which may be configured to transmit the analog synchronization information 2332 via communication interconnect 2307.

In some demonstrative aspects, as shown in FIG. 23, RH 2310 may include a cable communication interface 2330, which may be configured to receive the analog synchronization information 2332 via communication interconnect 2307.

In some demonstrative aspects, as shown in FIG. 23, the second conducted cable 2303 may be configured to send the digital radar Rx information 2338 in a digital manner, e.g., from RH 2310 to radar processor 2336.

In some demonstrative aspects, as shown in FIG. 23, RH 2310 may include a SERDES 2315 to transmit the digital radar Rx information 2338 over the communication interconnect 2307.

In some demonstrative aspects, as shown in FIG. 23, radar processor 2336 may include a SERDES 2335 to process the digital radar Rx information 2338 received over the communication interconnect 2307, for example, to recover bits of the digital radar Rx information 2338, for example, according to a reverse processing of processing performed by the RH 2310.

Referring back to FIG. 11, in some demonstrative aspects, radar system 1100 may be configured to utilize a Tx interconnect scheme, e.g., Tx interconnect scheme 1901 (FIG. 19), Tx interconnect scheme 2001 (FIG. 20), and/or Tx interconnect scheme 2101 (FIG. 21), for example, to interconnect between the radar processing unit 1134 and an RH having Tx capabilities, e.g., an RH 1116 and/or an RH 1112.

In some demonstrative aspects, radar system 1100 may be configured to utilize an Rx interconnect scheme, e.g., Rx interconnect scheme 2201 (FIG. 22), and/or Rx interconnect scheme 2301 (FIG. 23), for example, to interconnect between the radar processing unit 1134 and an RH having Rx capabilities, e.g., an RH 1114 and/or an RH 1112.

In some demonstrative aspects, radar system 1100 may be configured to utilize a bi-directional interconnect scheme to interconnect between the radar processing unit 1134 and an RH having both Rx capabilities and Tx capabilities, e.g., an RH 1112.

In some demonstrative aspects, the bi-directional interconnect scheme may be configured to implement a combination of one or more functionalities of an Rx interconnect scheme, e.g., Rx interconnect scheme 2201 (FIG. 22), and/or Rx interconnect scheme 2301 (FIG. 23), and one or more functionalities of a Tx interconnect scheme, e.g., Tx interconnect scheme 1901 (FIG. 19), Tx interconnect scheme 2001 (FIG. 20), and/or Tx interconnect scheme 2101 (FIG. 21).

In some demonstrative aspects, the bi-directional communication interconnect scheme may include a bi-directional digital interconnect to communicate digital radar Tx information and digital radar Rx information between the processing unit 1134 and the RH 1112.

In some demonstrative aspects, the bi-directional digital interconnect may include an analog channel, e.g., a single analog synchronization channel, to communicate analog synchronization information in a Tx direction from the processing unit 1134 to the RH 1112.

In some demonstrative aspects, bi-directional digital interconnect may be configured to implement one or more functionalities of a digital interconnect in a Tx direction, e.g., the digital interconnect in the Tx direction described above with respect to Tx interconnect scheme 1901 (FIG. 19), Tx interconnect scheme 2001 (FIG. 20), and/or Tx interconnect scheme 2101 (FIG. 21).

In some demonstrative aspects, bi-directional digital interconnect may be configured to implement one or more functionalities of a digital interconnect in an Rx direction, e.g., the digital interconnect in the Rx direction described above with respect to Rx interconnect scheme 2201 (FIG. 22), and/or Rx interconnect scheme 2301 (FIG. 23).

In some demonstrative aspects, the analog channel may be configured to implement one or more functionalities of the analog interconnect channel in the Tx direction described above with respect to Tx interconnect scheme 1901 (FIG. 19), and/or Tx interconnect scheme 2101 (FIG. 21).

In some demonstrative aspects, an RH having both Rx capabilities and Tx capabilities, e.g., an RH 1112, may be configured to distribute analog synchronization information to both Tx and Rx portions of the RH. For example, as shown in FIG. 11, the TRX 1115 of the analog synchronization information, e.g., which may be based on the analog LO signal 1137, to the Rx chains 1117 and the Tx chains 1119.

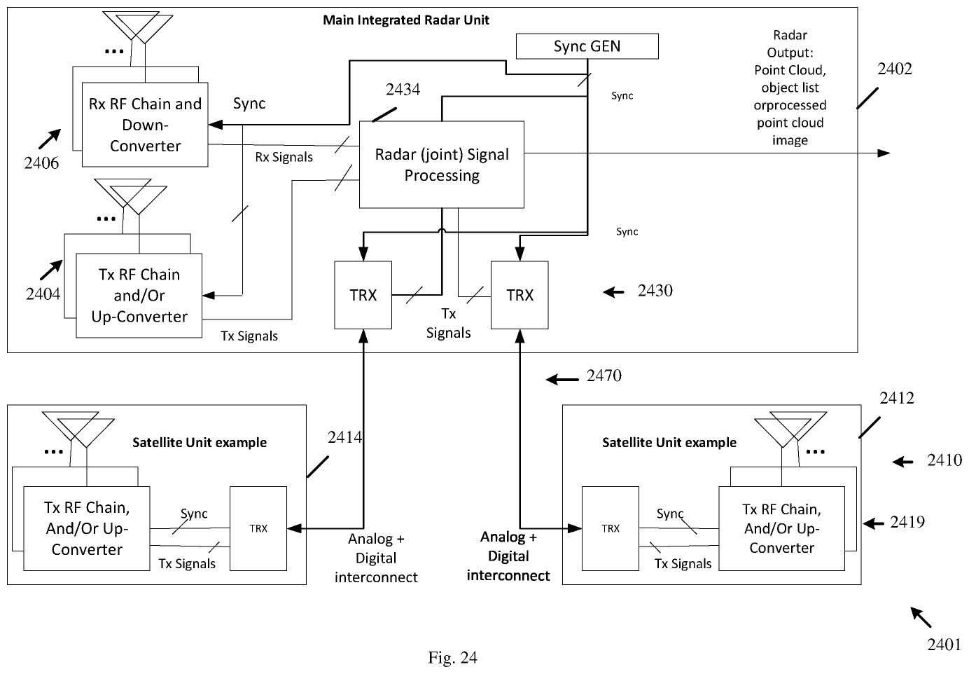

Reference is made to FIG. 24, which schematically illustrates a radar system 2401, in accordance with some demonstrative aspects. For example, radar system 1001 (FIG. 10) may include one or more elements of radar system 2401, and/or may perform one or more operations and/or functionalities of radar system 2401.

In some demonstrative aspects, as shown in FIG. 24, radar system 2401 may include a radar device 2402. For example, radar device 1002 (FIG. 10) may include one or more elements of radar device 2402, and/or may perform one or more operations and/or functionalities of radar device 2402.

In some demonstrative aspects, as shown in FIG. 24, radar device 2402 may include a transmitter 2404 and a receiver 2406.

In some demonstrative aspects, as shown in FIG. 24, radar system 2401 may include a plurality of RHs 2410, e.g., as satellite RHs. For example, the plurality of RHs 1010 (FIG. 10) may include one or more elements of the plurality of the RHs 2410, and/or may perform one or more operations and/or functionalities of plurality of RHs the 2410.

In some demonstrative aspects, as shown in FIG. 24, radar device 2402 may include a radar processing unit 2434 configured to coordinate radar communications by the plurality of RHs 2410, the transmitter 2404, and/or the receiver 2406. For example, radar processing unit 1034 (FIG. 10) may include one or more elements of radar processing unit 2434, and/or may perform one or more operations and/or functionalities of radar processing unit 2434.

In some demonstrative aspects, as shown in FIG. 24, radar processing unit 2434 may be implemented, for example, as part of radar device 2402.

In some demonstrative aspects, as shown in FIG. 24, radar device 2402 may include a communication interface 2430 configured to communicate with the plurality of RHs 2410. For example, communication interface 1030 (FIG. 10) may include one or more elements of communication interface 2430, and/or may perform one or more operations and/or functionalities of communication interface 2430.

In some demonstrative aspects, as shown in FIG. 24, the plurality of the RHs 2410 may include Tx-only RHs having only Tx capabilities. For example, an RH 2412 and/or an RH 2414 may be configured as a Tx-only RHs including one or more Tx chains 2419.

In some demonstrative aspects, a satellite architecture of radar system 2401, may be utilized, for example, to provide a technical solution to support an efficient mode of a Multi Static radar system.

In some demonstrative aspects, performance of a Multi Static radar system may be improved, for example, when using a coherent processing over multiple frames, e.g., according to a Synthetic Aperture Radar (SAR) scheme.

In some demonstrative aspects, the satellite architecture may be implemented to improve radar performance, for example, with respect to side scenery and/or height measurements, e.g., as described below.

In some demonstrative aspects, the satellite architecture may be implemented to increase an aperture size of a virtual array (VA), for example, by using additional RHs.

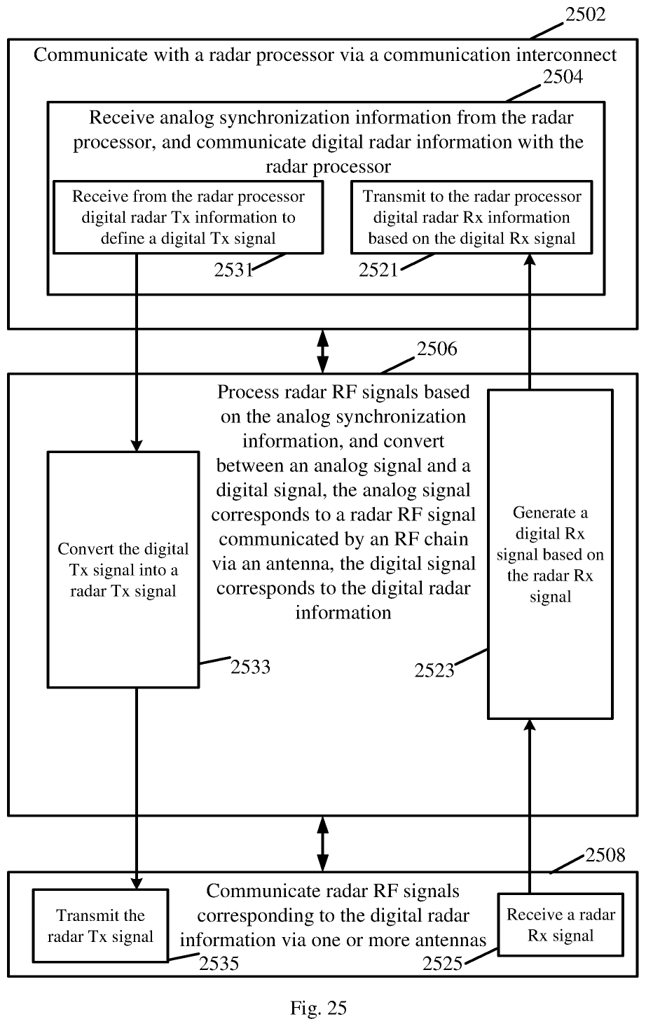

Reference is made to FIG. 25, which schematically illustrates a method of radar processing, in accordance with some demonstrative aspects. For example, one or more of the operations of the method of FIG. 25 may be performed by a radar system, e.g., radar system 900 (FIG. 9), radar system 1001 (FIG. 10), radar system 1100 (FIG. 11), and/or radar system 1201 (FIG. 12); a radar device, e.g., radar device 1002 (FIG. 10); and/or a radio head, e.g., RH 1010 (FIG. 10), RH 1110 (FIG. 11) and/or RH 1210 (FIG. 12).

As indicated at block 2502, the method may include communicating, at a RH, with a radar processor via a communication interconnect. For example, RH 1210 (FIG. 12) may communicate with radar processor 1210 (FIG. 12) via the communication interconnect 1207 (FIG. 12), e.g., as described above.

As indicated at block 2504, communicating at the RH with the radar processor may include receiving analog synchronization information from the radar processor, and communicating digital radar information with the radar processor. For example, RH 1210 (FIG. 12) may receive the analog synchronization information 1232 (FIG. 12) from the radar processor 1236 (FIG. 12), and may communicate the digital radar information 1238 (FIG. 12) with the radar processor 1236 (FIG. 12), e.g., as described above.

As indicated at block 2506, the method may include processing at the RH radar RF signals based on the analog synchronization information, and converting between an analog signal and a digital signal. For example, the analog signal may correspond to a radar RF signal communicated by an RF chain of the RH via an antenna, and/or the digital signal may correspond to the digital radar information communicated with the radar processor. For example, RH 1210 (FIG. 12) may process radar RF signals based on the analog synchronization information 1232 (FIG. 12), and may convert between analog signals corresponding to radar RF signals communicated by the RF chain 1220 (FIG. 12) and digital signals corresponding to the digital radar information 1238 (FIG. 12), e.g., as described above.

As indicated at block 2508, the method may include communicating, at the RH, radar RF signals corresponding to the digital radar information via one or more antennas. For example, RH 1210 (FIG. 12) may communicate the radar RF signals corresponding to the digital radar information 1238 (FIG. 12) via the one or more antennas 1217 (FIG. 12), e.g., as described above.

In some demonstrative aspects, one or more operations of the method of FIG. 25 may be performed by an RH to transmit radar Tx signals, e.g., as described below.

In some demonstrative aspects, as indicated at block 2531, communicating the digital radar information with the radar processor may include receive from the radar processor digital radar Tx information to define a digital Tx signal. For example, RH 1210 (FIG. 12) may receive from radar processor 1236 (FIG. 12) the radar Tx information to define the digital Tx signal, e.g., as described above.

In some demonstrative aspects, as indicated at block 2533, the method may include converting the digital Tx signal into an RF radar Tx signal. For example, RH 1210 (FIG. 12) may convert the digital Tx signal into an RF radar Tx signal to be transmitted by the RH 1210 (FIG. 12), e.g., as described above.

In some demonstrative aspects, as indicated at block 2535, the method may include transmitting the RF radar Tx signal. For example, RH 1210 (FIG. 12) may transmit the RF radar Tx signal via an antenna, e.g., as described above.

In some demonstrative aspects, one or more operations of the method of FIG. 25 may be performed by an RH to transmit process Rx signals, e.g., as described below.

In some demonstrative aspects, as indicated at block 2525, the method may include receiving an RF radar Rx signal. For example, RH 1210 (FIG. 12) may receive the RF radar Rx signal via an antenna, e.g., as described above.

In some demonstrative aspects, as indicated at block 2523, the method may include generating a digital Rx signal based on the radar Rx signal. For example, RH 1210 (FIG. 12) may generate the digital Rx signal based on the RF radar Rx signal, e.g., as described above.

In some demonstrative aspects, as indicated at block 2521, communicating the digital radar information with the radar processor may include transmitting to the radar processor digital radar Rx information based on the digital Rx signal. For example, RH 1210 (FIG. 12) may transmit to radar processor 1236 (FIG. 12) the radar Rx information, e.g., as described above.

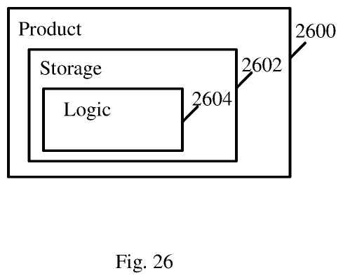

Reference is made to FIG. 26, which schematically illustrates a product of manufacture 2600, in accordance with some demonstrative aspects. Product 2600 may include one or more tangible computer-readable (“machine-readable”) non-transitory storage media 2602, which may include computer-executable instructions, e.g., implemented by logic 2604, operable to, when executed by at least one computer processor, enable the at least one computer processor to implement one or more operations and/or functionalities described with reference to any of the FIGS. 1-25, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 2600 and/or machine-readable storage media 2602 may include one or more types of computer-readable storage media capable of storing data, including volatile memory, non-volatile memory, removable or non-removable memory, erasable or non-erasable memory, writeable or re-writeable memory, and the like. For example, machine-readable storage media 2602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 2604 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 2604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising a Radio Head (RH) comprising a communication interface configured to communicate with a radar processor via a communication interconnect, wherein the communication interface is configured to receive analog synchronization information from the radar processor, and to communicate digital radar information with the radar processor; and one or more Radio Frequency (RF) chains to communicate radar RF signals corresponding to the digital radar information via one or more antennas, the one or more RF chains configured to process the radar RF signals based on the analog synchronization information, wherein an RF chain comprises a digital/analog converter to convert between an analog signal and a digital signal, wherein the analog signal corresponds to a radar RF signal communicated by the RF chain via an antenna, wherein the digital signal corresponds to the digital radar information.

Example 2 includes the subject matter of Example 1, and optionally, wherein the one or more RF chains comprise a Receive (Rx) chain to receive a radar Rx signal and to generate an Rx Baseband (BB) signal by processing the radar Rx signal based on the analog synchronization information, wherein the digital/analog converter comprises an Analog-to-Digital (ADC) converter to convert the Rx BB signal into a digital Rx signal, wherein the communication interface is configured to transmit to the radar processor digital radar Rx information based on the digital Rx signal.

Example 3 includes the subject matter of Example 2, and optionally, wherein the Rx chain comprises a Low Noise Amplifier (LNA) to provide an amplified Rx signal based on the radar Rx signal, and a frequency downconverter to provide a downconverted Rx signal by downconverting the amplified Rx signal based on the analog synchronization information, wherein the Rx BB signal is based on the downconverted Rx signal.

Example 4 includes the subject matter of Example 2 or 3, and optionally, wherein the RH comprises a correlator configured to generate correlation information based on a correlation between the digital Rx signal and Transmit (Tx) radar information corresponding to a radar Tx signal, wherein the digital radar Rx information is based on the correlation information.

Example 5 includes the subject matter of Example 4, and optionally, wherein the communication interface is configured to receive the Tx radar information from the radar processor.

Example 6 includes the subject matter of any one of Examples 2-5, and optionally, wherein the RH comprises a Doppler processor configured to determine Doppler information based on the digital Rx signal, wherein the digital radar Rx information is based on the Doppler information.

Example 7 includes the subject matter of Example 6, and optionally, wherein the RH comprises an active bin selector configured to select one or more active Range-Doppler (RD) bins based on the Doppler information, wherein the digital radar Rx information is based on radar information corresponding to the active RD bins.

Example 8 includes the subject matter of any one of Examples 2-7, and optionally, wherein the RH comprises a compressor to generate the digital radar Rx information comprising compressed Rx information based on the digital Rx signals.

Example 9 includes the subject matter of any one of Examples 2-8, and optionally, wherein the RH comprises a memory to store processed information based on the digital Rx signal, wherein the digital radar Rx information is based on the processed information.

Example 10 includes the subject matter of any one of Examples 1-9, and optionally, wherein the communication interface is configured to receive from the radar processor digital radar Tx information to define a digital Tx signal, wherein the digital/analog converter comprises a Digital-to-Analog Converter (DAC) to convert the digital Tx signal into a Tx Baseband (BB) signal, wherein the one or more RF chains comprise a Transmit (Tx) chain to transmit a radar Tx signal by processing the Tx BB signal based on the analog synchronization information.

Example 11 includes the subject matter of Example 10, and optionally, wherein the Tx chain comprises a Low-Pass-Filter (LPF) to provide a filtered Tx signal based on the Tx BB signal, and a frequency upconverter to provide an upconverted Tx signal by upconverting the filtered Tx signal based on the analog synchronization information, wherein the radar Tx signal is based on the upconverted Tx signal.

Example 12 includes the subject matter of Example 10 or 11, and optionally, wherein the digital radar Tx information comprises a sequence of digital radar Tx samples of the digital Tx signal.

Example 13 includes the subject matter of Example 12, and optionally, comprising a memory to store the sequence of digital radar Tx samples, wherein the RH is configured to transmit a plurality of repetitions of a radar Tx transmission, the radar Tx transmission based on the sequence of digital radar Tx samples.

Example 14 includes the subject matter of Example 12 or 13, and optionally, wherein the RH is configured to stream the sequence of digital radar Tx samples as an input to the DAC of the Tx chain.

Example 15 includes the subject matter of Example 10 or 11, and optionally, wherein the digital radar Tx information comprises waveform information to define a radar Tx waveform, wherein the RH is configured to generate the digital Tx signal based on the waveform information.

Example 16 includes the subject matter of any one of Examples 1-15, and optionally, wherein the communication interface is configured to receive RH control information from the radar processor, wherein the RH is configured to control one or more functionalities of the RH based on the RH control information.

Example 17 includes the subject matter of any one of Examples 1-16, and optionally, wherein the communication interface is configured to receive RH control information from the radar processor, the RH control information comprising register information to identify one or more memory registers mapped to an element of the RH, and control instructions to control one or more functionalities of the element of the RH, wherein the RH comprises a memory interface to write the control instructions to the one or more memory registers based on the register information.

Example 18 includes the subject matter of Example 16 or 17, and optionally, wherein the RH control information comprises information to set at least one of a cutoff frequency of a Low-Pass-Filter (LPF) in the RF chain, a parameter of the digital/analog converter, or a parameter of an RF amplifier in the RF chain.

Example 19 includes the subject matter of any one of Examples 16-18, and optionally, wherein the RH comprises a controllerless RH, which is controllable, e.g., directly, based on the RH control information from the radar processor.

Example 20 includes the subject matter of any one of Examples 1-19, and optionally, wherein the analog synchronization information comprises an analog Local Oscillator (LO) signal.

Example 21 includes the subject matter of any one of Examples 1-20, and optionally, wherein the analog synchronization information comprises time synchronization information to synchronize in time the radar RF signals.

Example 22 includes the subject matter of any one of Examples 1-21, and optionally, wherein the RH comprises a Local Oscillator (LO) generator to generate an LO signal based on the analog synchronization information, wherein the one or more RF chains are configured to process the radar RF signals based on the LO signal.

Example 23 includes the subject matter of any one of Examples 1-22, and optionally, wherein the one or more RF chains comprise a plurality of RF chains, wherein the digital radar information is in the form of a serial stream comprising an aggregation of a plurality of digital streams, the plurality of digital streams comprising digital radar information corresponding to the plurality of RF chains, respectively.

Example 24 includes the subject matter of any one of Examples 1-23, and optionally, wherein the communication interface is configured to communicate the digital radar information modulated over one or more first electromagnetic waveforms via a waveguide interconnect, and to communicate the analog synchronization information over a second electromagnetic waveform via the waveguide interconnect.

Example 25 includes the subject matter of any one of Examples 1-24, and optionally, wherein the communication interface comprises a fiber optic communication interface to communicate the analog synchronization information, and the digital radar information via a fiber optic interconnect.

Example 26 includes the subject matter of any one of Examples 1-25, and optionally, wherein the communication interface comprises an Active Optical Cable (AOC) communication interface to communicate the analog synchronization information, and the digital radar information via an AOC interconnect.

Example 27 includes the subject matter of any one of Examples 1-26, and optionally, wherein the communication interface comprises a dielectric waveguide communication interface to communicate the analog synchronization information, and the digital radar information via a dielectric waveguide interconnect.

Example 28 includes the subject matter of any one of Examples 1-27, and optionally, wherein the communication interface comprises cable communication interface to communicate the analog synchronization information, and the digital radar information via a conductive cable interconnect.

Example 29 includes the subject matter of any one of Examples 1-28, and optionally, comprising a vehicle, the vehicle comprising a system controller to control one or more systems of the vehicle based on radar information, the radar information based on the digital radar information.

Example 30 includes a vehicle comprising the apparatus of any of Examples 1-28.

Example 31 includes an apparatus comprising means for executing any of the described operations of any of Examples 1-28.

Example 32 includes a machine-readable medium that stores instructions for execution by a processor to perform any of the described operations of any of Examples 1-28.

Example 33 comprises a product comprising one or more tangible computer-readable non-transitory storage media comprising instructions operable to, when executed by at least one processor, enable the at least one processor to cause a device to perform any of the described operations of any of Examples 1-28.

Example 34 includes an apparatus comprising a memory; and processing circuitry configured to perform any of the described operations of any of Examples 1-28.

Example 35 includes a method including any of the described operations of any of Examples 1-28.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

1-25. (canceled)

26. An apparatus comprising:
a Radio Head (RH) comprising:
a communication interface configured to communicate with a radar processor via a communication interconnect, wherein the communication interface is configured to receive analog synchronization information from the radar processor, and to communicate digital radar information with the radar processor; and
one or more Radio Frequency (RF) chains to communicate radar RF signals corresponding to the digital radar information via one or more antennas, the one or more RF chains configured to process the radar RF signals based on the analog synchronization information, wherein an RF chain comprises a digital/analog converter to convert between an analog signal and a digital signal, wherein the analog signal corresponds to a radar RF signal communicated by the RF chain via an antenna, wherein the digital signal corresponds to the digital radar information.

27. The apparatus of claim 26, wherein the one or more RF chains comprise a Receive (Rx) chain to receive a radar Rx signal and to generate an Rx Baseband (BB) signal by processing the radar Rx signal based on the analog synchronization information, wherein the digital/analog converter comprises an Analog-to-Digital (ADC) converter to convert the Rx BB signal into a digital Rx signal, wherein the communication interface is configured to transmit to the radar processor digital radar Rx information based on the digital Rx signal.

28. The apparatus of claim 27, wherein the Rx chain comprises a Low Noise Amplifier (LNA) to provide an amplified Rx signal based on the radar Rx signal, and a frequency downconverter to provide a downconverted Rx signal by downconverting the amplified Rx signal based on the analog synchronization information, wherein the Rx BB signal is based on the downconverted Rx signal.

29. The apparatus of claim 27, wherein the RH comprises a correlator configured to generate correlation information based on a correlation between the digital Rx signal and Transmit (Tx) radar information corresponding to a radar Tx signal, wherein the digital radar Rx information is based on the correlation information.

30. The apparatus of claim 27, wherein the RH comprises a Doppler processor configured to determine Doppler information based on the digital Rx signal, wherein the digital radar Rx information is based on the Doppler information.

31. The apparatus of claim 30, wherein the RH comprises an active bin selector configured to select one or more active Range-Doppler (RD) bins based on the Doppler information, wherein the digital radar Rx information is based on radar information corresponding to the active RD bins.

32. The apparatus of claim 27, wherein the RH comprises a compressor to generate the digital radar Rx information comprising compressed Rx information based on the digital Rx signals.

33. The apparatus of claim 26, wherein the communication interface is configured to receive from the radar processor digital radar Tx information to define a digital Tx signal, wherein the digital/analog converter comprises a Digital-to-Analog Converter (DAC) to convert the digital Tx signal into a Tx Baseband (BB) signal, wherein the one or more RF chains comprise a Transmit (Tx) chain to transmit a radar Tx signal by processing the Tx BB signal based on the analog synchronization information.

34. The apparatus of claim 33, wherein the Tx chain comprises a Low-Pass-Filter (LPF) to provide a filtered Tx signal based on the Tx BB signal, and a frequency upconverter to provide an upconverted Tx signal by upconverting the filtered Tx signal based on the analog synchronization information, wherein the radar Tx signal is based on the upconverted Tx signal.

35. The apparatus of claim 33, wherein the digital radar Tx information comprises a sequence of digital radar Tx samples of the digital Tx signal.

36. The apparatus of claim 35 comprising a memory to store the sequence of digital radar Tx samples, wherein the RH is configured to transmit a plurality of repetitions of a radar Tx transmission, the radar Tx transmission based on the sequence of digital radar Tx samples.

37. The apparatus of claim 35, wherein the RH is configured to stream the sequence of digital radar Tx samples as an input to the DAC of the Tx chain.

38. The apparatus of claim 33, wherein the digital radar Tx information comprises waveform information to define a radar Tx waveform, wherein the RH is configured to generate the digital Tx signal based on the waveform information.

39. The apparatus of claim 26, wherein the communication interface is configured to receive RH control information from the radar processor, wherein the RH is configured to control one or more functionalities of the RH based on the RH control information.

40. The apparatus of claim 39, wherein the RH control information comprises information to set at least one of a cutoff frequency of a Low-Pass-Filter (LPF) in the RF chain, a parameter of the digital/analog converter, or a parameter of an RF amplifier in the RF chain.

41. The apparatus of claim 26, wherein the communication interface is configured to receive RH control information from the radar processor, the RH control information comprising register information to identify one or more memory registers mapped to an element of the RH, and control instructions to control one or more functionalities of the element of the RH, wherein the RH comprises a memory interface to write the control instructions to the one or more memory registers based on the register information.

42. The apparatus of claim 41, wherein the RH comprises a controllerless RH, which is controllable based on the RH control information from the radar processor.

43. The apparatus of claim 26, wherein the one or more RF chains comprise a plurality of RF chains, wherein the digital radar information is in the form of a serial stream comprising an aggregation of a plurality of digital streams, the plurality of digital streams comprising digital radar information corresponding to the plurality of RF chains, respectively.

44. A vehicle comprising:
a system controller configured to control one or more vehicular systems of the vehicle based on radar-based information; and
a radar system configured to generate the radar-based information, the radar system comprising:
a radar processor; and
one or more Radio Heads (RHs), wherein an RH of the one or more RHs comprises:
a communication interface configured to communicate with the radar processor via a communication interconnect, wherein the communication interface is configured to receive analog synchronization information from the radar processor, and to communicate digital radar information with the radar processor; and
one or more Radio Frequency (RF) chains to communicate radar RF signals corresponding to the digital radar information via one or more antennas, the one or more RF chains configured to process the radar RF signals based on the analog synchronization information, wherein an RF chain comprises a digital/analog converter to convert between an analog signal and a digital signal, wherein the analog signal corresponds to a radar RF signal communicated by the RF chain via an antenna, wherein the digital signal corresponds to the digital radar information.

45. The vehicle of claim 44, wherein the one or more RF chains comprise a Receive (Rx) chain to receive a radar Rx signal and to generate an Rx Baseband (BB) signal by processing the radar Rx signal based on the analog synchronization information, wherein the digital/analog converter comprises an Analog-to-Digital (ADC) converter to convert the Rx BB signal into a digital Rx signal, wherein the communication interface is configured to transmit to the radar processor digital radar Rx information based on the digital Rx signal.
